(19) United States
(12) Patent Application Publication
(10) Pub. No.: US 2023/0393443 A1
(43) Pub. Date: Dec. 7, 2023

(54) VIRTUALLY VIEWING DEVICES IN A FACILITY

(71) Applicant: View, Inc., Milpitas, CA (US)

(72) Inventors: Ryssa Lolita Marquez, San Jose, CA (US); Mahender Reddy Vangati, San Jose, CA (US); Benjamin Scott Wynia, Milpitas, CA (US); Harmeet Bhutani, Santa Clara, CA (US); Ruben Edward Matos, Van Nuys, CA (US); Alan Lee Knight, Fort Worth, TX (US); James C Russell Bolen, Powder Springs, GA (US); Astrid Andreana Crivello, Sterling, VA (US); Dhairya Shrivastava, Los Altos, CA (US); Stephen Clark Brown, San Mateo, CA (US); Ronald F. Cadet, Redwood City, CA (US); Yuyang Ying, San Jose, CA (US); Qingjun Wang, Vernon, CT (US); Ranojoy Dutta, San Jose, CA (US)

(21) Appl. No.: 18/034,328

(22) PCT Filed: Nov. 2, 2021
(86) PCT No.: PCT/US2021/057678

§ 371 Date: Apr. 27, 2023

Related U.S. Application Data
(63) Continuation-in-part of application No. PCT/US2021/027418, filed on Apr. 15, 2021.
Application No. PCT/US2021/027418 is a continuation-in-part of application No. 16/946,947, filed on Jul. 13, 2020, now Pat. No. 11,592,723.
Application No. 16/946,947 is a continuation-in-part of application No. 17/211,697, filed on Mar. 24, 2021, now Pat. No. 11,668,992.
Application No. 17/211,697 is a continuation of application No. 15/727,258, filed on Oct. 6, 2017, now Pat. No. 10,989,976.
Application No. PCT/US2021/057678 is a continuation-in-part of application No. 17/450,091, filed on Oct. 6, 2021.
Application No. 17/450,091 is a continuation of application No. 16/871,976, filed on May 11, 2020, now Pat. No. 11,175,178.
Application No. 16/871,976 is a continuation of application No. 14/998,019, filed on Oct. 6, 2015, now Pat. No. 10,690,540.
Application No. PCT/US2021/057678 is a continuation-in-part of application No. 16/696,887, filed on Nov. 26, 2019, now Pat. No. 11,280,671.
Application No. 16/696,887 is a continuation of application No. 15/287,646, filed on Oct. 6, 2016, now Pat. No. 10,533,892.
Application No. 15/287,646 is a continuation-in-part of application No. 14/998,019, filed on Oct. 6, 2015, now Pat. No. 10,690,540.
Application No. PCT/US2021/057678 is a continuation-in-part of application No. 17/380,785, filed on Jul. 20, 2021, now Pat. No. 11,799,187.
Application No. 17/380,785 is a continuation of application No. 16/099,424, filed on Nov. 6, 2018, now Pat. No. 11,114,742.
Application No. PCT/US2021/057678 is a continuation-in-part of application No. 16/980,305, filed on Sep. 11, 2020, now Pat. No. 11,732,527.
Application No. 16/980,305 is a continuation-in-part of application No. 16/099,424, filed on Nov. 6, 2018, now Pat. No. 11,114,742.
(60) Provisional application No. 63/109,306, filed on Nov. 3, 2020.
(60) Provisional application No. 63/214,741, filed on Jun. 24, 2021.

(51) Int. Cl. G02F 1/163; G05B 15/02; G05B 19/042

(52) U.S. Cl. CPC G02F 1/163; G05B 15/02; G05B 19/042; G02F 2203/01; G06F 3/04847

(57) ABSTRACT

Provided herein are methods, systems, apparatuses, and computer programs related to various devices in an enclosure, e.g., using identification capturing device such as in conjunction with a digital twin of the enclosure. The computer program may be utilized for commissioning, maintenance, sales, marketing, and/or customer service. The computer program may receive customer, and/or customer service, input. The computer program may facilitate use of customer and/or customer service, e.g., input for controlling the facility (e.g., various devices of the facility), input for structuring the facility, and/or input for placing assets such as devices of the facility.

### PRIORITY APPLICATIONS

This application claims priority from U.S. Provisional Patent Application Ser. No. 63/109,306, filed Nov. 3, 2020, titled “ACCOUNTING FOR DEVICES IN A FACILITY;” and from U.S. Provisional Patent Application Ser. No. 63/214,741, filed Jun. 24, 2021, titled “VIRTUALLY VIEWING DEVICES IN A FACILITY.” This application also claims priority as a Continuation-in-Part of International Patent Application Serial No. PCT/US21/27418, filed Apr. 15, 2021, titled “INTERACTION BETWEEN AN ENCLOSURE AND ONE OR MORE OCCUPANTS;” International Patent Application Serial No. PCT/US21/33544, filed May 21, 2021, titled “ENVIRONMENTAL ADJUSTMENT USING ARTIFICIAL INTELLIGENCE;” and International Patent Application Serial No. PCT/US21/30798, filed May 5, 2021, titled “DEVICE ENSEMBLES AND COEXISTENCE MANAGEMENT OF DEVICES”. This application also claims priority as a Continuation-in-Part of U.S. patent application Ser. No. 16/946,947, filed Jul. 13, 2020, titled, “AUTOMATED COMMISSIONING OF CONTROLLERS IN A WINDOW NETWORK,” that is a National Stage Entry of International Patent Application Serial No. PCT/US17/62634, filed Nov. 20, 2017, titled, “AUTOMATED COMMISSIONING OF CONTROLLERS IN A WINDOW NETWORK.” This application also claims priority as a Continuation-in-Part of U.S. patent application Ser. No. 17/211,697 filed Mar. 24, 2021, titled “COMMISSIONING WINDOW NETWORKS,” that is a continuation of U.S. patent application Ser. No. 15/727,258, filed Oct. 6, 2017, titled, “COMMISSIONING WINDOW NETWORKS.” This application also claims priority as a Continuation-in-Part of U.S. patent application Ser. No. 17/450,091 filed Oct. 6, 2021, titled “MULTI-SENSOR HAVING A LIGHT DIFFUSING ELEMENT AROUND A PERIPHERY OF A RING OF PHOTOSENSORS,” that is a continuation of U.S. patent application Ser. No. 16/871,976 filed May 11, 2020, titled “ADJUSTING WINDOW TINT BASED AT LEAST IN PART ON SENSED SUN RADIATION,” that is a continuation of U.S. patent application Ser. No. 14/998,019 filed Oct. 6, 2015, now U.S. Pat. No. 10,690,540 issued Jun. 23, 2020, titled “MULTI-SENSOR HAVING A LIGHT DIFFUSING ELEMENT AROUND A PERIPHERY OF A RING OF PHOTOSENSORS.” This application also claims priority as a Continuation-in-Part of U.S. patent application Ser. No. 16/696,887 filed Nov. 26, 2019, titled “SENSING SUN RADIATION,” that is a continuation of U.S. patent application Ser. No. 15/287,646, filed Oct. 6, 2016, now U.S. Pat. No. 10,533,892 issued Jan. 14, 2020, titled “MULTI-SENSOR,” that is a Continuation in Part of U.S. patent application Ser. No. 14/998,019 filed Oct. 6, 2015, now U.S. Pat. No. 10,690,540 issued Jun. 23, 2020, titled “MULTI-SENSOR HAVING A LIGHT DIFFUSING ELEMENT AROUND A PERIPHERY OF A RING OF PHOTOSENSORS.” This application also claims priority as a Continuation-in-Part of (i) U.S. patent application Ser. No. 17/380,785 filed Jul. 20, 2021, titled “WINDOW ANTENNAS,” and to (ii) U.S. patent application Ser. No. 17/385,810, filed Jul. 26, 2021, titled “WINDOW ANTENNAS,” which both (i) and (ii) claim priority to U.S. patent application Ser. No. 16/099,424, filed Nov. 6, 2018, titled “WINDOW ANTENNAS,” that is a National Stage Entry of International Patent Application Serial No. PCT/US17/31106, filed May 4, 2017, titled, “WINDOW ANTENNAS.” This application also claims priority as a Continuation-in-Part of U.S. patent application Ser. No. 16/980,305, filed Sep. 11, 2020, titled “WIRELESSLY POWERED AND POWERING ELECTROCHROMIC WINDOWS,” that is a National Stage Entry of International Patent Application Serial No. PCT/US19/22129, filed Mar. 13, 2019, titled “WIRELESSLY POWERED AND POWERING ELECTROCHROMIC WINDOWS.” Each of the patent documents recited above is incorporated herein by reference in its entirety.

### BACKGROUND

Some tintable windows can be electronically controlled. Such control may allow control of the amount of light (e.g., heat) that passes through the windows, and presents an opportunity for tintable windows to be used as energy-saving devices by adjusting (e.g., absorbing, dispersing, and/or reflecting) the amount of passing light. There are various types of tintable windows, e.g., electrochromic windows.

Electrochromism is a phenomenon in which a material exhibits a reversible electrochemically-mediated change in an optical property when placed in a different electronic state, e.g., by being subjected to a voltage change. The optical property can be color, transmittance, absorbance, and/or reflectance. Electrochromic materials may be incorporated into, for example, windows for home, commercial and/or other uses. The electrochromic coating can be a (e.g., thin) film coatings on the windowpane. The color, transmittance, absorbance, and/or reflectance of such windows may be changed by inducing a change in the electrochromic material, for example, electrochromic windows are windows that can be darkened or lightened electronically. In some embodiments, a (e.g., small) voltage applied to an electrochromic device (EC) of the window will cause them to darken; reversing the voltage polarity causes them to lighten.

While electrochromism was discovered in the 1960's, electrochromic devices, and particularly electrochromic windows, still suffer various problems and have not begun to realize their full commercial potential despite many recent advancements in electrochromic technology, apparatus, software, and related methods of making and/or using electrochromic devices.

Commissioning, maintenance, and/or customer satisfaction regarding devices (e.g., tintable windows) and associated controllers remains a problem, especially in large facilities having multiple such windows and/or controllers. Locating an error in placement of the window, controller and/or connection of a controller to a designated window, may prove time and labor consuming to locate and rectify. Similarly, locating of a malfunctioning window, controller and/or connection of a controller to a designated window, (e.g., for maintenance, upgrade and/or replacement) may be time and labor consuming.

The tintable windows (e.g., comprising electrochromic devices), electronic ensembles (e.g., containing various sensors, actuators, and/or communication interfaces), and/or associated controllers (e.g., master controllers, network controllers, and/or other controllers, e.g., responsible for tint decisions) may be interconnected in a hierarchical network, e.g., for purposes of coordinated control (e.g., monitoring). For example, one or more controllers may need to utilize the network address of the window controller(s) connected to specific windows or sets of windows. To this end, a function of commissioning is performed to provide correct assignment of window controller addresses and/or other identifying information to specific windows and window controllers, as well the physical locations of the windows and/or window controllers in buildings. In some cases, a goal of commissioning is to correct mistakes or other problems made in installing windows in the wrong locations or the connecting of cables to the wrong window controllers. The commissioning process for a particular window (e.g., insulated glass unit (IGU)) may involve associating an identification (ID) for the window, or other window-related component, with a network address of its corresponding window controller. The process may (e.g., also) assign a building location and/or absolute location (e.g., latitude, longitude and/or elevation) to the window or other component.

During commissioning of devices in a facility, one or more devices (e.g., target devices) may be misplaced. For example, identical devices may be installed which can (e.g., only) be differentiated from one another by the installer, e.g., by consulting an external label having an inscribed serial number, bar code, Quick Response (QR) code, radio frequency identification (RF ID), and/or other printed information. If locations for each specific device are specified in advance, significant effort (e.g., labor and cost) may be required to ensure correct placement. If not specified in advance but manually recorded afterwards, significant effort (e.g., labor and cost) may again be required. Such effort is increased (i) with increased number of devices and (ii) with increase size and/or complexity of the facility in which the devices are located (e.g., disposed). A digital model and/or other file may be associated with the facility and the devices (e.g., a Building Information Model (BIM) (e.g., Revit file, Microdesk (e.g., ModelStream), IMAGINiT, ATG USA, or similar facility related digital file). The digital model and/or file may be referred to herein as a “digital twin” of the facility. When the devices are numerous, that task of locating any misplaced device and updating the digital twin becomes tedious, time consuming, expensive, and prone to human error (e.g., due to manual typing). At least partially automate the process of location and documenting the devices during and/or after the commissioning process may afford at least some relief to such tasks. Such at least partially automated process will increase the likelihood that the digital twin of the facility indicating the devices (e.g., assets) therein, is accurate. Such process will simplify forming a centralized file integrating all assets of the facility, which will aid tenants and customer support personnel responsible for the facility and/or devices therein.

In some instances, a marketing team member, sales team member, and/or Customer Success Manager (CSM) does not have a tool (e.g., an automatic tool) incorporating various devices in the facility they are addressing during their service. In some cases, initial BIM files (such as Autodesk Revit file) may be static and incorporate architectural elements of a facility, but not devices installed in the facility, let alone updated status of such devices. Substantial manpower may be required to translate an architectural plan to a digital twin. For example, 3D architectural model may at times are manually build to corresponding 3D architectural models. The devices may be manually inserted therein. Ground truth validation (e.g., from a field service engineer) may be required for device data in the digital twin.

A digital twin of the facility (e.g., automatically) integrating devices installed therein (which digital twin may be updated to reflect real time, or substantially real time status), may not only aid in deployment and maintenance of the facility and/or devices therein, but also may serve a tool for the CSM, e.g., when interacting with customers or potential customers. The digital twin may be a BIM that is supplemented with device related information, or may incorporate the BIM data. Such digital twin (e.g., visible using an app) may facilitate facility management at various levels. At times, input from building occupants may server as a feedback tool to customize control of the facility (e.g., control devices in the facility). Input from customers and/or from the CMS (e.g., through the app) may feed into control of the facility (e.g., devices of the facility), e.g., using the digital twin. The digital twin may offer (e.g., intuitive and/or visual) proofing tool prior to commissioning various aspects of the facility. The digital twin may offer a virtual reality experience of the facility (including its assets such as devices) to a user of the software application.

### SUMMARY

According to some aspects, disadvantages of the prior art are overcome using a traveler (e.g., field service engineer or robot such as a drone) to recognize an identity of the target device (e.g., asset) according to its identification code(s) along with its location in the facility (e.g., in real time), and automatically update this information in a digital twin of the enclosure (e.g., virtual three-dimensional model of an enclosure) and/or the BIM for automatic update to form an updated BIM (e.g., Revit® file). In some embodiments, the updated BIM will be compared with a prior version (e.g., the original) BIM for any discrepancies, which may be reported or otherwise addressed.

In some aspects, capturing the ID code may be by a mobile device. the mobile device may present (e.g., using augmented reality) an emulation of fixtures of the facility around the traveler (e.g., in real time) with or without an emulation of traveler, e.g., using a digital twin. For example, the mobile device may present at least a portion of the digital twin of the enclosure.

In some aspects, the device to be located (e.g., target device) may or may not be operatively coupled to a communication and/or power network. The device to be located may comprise a tintable window, a sensor, an emitter, a media display construct, an antenna, a router, a transceiver, a controller (e.g., microcontroller), a processor, a table, a chair, a door, a lighting, a heater, a ventilator, a lighting, an air-conditioning device, an alarm, or any other identifiable device associated with the facility. The target devices may be include a fixture (e.g., window or non-movable furniture such as a shelf) and/or non-fixture (e.g., movable furniture).

In some aspects, the target device may be represented in the digital twin or may be added to the digital twin using the mobile device. The digital twin may include or be operatively (e.g., communicatively) coupled to the BIM. The target device can be disposed (e.g., located) at a designated location or at a random location in the facility.

In some aspects, the digital twin may be utilized for building automation, analysis, customer service, customer management, sales, marketing, and/or asset lifecycle management. The digital twin may be utilized for control of various devices in the facility and/or of an environment of the facility (e.g., lighting system, security system, safety system, heating, air conditioning, and/or ventilation (e.g., HVAC system). The digital twin may be operatively coupled to a building management system (BMS).

In another aspect, a method of registering one or more real target devices, the method comprises: (A) identifying a location information of a real target device at least in part by (i) using a mobile device to select a virtual target device in a virtual representation of an enclosure in which the real target device is disposed, which virtual target device is a virtual representation of the real target device, which real target device is included in the one or more real target devices disposed in the enclosure, and/or (ii) using geographic information locating the real target device; (B) using an identification capture device to capture an identification code of the real target device, which identification code is attached to the real target device; and (C) registering the real target device at least in part by linking (I) the identification code, (II) the location information, and (III) the virtual representation of the enclosure.

In some embodiments, the virtual representation of the enclosure is an augmented reality. In some embodiments, the virtual representation of the enclosure is displayed on the mobile device. In some embodiments, the virtual representation includes virtual representations of at least some of the one or more real target devices. In some embodiments, the method further comprises navigating within the virtual representation of the enclosure according to movement of the mobile device in the enclosure. In some embodiments, the mobile device is transported by a traveler within the enclosure, and wherein a zoomed view in the virtual augmented reality representation is presented on a display of the mobile device in real time to depict a virtual representation of the real target device based at least in part on a present location of the traveler. In some embodiments, the traveler is a human. In some embodiments, the traveler is a robot having image recognition capabilities. In some embodiments, the method further comprises updating the virtual representation of the enclosure according to the registering of the target device. In some embodiments, the virtual representation of the enclosure is derived from and/or comprises an architectural model of the enclosure. In some embodiments, the method further comprises updating the architectural model according to registration of the real target device. In some embodiments, the method further comprises determining a status of the real target device at least in part by utilizing the virtual representation of the enclosure, the virtual representation of the real target device, and associated information obtained through utilizing the capture device. In some embodiments, the associated information is linked to the real target device and/or to the enclosure. In some embodiments, the associated information is obtained from a source which is identified as a result of the capture by the identification capture device. In some embodiments, the source is at least one server file linked by the identification code. In some embodiments, the method further comprises (a) initiating servicing of the real target device when the status determined indicates a servicing need, and (b) updating the status determined upon completion of the servicing. In some embodiments, the geographic information is an absolute information. In some embodiments, the absolute information is derived at least in part from a Global Positioning System (GPS) receiver or from a ultrawide band (UWB) receiver. In some embodiments, the geographic information is a relative location in the virtual representation of the enclosure. In some embodiments, the relative location is referenced to a fixture of the enclosure. In some embodiments, the identification capture device is mobile. In some embodiments, the identification capture device captures the identification code optically and/or electronically. In some embodiments, the identification code includes a barcode and/or a quick response (QR) code. In some embodiments, the identification code includes at least one or two dimensional code. In some embodiments, the identification code includes an electromagnetic code. In some embodiments, when identifying the location information, the real target device lacks a corresponding virtual target device representation in the virtual representation of the enclosure. In some embodiments, the method further comprises using the identification code to populate (a) the virtual representation of the enclosure and/or (b) at least one associated database of the virtual representation of the enclosure, with: a virtual representation of the real target device and/or associated information of the real target device. In some embodiments, the identification code is linked in the at least one associated database to the virtual representation of the real target device and/or the associated information about the real target device. In some embodiments, the at least one associated database comprises a lookup table. In some embodiments, the method further comprises selecting the virtual representation of the real target device from a plurality of selections presented by the mobile device. In some embodiments, the method further comprises selecting the identification code of the real target device from a plurality of identification codes presented by the mobile device. In some embodiments, the method further comprises transmitting the captured identification code to at least one database for storing and/or operatively coupled to the virtual representation of the enclosure. In some embodiments, the enclosure includes a network. In some embodiments, the mobile device is communicatively coupled in a wired and/or wireless manner to the at least one database via the network. In some embodiments, the network is communicatively coupled to the real target device. In some embodiments, the network is a hierarchical network comprising a plurality of controllers. In some embodiments, the network provides power and communication, which network is configured for at least fourth (4G) or at least fifth (5G) generation cellular communication. In some embodiments, the network is configured for media and/or video transmission using coaxial cables, optical wires, and/or twisted wires. In some embodiments, the mobile device is included in a handheld pointing device. In some embodiments, the mobile device is included in a mobile phone. In some embodiments, the mobile device is included in a tablet computer.

In another aspect, a non-transitory computer readable media for registering one or more real target devices, the non-transitory computer readable media, when read by one or more processors, is configured to execute operations of any of the above methods.

In another aspect, an apparatus for registering one or more real target devices, the apparatus comprising at least one controller having circuitry, which at least one controller is configured to: (A) operatively couple to an identification capture device and to a virtual representation of an enclosure in which the one or more real target devices are disposed; (B) receive, or direct receipt of, location information of a real target device at least in part by (i) selection of a virtual target device in a virtual representation of an enclosure in which the real target device is disposed, which virtual target device is a virtual representation of the real target device, which real target device is included in the one or more real target devices, and/or (ii) geographic information locating the real target device; (C) receive, or direct receipt of, identification information of the real target device from the identification capture device configured to capture an identification code of the real target device, which identification code is attached to the real target device; and (D) register, or direct registration of, the real target device at least in part by linking, or direct linkage of, (I) the identification code, (II) the location information, and (Ill) the virtual representation of the enclosure.

In some embodiments, the least one controller is configured to generate, or direct generation of, the virtual representation of the enclosure as an augmented reality. In some embodiments, the least one controller is configured to display, or direct display of, the virtual representation of the enclosure on the mobile device. In some embodiments, the virtual representation includes virtual representations of at least some of the one or more real target devices. In some embodiments, the least one controller is further configured to navigate, or direct navigation of, within the virtual representation of the enclosure according to movement of the mobile device in the enclosure. In some embodiments, the mobile device is transported by a traveler within the enclosure, and wherein the least one controller is configured to present, or direct presentation of, a zoomed view in the virtual augmented reality representation on a display of the mobile device in real time to depict a virtual representation of the real target device based at least in part on a present location of the traveler. In some embodiments, the traveler is a human. In some embodiments, the traveler is a robot having image recognition capabilities. In some embodiments, the least one controller is further configured to update, or direct update of, the virtual representation of the enclosure according to the registering of the real target device. In some embodiments, the virtual representation of the enclosure is derived from and/or comprises an architectural model of the enclosure. In some embodiments, the least one controller is further configured to update, or direct update of, the architectural model according to registration of the real target device. In some embodiments, the least one controller is further configured to determine, or direct determination of, a status of the real target device at least in part by utilizing (i) the virtual representation of the enclosure, (ii) the virtual representation of the real target device, and (iii) associated information obtained through utilizing the capture device. In some embodiments, the associated information is linked to the real target device and/or to the enclosure. In some embodiments, the least one controller is further configured to obtain, or direct obtaining of, the associated information from a source which is identified as a result of the capture by the identification capture device. In some embodiments, the source is at least one database file linked by the identification code. In some embodiments, the least one controller is further configured to (a) initiate servicing of, or direct initiating servicing of, the real target device when the status determined indicates a servicing need, and (b) update, or direct update of, the status determined upon completion of the servicing. In some embodiments, the geographic information is an absolute information. In some embodiments, the least one controller is further configured to derive, or direct derivation of, the absolute information at least in part from a Global Positioning System (GPS) receiver or from a ultrawide band (UWB) receiver. In some embodiments, the geographic information is a relative location in the virtual representation of the enclosure. In some embodiments, the least one controller is further configured to reference, or direct referencing of, the relative location to a fixture of the enclosure. In some embodiments, the identification capture device is mobile. In some embodiments, the least one controller is configured to direct the identification capture device to capture the identification code optically and/or electronically, which controller is operatively coupled to the identification capture device. In some embodiments, the identification code includes a barcode and/or a quick response (QR) code. In some embodiments, the identification code includes at least one or two dimensional code. In some embodiments, the identification code includes an electromagnetic code. In some embodiments, when the location information is identified, the real target device lacks a corresponding virtual target device representation in the virtual representation of the enclosure. In some embodiments, the least one controller is further configured to use, or direct using, the identification code to populate (a) the virtual representation of the enclosure and/or (b) at least one associated database of the virtual representation of the enclosure, with (i) a virtual representation of the real target device and/or (ii) associated information of the real target device. In some embodiments, the identification code is linked in the at least one associated database to the virtual representation of the real target device and/or the associated information about the real target device. In some embodiments, the at least one associated database comprises a lookup table. In some embodiments, the least one controller is further configured to facilitate selection of the virtual representation of the real target device from a plurality of selections presented by the mobile device. In some embodiments, the least one controller is further configured to facilitate selecting the identification code of the real target device from a plurality of identification codes presented by the mobile device. In some embodiments, the least one controller is further configured to communicate, or direct communication of, the captured identification code to at least one database storing and/or operatively coupled to the virtual representation of the enclosure. In some embodiments, the enclosure includes a network. In some embodiments, the mobile device is communicatively coupled in a wired and/or wireless manner to the at least one database via the network. In some embodiments, the network is communicatively coupled to the real target device. In some embodiments, the network is a hierarchical network comprising a plurality of controllers. In some embodiments, the network provides power and communication, which network is configured for at least fourth (4G) or at least fifth (5G) generation cellular communication. In some embodiments, the network is configured for media, video, and/or power transmission using coaxial cables, optical wires, and/or twisted wires. In some embodiments, the mobile device is included in a handheld pointing device. In some embodiments, the mobile device is included in a mobile phone. In some embodiments, the mobile device is included in a tablet computer.

In another aspect, a method for simulating a real facility, the method comprises: (i) generating a digital twin of a real facility at least in part by using a virtual architectural model of a real facility; (ii) populating at least one device of the real facility in the digital twin at a virtual location that corresponds to its real location in the real facility, which at least one device is controllable; and (iii) simulating, or directing simulation of, effect of at least one environmental attribute on the real facility.

In some embodiments, populating into the digital twin is a virtually populating (e.g., as opposed to physically connecting), such as establishing a virtual representation of the one or more devices in the digital twin. In some embodiments, the environmental attribute comprises lighting, radiation, temperature, gas velocity, gas flow, gas content, gas concentration, gas pressure, sound, volatile organic compounds, or particulate matter. In some embodiments, the irradiation is an external radiation impinging on the real facility and/or penetrating the real facility. In some embodiments, the gas comprises oxygen, carbon dioxide, carbon monoxide, radon, oxygen, nitrogen, hydrogen sulfide, one or more nitrogen oxide pollutants (NOx), or water vapor. In some embodiments, the method further comprises displaying the digital twin as it is affected by the environmental attribute on a user interface to visualize the digital twin in a facility visualizer. In some embodiments, the simulation is a time varied simulation. In some embodiments, the method further comprises saving the time varied simulation. In some embodiments, the method further comprises using the facility visualizer to solicit an input from a user that affects one or more aspects of the digital twin. In some embodiments, the at least one device comprises a tintable window, a sensor, and emitter, a controller, a transceiver, an antenna, a media display, or a device ensemble. In some embodiments, the device ensemble comprises (i) a transceiver, (ii) sensors, or (iii) a sensor and an emitter. In some embodiments, the digital twin is utilized in controlling the real facility. In some embodiments, the method further comprises adjusting or creating an occupancy region of the real facility. In some embodiments, the at least one device is a plurality of devices, and wherein the method further comprises adjusting or creating a zone of the real facility with which at least a portion of the plurality of devices are associated. In some embodiments, associating the at least the portion of the plurality of devices to the zone. In some embodiments, the at least one device is a plurality of devices of different types, and wherein the method further comprises searching for a type of the different types of the plurality of devices. In some embodiments, the method further comprises presenting the type of the different types of the plurality of devices, in the digital twin. In some embodiments, the at least one device is a plurality of devices, and wherein the method further comprises selecting one device the plurality of devices. In some embodiments, the method further comprises presenting the one device of the plurality of devices, in the digital twin along with its status, network identification, and/or factory information, wherein the network identification is a unique identifier of the one device on a network of the real facility.

In some embodiments, the method further comprises a map of the at least one environmental attribute in the digital twin. In some embodiments, the simulation is a time dependent simulation. In some embodiments, the method further comprises populating the digital twin with input from a user. In some embodiments, a user of the user interface comprises a commissioning personnel, a maintenance personnel, a customer service personnel, or a customer.

In another aspect, a non-transitory computer readable media for visualizing a digital twin of a real facility, the non-transitory computer readable media, when read by one or more processors, is configured to execute operations of any of the methods disclosed above.

In another aspect, an apparatus for simulating a real facility, the apparatus comprises at least one controller configured to execute, or direct execution of, any of the methods disclosed above.

In another aspect, a system for simulating a real facility, the system comprises a network configured to transmit (e.g., communicate) one or more signals associated with any of the methods disclosed above.

In another aspect, a system for simulating a real facility, the system comprises a network configured to: operatively couple to at least one device of the real facility, which at least one device is virtually populated in a digital twin at a virtual location that corresponds to its real location in the real facility, which at least one device is controllable via the network; communicate the digital twin of the real facility, which digital twin is generated at least in part by using a virtual architectural model of a real facility; and communicate a simulation comprising an effect of at least one environmental attribute on the real facility.

In some embodiments, the network is a local network. In some embodiments, the network comprises a cable configured to transmit power and communication in a single cable. The communication can be one or more types of communication. The communication can comprise cellular communication abiding by at least a second generation (2G), third generation (3G), fourth generation (4G) or fifth generation (5G) cellular communication protocol. In some embodiments, the communication comprises media communication facilitating stills, music, or moving picture streams (e.g., movies or videos). In some embodiments, the communication comprises data communication (e.g., sensor data). In some embodiments, the communication comprises control communication, e.g., to control the one or more nodes operatively coupled to the networks. In some embodiments, the network comprises a first (e.g., cabling) network installed in the real facility. In some embodiments, the network comprises a (e.g., cabling) network installed in an envelope of the real facility (e.g., in an envelope of a building included in the real facility).

In another aspect, a non-transitory computer readable media for visualizing a digital twin of a real facility, the non-transitory computer readable media, when read by one or more processors, is configured to execute operations comprises: (i) generating, or directing generation of, a digital twin of a real facility at least in part by using a virtual architectural model of a real facility; (ii) populating, or directing population of, at least one device of the real facility in the digital twin at a virtual location that corresponds to its real location in the real facility, which at least one device is controllable; and (iii) simulating, or directing simulation of, effect of at least one environmental attribute on the real facility. In some embodiments, the operations further comprise displaying, or directing display of, the digital twin as it is affected by the environmental attribute on a user interface to visualize the digital twin.

In another aspect, an apparatus for simulating a real facility, the apparatus comprises at least one controller configured to: (i) generate, or directing generation of, a digital twin of a real facility at least in part by using a virtual architectural model of a real facility; (ii) populate, or direct population of, at least one device of the real facility in the digital twin at a virtual location that corresponds to its real location in the real facility, which at least one device is controllable; and (iii) simulate, or direct simulation of, effect of at least one environmental attribute on the real facility. In some embodiments, the simulation is utilized to control the real facility. In some embodiments, the at least one controller is configured to direct a software application to display the digital twin as it is affected by the environmental attribute on a user interface to visualize the digital twin, wherein the at least one controller is operatively coupled to the application, or incorporates the software application.

In another aspect, the present disclosure provides systems, apparatuses (e.g., controllers), and/or non-transitory computer-readable medium or media (e.g., software) that implement any of the methods disclosed herein.

In another aspect, the present disclosure provides methods that use any of the systems, computer readable media, and/or apparatuses disclosed herein, e.g., for their intended purpose.

In another aspect, an apparatus comprises at least one controller that is programmed to direct a mechanism used to implement (e.g., effectuate) any of the method disclosed herein, which at least one controller is configured to operatively couple to the mechanism. In some embodiments, at least two operations (e.g., of the method) are directed/executed by the same controller. In some embodiments, at less at two operations are directed/executed by different controllers.

In another aspect, an apparatus comprises at least one controller that is configured (e.g., programmed) to implement (e.g., effectuate) any of the methods disclosed herein. The at least one controller may implement any of the methods disclosed herein. In some embodiments, at least two operations (e.g., of the method) are directed/executed by the same controller. In some embodiments, at less at two operations are directed/executed by different controllers.

In some embodiments, one controller of the at least one controller is configured to perform two or more operations. In some embodiments, two different controllers of the at least one controller are configured to each perform a different operation.

In another aspect, a system comprises at least one controller that is programmed to direct operation of at least one another apparatus (or component thereof), and the apparatus (or component thereof), wherein the at least one controller is operatively coupled to the apparatus (or to the component thereof). The apparatus (or component thereof) may include any apparatus (or component thereof) disclosed herein. The at least one controller may be configured to direct any apparatus (or component thereof) disclosed herein. The at least one controller may be configured to operatively couple to any apparatus (or component thereof) disclosed herein. In some embodiments, at least two operations (e.g., of the apparatus) are directed by the same controller. In some embodiments, at less at two operations are directed by different controllers.

In another aspect, a computer software product (e.g., inscribed on one or more non-transitory medium) in which program instructions are stored, which instructions, when read by at least one processor (e.g., computer), cause the at least one processor to direct a mechanism disclosed herein to implement (e.g., effectuate) any of the method disclosed herein, wherein the at least one processor is configured to operatively couple to the mechanism. The mechanism can comprise any apparatus (or any component thereof) disclosed herein. In some embodiments, at least two operations (e.g., of the apparatus) are directed/executed by the same processor. In some embodiments, at less at two operations are directed/executed by different processors.

In another aspect, the present disclosure provides a non-transitory computer-readable program instructions (e.g., included in a program product comprising one or more non-transitory medium) comprising machine-executable code that, upon execution by one or more processors, implements any of the methods disclosed herein. In some embodiments, at least two operations (e.g., of the method) are directed/executed by the same processor. In some embodiments, at less at two operations are directed/executed by different processors.

In another aspect, the present disclosure provides a non-transitory computer-readable medium or media comprising machine-executable code that, upon execution by one or more processors, effectuates directions of the controller(s) (e.g., as disclosed herein). In some embodiments, at least two operations (e.g., of the controller) are directed/executed by the same processor. In some embodiments, at less at two operations are directed/executed by different processors.

In another aspect, the present disclosure provides a computer system comprising one or more computer processors and a non-transitory computer-readable medium or media coupled thereto. The non-transitory computer-readable medium comprises machine-executable code that, upon execution by the one or more processors, implements any of the methods disclosed herein and/or effectuates directions of the controller(s) disclosed herein.

In another aspect, the present disclosure provides a non-transitory computer readable program instructions that, when read by one or more processors, causes the one or more processors to execute any operation of the methods disclosed herein, any operation performed (or configured to be performed) by the apparatuses disclosed herein, and/or any operation directed (or configured to be directed) by the apparatuses disclosed herein.

In some embodiments, the program instructions are inscribed in a non-transitory computer readable medium or media. In some embodiments, at least two of the operations are executed by one of the one or more processors. In some embodiments, at least two of the operations are each executed by different processors of the one or more processors.

In another aspect, the present disclosure provides networks that are configured for transmission of any communication (e.g., signal) and/or (e.g., electrical) power facilitating any of the operations disclosed herein. The communication may comprise control communication, cellular communication, media communication, and/or data communication. The data communication may comprise sensor data communication and/or processed data communication. The networks may be configured to abide by one or more protocols facilitating such communication. For example, a communications protocol used by the network (e.g., with a BMS) can be a building automation and control networks protocol (BACnet). For example, a communication protocol may facilitate cellular communication abiding by at least a 2^{nd}, 3^{rd}, 4^{th}, or 5^{th} generation cellular communication protocol.

The content of this summary section is provided as a simplified introduction to the disclosure and is not intended to be used to limit the scope of any invention disclosed herein or the scope of the appended claims.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

These and other features and embodiments will be described in more detail with reference to the drawings.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings or figures (also “Fig.” and “Figs.” herein), of which:

FIG. 1 is a schematic cross-section depicting formation of an electrochromic device stack;

FIG. 2 schematically shows a control system for a building;

FIG. 3 shows a schematic block diagram of a control system;

FIG. 4 depicts a hierarchal structure in which devices may be arranged;

FIG. 5 schematically depicts a network configuration file used by control logic to perform various functions on a network;

FIG. 6 schematically depicts process of creating a network configuration file;

FIG. 7 depicts an interconnect drawing of an enclosure portion;

FIG. 8 depicts an elevation view of an interconnect drawing;

FIG. 9 schematically shows a block diagram related to commissioning;

FIG. 10 schematically shows a block diagram related to commissioning;

FIG. 11 schematically depicts the use of a Building Information Model (BIM) file to generate a virtual representation of a building;

FIG. 12 schematically depicts a digital twin of an enclosure corresponding to a real enclosure, and a control system;

FIG. 13 shows an example identification label of a target device;

FIG. 14 schematically depicts a system for accounting for devices in an enclosure;

FIG. 15 shows images associate with real and virtual navigation in an environment to identify a target device and/or location of the target device;

FIG. 16 depicts a mobile device scanning an identification code of a target device among target devices;

FIG. 17 depicts a graphical user interface (GUI) portion providing navigation within an augmented reality representation;

FIG. 18 shows a selected target device representation and information stored in a digital twin about the selected target device;

FIG. 19 is a schematic flowchart of a method associated with accounting for target devices;

FIG. 20 is a schematic showing the structure of the facility management application;

FIG. 21 is an example of a graphical user interface portion of the facility management application;

FIG. 22 depicts a schematic flow chart of a process used in design and commissioning;

FIG. 23 schematically depict a processing system;

FIG. 24 schematically depicts time dependent sun position relative to a facility;

FIG. 25 depicts various topographic and schematic representation of an area;

FIG. 26 depicts various topographic and schematic representation of an area;

FIG. 27 depicts a user interface screen of a software application;

FIG. 28 depicts a user interface screen of a software application;

FIG. 29 schematically shows occupancy regions and associated components;

FIG. 30 schematically shows facility portions and associated fields of view and an irradiation zone;

FIG. 31 depicts a user interface screen of a software application;

FIG. 32 depicts a user interface screen of a software application;

FIG. 33 depicts a user interface screen of a software application, and sequence of operations;

FIG. 34 depicts user interface screens of a software application; and

FIG. 35 schematically shows an Isovist in a building.

The figures and components therein may not be drawn to scale. Various components of the figures described herein may not be drawn to scale.

### DETAILED DESCRIPTION

While various embodiments of the invention have been shown, and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein might be employed.

Terms such as “a,” “an,” and “the” are not intended to refer to only a singular entity but include the general class of which a specific example may be used for illustration. The terminology herein is used to describe specific embodiments of the invention(s), but their usage does not delimit the invention(s).

When ranges are mentioned, the ranges are meant to be inclusive, unless otherwise specified. For example, a range between value 1 and value 2 is meant to be inclusive and include value 1 and value 2. The inclusive range will span any value from about value 1 to about value 2. The term “adjacent” or “adjacent to,” as used herein, includes “next to,” “adjoining,” “in contact with,” and “in proximity to.”

As used herein, including in the claims, the conjunction “and/or” in a phrase such as “including X, Y, and/or Z”, refers to in inclusion of any combination or plurality of X, Y, and Z. For example, such phrase is meant to include X. For example, such phrase is meant to include Y. For example, such phrase is meant to include Z. For example, such phrase is meant to include X and Y. For example, such phrase is meant to include X and Z. For example, such phrase is meant to include Y and Z. For example, such phrase is meant to include a plurality of Xs. For example, such phrase is meant to include a plurality of Ys. For example, such phrase is meant to include a plurality of Zs. For example, such phrase is meant to include a plurality of Xs and a plurality of Ys. For example, such phrase is meant to include a plurality of Xs and a plurality of Zs. For example, such phrase is meant to include a plurality of Ys and a plurality of Zs. For example, such phrase is meant to include a plurality of Xs and Y. For example, such phrase is meant to include a plurality of Xs and Z. For example, such phrase is meant to include a plurality of Ys and Z. For example, such phrase is meant to include X and a plurality of Ys. For example, such phrase is meant to include X and a plurality of Zs. For example, such phrase is meant to include Y and a plurality of Zs. The conjunction “and/or” is meant to have the same effect as the phrase “X, Y, Z, or any combination or plurality thereof.” The conjunction “and/or” is meant to have the same effect as the phrase “one or more X, Y, Z, or any combination thereof.”

The term “operatively coupled” or “operatively connected” refers to a first element (e.g., mechanism) that is coupled (e.g., connected) to a second element, to allow the intended operation of the second and/or first element. The coupling may comprise physical or non-physical coupling (e.g., communicative coupling). The non-physical coupling may comprise signal-induced coupling (e.g., wireless coupling). Coupled can include physical coupling (e.g., physically connected), or non-physical coupling (e.g., via wireless communication). Operatively coupled may comprise communicatively coupled.

An element (e.g., mechanism) that is “configured to” perform a function includes a structural feature that causes the element to perform this function. A structural feature may include an electrical feature, such as a circuitry or a circuit element. A structural feature may include an actuator. A structural feature may include a circuitry (e.g., comprising electrical or optical circuitry). Electrical circuitry may comprise one or more wires. Optical circuitry may comprise at least one optical element (e.g., beam splitter, mirror, lens and/or optical fiber). A structural feature may include a mechanical feature. A mechanical feature may comprise a latch, a spring, a closure, a hinge, a chassis, a support, a fastener, or a cantilever, and so forth. Performing the function may comprise utilizing a logical feature. A logical feature may include programming instructions. Programming instructions may be executable by at least one processor. Programming instructions may be stored or encoded on a medium accessible by one or more processors. Additionally, in the following description, the phrases “operable to,” “adapted to,” “configured to,” “designed to,” “programmed to,” or “capable of” may be used interchangeably where appropriate.

Further, as used herein, the terms pane, and lite are used interchangeably. An electrochromic window may be in the form of an insulated glass unit (IGU), a laminate structure or both, e.g., where an IGU has one or more laminated panes as its lites, e.g., a double pane IGU where one pane is a single sheet of glass and the other pane is a laminate of two sheets of glass. A laminate may include two, three or more sheets of glass.

At times, installation personnel (e.g., field service engineers) install the wrong window at a particular location in an enclosure (e.g., building of a facility). Commissioning may correct installation errors. Commissioning may allow a device (e.g., window) of a particular type to be randomly installed throughout a building or site. For example, all optically switchable windows having the same dimensions may be installed randomly, at locations having openings that can accommodate windows having these dimensions. Commissioning may account for identifying the specific device as located in a specific location in the enclosure.

In some embodiments, commissioning comprises associating physical devices, within a building, with identifying data (e.g., network IDs) that allows the physical devices to be accounted for, tracked, and/or electrically reachable (when they are coupled to a network). Commissioned devices that are operatively (e.g., communicatively) coupled to the network, may be accessed via a network. Commissioned devices at locations known through the commissioning process, may be controlled via commands sent to network addresses associated with the devices via commissioning. Commissioning may ensure that tint commands, sensor readings, etc. that are provided by or to control logic are associated with the correct physical devices, which have known locations and/or connectivity (e.g., connectivity point, hub, and/or address) to the network.

As buildings become larger, and as the quantity of devices in buildings increases, the commissioning process can consume substantial time, and effort. When the devices are of a diverse nature, their commissioning may require personnel having different specialties to install and/or configure. In some cases, commissioning can take weeks or even months to complete. In some cases, commissioning techniques require a user to wait for a device action to accurately configure it. For example, the installer may have to wait for a window to tint, which may take several minutes.

Certain embodiments described herein may allow more rapid commissioning of devices. In some cases, a capturing device (e.g., sensor such as a RF reader, a camera or other imaging device) is placed in a region of an enclosure (e.g., in a lobby of a building) having devices to be commissioned. The capturing device may be operated to capture an image and/or identification tag of devices to be commissioned in the region. In some embodiments, every device in the region is captured. Commissioning logic may associate the device images with locations in a two-dimensional or three-dimensional format of a digital twin of the enclosure, and thereby identify the locations of the one or more devices in the region. The captured information (e.g., images) may capture some distinctive characteristic of the device(s). In certain embodiments, the distinctive characteristic is a permanently or temporarily applied indicator such as an ID tag (e.g., having a barcode, a QR code, or another type of image-discernable identifier; or an emitting tag such as an RFID).

In some implementations, the commissioning logic reads or otherwise identifies information contained in the identifiers (e.g., ID tag) to uniquely identify the one or more devices. In certain embodiments, the commissioning logic additionally identifies locations in a region of the enclosure that hold the one or more devices that have been identified by their identifiers. When coupling the device IDs with their location information, the commissioning logic may associate uniquely identified devices with their locations.

In some embodiments, a commissioning method may comprise providing a capturing device in an enclosure region having one or more devices to be commissioned. The one or more devices may have identifiers, which are unique among devices to be installed in the enclosure region. Such identifiers may be accessible for imaging by an image capture device. The ID capture device may capture one or more images of the one or more devices to be commissioned. By using images taken by the image capture device, the locations of the one or more devices in the images of the enclosure region may be determined (e.g., using machine image recognition). Any interprets image-discernible identifiers contained in the images captured by the capture device may be determined (e.g., using machine image recognition). For example, identifying individual device by their unique identifiers. The identified devices may be associated with their locations. The location and/or identifier pairs for the one or more devices may be stored (e.g., in one or more databases) and/or transmitted (e.g., wired and/or wirelessly, e.g., using the network).

In some embodiments, the optically recognized identity may be a machine-readable code, e.g., consisting of a digital picture, RFID. The digital picture may comprise an array or lines of two distinctly identifiable hues (e.g., colors). The digital picture may comprise an array of black and white squares or lines (e.g., barcode or a Quick Response (QR) code). The traveler may use a mobile device (e.g., cellular smartphone) or an associated peripheral device (e.g., barcode scanner) to record and/or scan the identity of the device. In some embodiments, a RFID (e.g., UWB ID) tag is attached to the device. The Radio-frequency identification (RFID) utilize electromagnetic fields to automatically identify and/or track tags attached to a device. The RFID tag cam comprise a (e.g., micro) radio transponder, a radio receiver, and a transmitter. The reader of the RFID tag may send an electromagnetic interrogation pulse, and the tag may respond by transmitting digital data (e.g., an identifying inventory number) back to the reader. The tag can be passive (e.g., powered by energy from the RFID reader's interrogating radio waves), or active (e.g., powered by a battery). The active RFID tags may have a greater range as compared with the passive RFID tags. For example, the active RFID may have a range of at least about 20 m, 50 m, 100 m, or 500 m. The ID code (e.g., barcode or QR code) may need to be within a light of sight of the (e.g., human) traveler. The ID code (e.g., RFID) may not be within a line of sight of the (e.g., human) traveler, but within the range of the reader (e.g., sensor). The data capture may be an automatic identification and data capture (AIDC). The ID tag may comprise a microchip. The ID tag and/or code may be attached to (and/or embedded in) any device to be identified.

In some embodiments, the ID tag is an image discernable identifier (e.g., barcode or QR code). The image discernable identifier may be any of various identifiers that can be provided in an image obtained with an image capture device. In various embodiments, an image of the image-discernible identifier can be interpreted by image analysis logic to determine a code or other information encoded or otherwise represented by the identifier

In certain embodiments, the image-discernible identifier comprises a pattern that contains the information in the spatial arrangement of elements in the pattern. The arrangement may contain information in one, two, or three dimensions. It may take the form of dots, bars, polygons, and/or other shapes. The identifier may be detectable in any one or more ranges of the electromagnetic spectrum, including the visible range, the ultraviolet range, the infrared range, and/or the radiofrequency range. The identifier may be detectable by reflection, absorption, refraction, fluorescence, luminescence, and/or other electromagnetic (EM) wave interaction. Examples of the image-discernable identifier include bar codes, QR codes, and the like. The image-discernible identifier may come in a wide range of sizes and/or shapes. In certain embodiments, the identifier has a fundamental length scale (FLS) of at least about 10 cm, or 15 cm (e.g., the identifier may be about 10 cm×10 cm or larger, or the identifier is about 15 cm×15 cm or larger). A fundamental length scale (FLS) comprises a height, length, width, diameter, or diameter of a bounding circle.

Application of the image discernible identifier to a device (or any components associated therewith) may be made at any point before updating the digital twin. In certain embodiments, the application is made at a manufacturing site. There, an identifier may be associated with the device. In certain embodiments, the identifier is permanently or temporarily affixed to the device. In some cases, the identifier is provided as a sticker, a polymeric peel off patch, and the like. In some cases, the identifier is embedded within the device (e.g., RFID)

An identifier may be applied to any region of a device or device-associated component for which an ID can be captured using the capture device. Examples include transparent or reflective lites, including optically switchable lites, window frames, window controllers, sensors or sensor ensembles associated with windows, mullions, and/or non-lite IGU components such as spacers.

In certain embodiments, images of devices in a region of an enclosure may be obtained by placing a camera or other image capture device in the region and moving the image capture device to capture an image of multiple windows or some recognizable feature of the windows in the region. Moving the image capture device may comprise pivoting or rotating the device while it remains at a fixed position within the room or region. The pivoting or rotating may allow the device to capture images at multiple angles in the region with respect to the fixed position. In certain embodiments, the image capture device is positioned at or near a geometric center of the room or other region. Moving the image capture device may alternatively or additionally comprise moving the physical location of the device to multiple different locations within the region.

In certain embodiments, the image capture device and/or associated logic is configured to take a sequence of images while moving the device (e.g., rotating to capture images at multiple angles) and stitch the images together to form a panoramic view. In certain embodiments, the camera scans an arc of the room, e.g., at least about a 90° arc, 180° arc, 270° arc, or a full 360° circle. In certain embodiments, the time elapsed to take the sequence of images is at most about 1 hour, 30 minutes, or 15 minutes. In this time, the device may capture images of at least about 4 devices, 7 devices, or 10 devices. In certain embodiments, the image capture device is configured to capture multiple images of devices or device components from a distance (e.g., as opposed to needing to hold a manual capturing device individually next to each window or its indicia). The image capture device and any associated apparatus (e.g., a tripod or other mount) may be movable from one region of the enclosure to another (e.g., from room-to-room in the building being commissioned).

In certain embodiments, commissioning logic or other appropriate logic is configured to compare a panoramic image or sequence of images from a region of an enclosure with an architectural representation of the region so that the devices in the image(s) can be associated with actual locations of windows in the enclosure. In some implementations, the logic is configured to superimpose the image(s) over a three-dimensional drawings such as architectural drawings. The logic may be configured to determine on a multi-dimensional (e.g., 2D or 3D) drawing where particular imaged devices are located. Representations of the physical locations of the devices in an enclosure may be provided in digital twin, an interconnect drawing, architectural drawing, or other representation of a building. In certain embodiments, the logic employs a floorplan, which may be created from architectural drawings. In certain embodiments, logic employs an interconnect drawing, which may depict wire routing (e.g., trunk lines) at a region of building, the positioning of various devices on the network (e.g., controllers, power supplies, control panels, windows, and sensors), and/or identifying information of network components (e.g., a network ID). In certain embodiments, logic employs a wireframe model from CAD software such as Trimble Navigation's SketchUp™, Autodesk Revit, or the like. The “commissioning logic” may include a process implemented in software, on one or more controllers of a window network, and/or on one or more processors of a computational system (which may be a standalone or distributed computational system).

In some embodiments, the images and their physical locations as captured by the device are provided to software that recognizes the unique identifier in the device with particular device locations as identified (i) in the image captured information, (ii) by the sensor and/or emitter network in the enclosure, and/or (iii) by any other geo-location technology (e.g., as disclosed herein).

In some embodiments, the individual devices are not associated with particular network addresses. This association can be accomplished during or after manufacturing of devices and prior to installation of the devices in the enclosure and coupling the devices to the network. The network association of devices may involve creating an association between the unique physical identifier of the device (as captured by the ID capturing device) and a network recognizable identifier of the device. The network recognizable identifier of the device may be a serial number or other electronic identifier of the device that is stored in at least one database. The at least one database may be stored in memory. The memory may reside in a chip or in another device (e.g., server) that is readable by the network when the device is installed. In certain embodiments, the network recognizable identifier is provided in a readable chip such as a memory chip in the pigtail of a window.

To allow commissioning, the ID code may be associated with a characteristic and/or component of the device (e.g., a lite ID, serial number or other data electronically encoded and stored on a network readable component of the window). The association may be stored in at least one table, database, and/or other data construct.

In some cases, the multi-dimensional (e.g., two- or three-dimensional model of a building (e.g., that is included in the digital twin)) is produced by a computer-aided design software which has a modeling environment for the design and examination of building structures. In some cases, pairing the network ID of each of the tintable (e.g., optically switchable) windows with at least one network node ID includes storing each pairing in a network configuration file. A node can be a device that is operatively (e.g., communicatively) coupled to the network.

In some embodiments, an enclosure comprises an area defined by at least one structure. The at least one structure may comprise at least one wall. An enclosure may comprise and/or enclose one or more sub-enclosure. The at least one wall may comprise metal (e.g., steel), clay, stone, plastic, glass, plaster (e.g., gypsum), polymer (e.g., polyurethane, styrene, or vinyl), asbestos, fiber-glass, concrete (e.g., reinforced concrete), wood, paper, or a ceramic. The at least one wall may comprise wire, bricks, blocks (e.g., cinder blocks), tile, drywall, or frame (e.g., steel frame).

In some embodiments, the enclosure comprises one or more openings. The one or more openings may be reversibly closable. The one or more openings may be permanently open. A fundamental length scale of the one or more openings may be smaller relative to the fundamental length scale of the wall(s) that define the enclosure. A fundamental length scale may comprise a diameter of a bounding circle, a length, a width, or a height. A surface of the one or more openings may be smaller relative to the surface the wall(s) that define the enclosure. The opening surface may be a percentage of the total surface of the wall(s). For example, the opening surface can measure at most about 30%, 20%, 10%, 5%, or 1% of the walls(s). The wall(s) may comprise a floor, a ceiling, or a side wall. The closable opening may be closed by at least one window or door. The enclosure may be at least a portion of a facility. The facility may comprise a building. The enclosure may comprise at least a portion of a building. The building may be a private building and/or a commercial building. The building may comprise one or more floors. The building (e.g., floor thereof) may include at least one of: a room, hall, foyer, attic, basement, balcony (e.g., inner or outer balcony), stairwell, corridor, elevator shaft, façade, mezzanine, penthouse, garage, porch (e.g., enclosed porch), terrace (e.g., enclosed terrace), cafeteria, and/or Duct. In some embodiments, an enclosure may be stationary and/or movable (e.g., a train, an airplane, a ship, a vehicle, or a rocket).

In some embodiments, a plurality of target devices may be operatively (e.g., communicatively) coupled to the control system. The plurality of devices may be disposed in a facility (e.g., including a building and/or room). The control system may comprise the hierarchy of controllers. The target devices may comprise an emitter, a sensor, or a (e.g., tintable) window (e.g., IGU). The device may be any device as disclosed herein. At least two of the plurality of devices may be of the same type. For example, two or more IGUs may be coupled to the control system. At least two of the plurality of devices may be of different types. For example, a sensor and an emitter may be coupled to the control system. At times, the plurality of devices may comprise at least 20, 50, 100, 500, 1000, 2500, 5000, 7500, 10000, 50000, 100000, or 500000 devices. The plurality of devices may be of any number between the aforementioned numbers (e.g., from 20 devices to 500000 devices, from 20 devices to 50 devices, from 50 devices to 500 devices, from 500 devices to 2500 devices, from 1000 devices to 5000 devices, from 5000 devices to 10000 devices, from 10000 devices to 100000 devices, or from 100000 devices to 500000 devices). For example, the number of windows in a floor may be at least 5, 10, 15, 20, 25, 30, 40, or 50. The number of windows in a floor can be any number between the aforementioned numbers (e.g., from 5 to 50, from 5 to 25, or from 25 to 50). At times, the devices may be in a multi-story building. At least a portion of the floors of the multi-story building may have devices controlled by the control system (e.g., at least a portion of the floors of the multi-story building may be controlled by the control system). For example, the multi-story building may have at least 2, 8, 10, 25, 50, 80, 100, 120, 140, or 160 floors that are controlled by the control system. The number of floors (e.g., devices therein) controlled by the control system may be any number between the aforementioned numbers (e.g., from 2 to 50, from 25 to 100, or from 80 to 160). The floor may be of an area of at least about 150 m², 250 m², 500 m², 1000 m², 1500 m², or 2000 square meters (m²). The floor may have an area between any of the aforementioned floor area values (e.g., from about 150 m² to about 2000 m², from about 150 m² to about 500 m² from about 250 m² to about 1000 m², or from about 1000 m² to about 2000 m²).

Certain disclosed embodiments provide a network infrastructure in the enclosure (e.g., a facility such as a building). The network infrastructure is available for various purposes such as for providing communication and/or power services. The communication services may comprise high bandwidth (e.g., wireless and/or wired) communications services. The communication services can be to occupants of a facility and/or users outside the facility (e.g., building). The network infrastructure may work in concert with, or as a partial replacement of, the infrastructure of one or more cellular carriers. The network infrastructure can be provided in a facility that includes electrically switchable windows. Examples of components of the network infrastructure include a high speed backhaul. The network infrastructure may include at least one cable, switch, physical antenna, transceivers, sensor, transmitter, receiver, radio, processor and/or controller (that may comprise a processor). The network infrastructure may be operatively coupled to, and/or include, a wireless network. The network infrastructure may comprise wiring. One or more sensors can be deployed (e.g., installed) in an environment as part of installing the network and/or after installing the network. The network may be a local network. The network may comprise a cable configured to transmit power and communication in a single cable. The communication can be one or more types of communication. The communication can comprise cellular communication abiding by at least a second generation (2G), third generation (3G), fourth generation (4G) or fifth generation (5G) cellular communication protocol. The communication may comprise media communication facilitating stills, music, or moving picture streams (e.g., movies or videos). The communication may comprise data communication (e.g., sensor data). The communication may comprise control communication, e.g., to control the one or more nodes operatively coupled to the networks. The network may comprise a first (e.g., cabling) network installed in the facility. The network may comprise a (e.g., cabling) network installed in an envelope of the facility (e.g., such as in an envelope of an enclosure of the facility. For example, in an envelope of a building included in the facility).

In various embodiments, a network infrastructure supports a control system for one or more windows such as tintable (e.g., electrochromic) windows. The control system may comprise one or more controllers operatively coupled (e.g., directly or indirectly) to one or more windows. While the disclosed embodiments describe tintable windows (also referred to herein as “optically switchable windows,” or “smart windows”) such as electrochromic windows, the concepts disclosed herein may apply to other types of switchable optical devices comprising a liquid crystal device, an electrochromic device, suspended particle device (SPD), NanoChromics display (NCD), Organic electroluminescent display (OELD), suspended particle device (SPD), NanoChromics display (NCD), or an Organic electroluminescent display (OELD). The display element may be attached to a part of a transparent body (such as the windows). The tintable window may be disposed in a (non-transitory) facility such as a building, and/or in a transitory facility (e.g., vehicle) such as a car, RV, bus, train, airplane, helicopter, ship, or boat.

In some embodiments, a tintable window exhibits a (e.g., controllable and/or reversible) change in at least one optical property of the window, e.g., when a stimulus is applied. The change may be a continuous change. A change may be to discrete tint levels (e.g., to at least about 2, 4, 8, 16, or 32 tint levels). The optical property may comprise hue, or transmissivity. The hue may comprise color. The transmissivity may be of one or more wavelengths. The wavelengths may comprise ultraviolet, visible, or infrared wavelengths. The stimulus can include an optical, electrical and/or magnetic stimulus. For example, the stimulus can include an applied voltage and/or current. One or more tintable windows can be used to control lighting and/or glare conditions, e.g., by regulating the transmission of solar energy propagating through them. One or more tintable windows can be used to control a temperature within a building, e.g., by regulating the transmission of solar energy propagating through the window. Control of the solar energy may control heat load imposed on the interior of the facility (e.g., building). The control may be manual and/or automatic. The control may be used for maintaining one or more requested (e.g., environmental) conditions, e.g., occupant comfort. The control may include reducing energy consumption of a heating, ventilation, air conditioning and/or lighting systems. At least two of heating, ventilation, and air conditioning may be induced by separate systems. At least two of heating, ventilation, and air conditioning may be induced by one system. The heating, ventilation, and air conditioning may be induced by a single system (abbreviated herein as “HVAC”). In some cases, tintable windows may be responsive to (e.g., and communicatively coupled to) one or more environmental sensors and/or user control. Tintable windows may comprise (e.g., may be) electrochromic windows. The windows may be located in the range from the interior to the exterior of a structure (e.g., facility, e.g., building). However, this need not be the case. Tintable windows may operate using liquid crystal devices, suspended particle devices, microelectromechanical systems (MEMS) devices (such as microshutters), or any technology known now, or later developed, that is configured to control light transmission through a window. Windows (e.g., with MEMS devices for tinting) are described in U.S. Pat. No. 10,359,681, issued Jul. 23, 2019, filed May 15, 2015, titled “MULTI-PANE WINDOWS INCLUDING ELECTROCHROMIC DEVICES AND ELECTROMECHANICAL SYSTEMS DEVICES,” and incorporated herein by reference in its entirety. In some cases, one or more tintable windows can be located within the interior of a building, e.g., between a conference room and a hallway. In some cases, one or more tintable windows can be used in automobiles, trains, aircraft, and other vehicles, e.g., in lieu of a passive and/or non-tinting window.

Electrochromic windows may be used in a variety of settings, for example in office buildings and residential buildings. The complexity of many conventional electrochromic windows (e.g., wiring, installation, and programming of a controller, etc.) may discourage their use. For example, residential customers are likely to have windows installed by local contractors who may be unfamiliar with electrochromic windows and their installation requirements. As such, one goal in certain disclosed embodiments is to provide electrochromic IGUs and window assemblies that are as easy to install as non-electrochromic windows. Certain disclosed features that promote easy installation include wireless power capability and/or self-power capability, wireless control communication, self-meshing networks, on-board controllers, automated commissioning, and a form factor matching commonly available windows, e.g., double-pane or triple-pane IGUs. Easy installation may refer to installation that is quick, requires labor with minimal qualifications, robust (e.g., not prone to errors), and cheap. Other target devices that may be included in various embodiments include, cellular or other antenna (e.g., provided on a window), a cellular repeater (e.g., in a controller), touch panel controls (e.g., attached to a media display construct), mountable and/or removable controllers, learning functionality, weather tracking, sharing of sensor outputs and other control information (e.g., between devices coupled to the network such as windows), sub-frames that may include certain controller components, wireless bus bars, optical (e.g., built-in photo) sensors, other sensors, etc. Any two or more of these target devices may be combined as requested for a particular application.

A challenge presented by deployment of target devices in an enclosure (e.g., target devices of the nascent electrochromic window technology) is correct assignment of network addresses and/or other identifying information to specific target devices (e.g., windows) and their electrical controllers (window controllers), as well the locations of the target devices (e.g., windows and/or window controllers) in facility (e.g., buildings).

In some embodiments, control of the target devices by the control system necessitates coupling of the control to a target device that is (i) correctly identifiable by the control system and/or network, (ii) is in a particular location, and (iii) is of a particular type. For example, in order to control tint controls of the tintable window (e.g., to allow the control system to change the tint state of one or a set of specific windows or IGUs), a (e.g., master) controller (responsible for tint decisions) may be provided with the network address of the window controller(s) connected to that specific window or set of windows. For example, in order to control a temperature of an atmosphere in a room of a building (e.g., to allow the control system to change the tint state of one or a set of HVAC components), a controller (responsible for environmental temperature) may be provided with the network address of the HVAC component (e.g., vent and blower unit) coupled to that specific room.

In some embodiments, manual (e.g., user) control of target devices affecting a particular location or locations in an enclosure depends on the collection of unique information regarding the identity, installation location, and/or capabilities of each target device. The unique information about each target device may be incorporated into the digital twin of the enclosure. A control interface to the digital twin can be configured to permit authorized users to initiate changes in the operation of target devices in a straightforward manner, e.g., since the digital twin links up each represented target element with (e.g., all) the needed information to select and/or control that target device.

For example, a challenge presented by tintable (e.g., electrochromic) window technology is manual control of (e.g., electrochromic device) tint states in specific windows of a building having many such tintable windows. Related to this is access to information about individual tintable (e.g., electrochromic) windows or zones in a building having many tintable windows. Building administrators and/or occupants may need at least some control over some (or all) tintable (e.g., electrochromic) windows in a facility (e.g., building).

In some embodiments, an IGU or other window assembly is provided as a simple, self-contained, ready-to-go unit that requires at most minimal physical connection (e.g., wires) before use. Such a unit can look like a non-tintable (e.g., electrochromic) IGU or window assembly (with a controller somewhere therein or thereon). The tintable (e.g., electrochromic) IGU may be installed in substantially the same manner as a non-tintable IGU. These embodiments may be beneficial for residential customers who request a quick install without significant additional work related to routing electrical power, communication lines, etc.

In some embodiments of an electrochromic device, first and second electrochromic layers include a cathodically tinting layer and an anodically tinting layer. In such embodiments, the first and second electrochromic layers will tint when exposed to opposite polarities. For example, the first electrochromic layer may tint under an applied cathodic potential (and clear under an applied anodic potential), while the second electrochromic layer may tint under an applied anodic potential (and clear under an applied cathodic potential). Of course, the arrangement can be reversed for some applications. Either way, the first and second electrochromic layers may work in concert to tint and clear.

In some embodiments, one of the first and second electrochromic layers can be substituted with a non-electrochromic ion storage layer. In such cases, (e.g., only) one of the two layers exhibits electrochromism such that it tints and clears under application of suitable potentials. The other layer, sometimes referred to as a counter electrode layer, simply serves as an ion reservoir when the other layer is exposed to a cathodic potential.

In some embodiments, a device stack has distinct layers, while in other embodiments, electrochromic stacks may be graded structures or may include additional components such as an antenna structure. While some of the discussion in the present disclosure focuses on windows having electrochromic devices, the disclosure may more generally pertains to windows having any type of optically switchable device such as liquid crystal devices and suspended particle devices, as well as to target devices other than tintable windows including any electrically controllable devices such as a sensor, an emitter, an ensemble of sensors and/or emitters, a media display construct, an antenna, a router, a transceiver, a controller (e.g., microcontroller), a processor, a table, a chair, a door, a lighting device, a heater, a ventilator, an air-conditioning device, an alarm, or any other identifiable device associated with the facility.

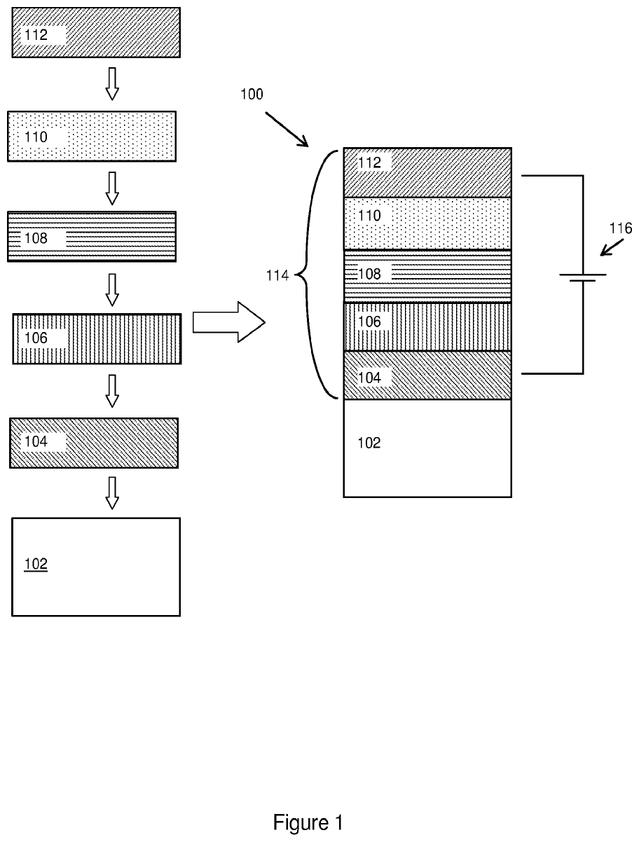

FIG. 1 depicts an electrochromic device 100 disposed on a substrate 102. Device 100 includes, in the following order starting from the substrate, a first conductive layer 104, a first electrochromic layer (EC1) 106, an ion conductor layer (IC) 108, a second electrochromic layer (EC2) 110, and a second conductive layer 112. Components 104, 106, 108, 110, and 112 are collectively referred to as an electrochromic stack 114. In some embodiments, the transparent conductor layers are made of a transparent material such as a transparent conductive oxide, which may be referred to as a “TCO.” Since the TCO layers are transparent, the tinting behavior of the EC1-IC-EC2 stack may be observable through the TCO layers, for example, allowing use of such devices on a window for reversible shading. A voltage source 116, operable to apply an electric potential across electrochromic stack 114, effects the transition of the electrochromic device from, for example, a clear state (i.e., transparent) to a tinted state. In some embodiments, the electrochromic device may not include a distinct ion conductor layer. See U.S. Pat. No. 8,764,950 issued Jul. 1, 2014, and PCT Publication No. WO2015/168626, field May 1, 2015, both of which are incorporated herein by reference in their entireties.

In some embodiments, an IGU includes two (or more) substantially transparent substrates, for example, two panes of glass, where at least one substrate includes an electrochromic device disposed thereon, and the panes have a separator disposed between them. An IGU may be hermetically (e.g., gas) sealed, having an interior region that is isolated from the ambient environment. A “window assembly” may include an IGU or for example a stand-alone laminate, and includes electrical leads for connecting the IGU's or laminate's of the one or more electrochromic devices to a voltage source, switches, and the like, and may include a frame that supports the IGU or laminate. A window assembly may include, or be operatively (e.g., communicatively) coupled to, a window controller (e.g., as described herein), and/or components of a window controller (e.g., a dock).

Window controllers may have many sizes, formats, and locations with respect to the optically switchable window(s) they control. The controller may be attached to glass of an IGU and/or laminate. The controller may be disposed in a frame that houses the IGU and/or laminate. A tintable (e.g., electrochromic) window may include one, two, three or more individual electrochromic panes (an electrochromic device on a transparent substrate). An individual pane of an electrochromic window may have an electrochromic coating that has independently tintable zones. A controller as described herein may control all electrochromic coatings associated with such windows, whether the electrochromic coating is monolithic or zoned.

The controller may be generally disposed in close proximity to the tintable (e.g., electrochromic) window, generally adjacent to, on the glass, or inside an IGU, (e.g., within a frame of the self-contained assembly). In some embodiments, the window controller is an “in situ” controller; that is, the controller is part of a window assembly, an IGU and/or a laminate. The controller may not have to be matched with the tintable window, and installed, in the field, e.g., the controller travels with the window as part of the assembly from the factory. The controller may be installed in the window frame of a window assembly or be part of an IGU and/or laminate assembly. The controller may be mounted on or between panes of the IGU or on a pane of a laminate. In cases where a controller is located on the visible portion of an IGU, at least a portion of the controller may be (e.g., substantially) transparent. Further examples of on-glass controllers are provided in U.S. patent application Ser. No. 14/951,410, filed Nov. 24, 2015, titled “SELF CONTAINED EC IGU,” which is herein incorporated by reference in its entirety. In some embodiments, a localized controller is provided as more than one part, with at least one part (e.g., including a memory component storing information about the associated tintable window) being provided as a part of the window assembly and at least one other part being separate and configured to mate with the at least one part that is part of the window assembly, IGU or laminate. In some embodiments, a controller is an assembly of interconnected parts that are not in a single housing, but rather spaced apart, e.g., in the secondary seal of an IGU. In some embodiments the controller is a compact unit, e.g., in a single housing or in two or more components that combine, e.g., a dock and housing assembly, that is proximate the glass, not in the viewable area, or mounted on the glass in the viewable area.

In one embodiment, the controller is incorporated into or onto the IGU and/or the window frame prior to installation of the tintable window. In one embodiment, the controller is incorporated into or onto the IGU and/or the window frame prior to leaving the manufacturing facility. In one embodiment, the controller is incorporated into the IGU, substantially within the secondary seal. In another embodiment, the controller is incorporated into or onto the IGU, partially, substantially, or wholly within a perimeter defined by the primary seal between the sealing separator and the substrate.

Having the controller as part of an IGU and/or a window assembly, the IGU can possess logic and/or features of the controller that, e.g., travels with the IGU or window unit. For example, when a controller is part of an IGU assembly having an electrochromic window, in the event the characteristics of the electrochromic device(s) change over time (e.g., through degradation), a characterization function may be used, for example, to update control parameters used to drive tint state transitions. In another embodiment, if already installed in a tintable window unit, the logic and/or features of the controller may be used to calibrate one or more of the control parameters, e.g., to match the intended installation. If already installed, the one or more control parameters may be recalibrated to match the performance characteristics of the tintable window(s).

In some embodiments, a controller is not pre-associated with a window, but rather a dock component, e.g., having parts generic to any tintable window, is associated with each window at the factory. After window installation, or otherwise in the field, a second component of the controller may be combined with the dock component to complete the tintable window controller assembly. The dock component may include a chip which is programmed at the factory with the physical characteristics and/or parameters of the particular window to which the dock is attached (e.g., on the surface which will face the building's interior after installation, sometimes referred to as surface 4 or “S4”). The second component (sometimes called a “carrier,” “casing,” “housing,” or “controller”) may be mated with the dock, and when powered, the second component can read the chip and configure itself to power the window according to the particular characteristics and parameters stored on the chip. In this way, the shipped window need (e.g., only) have its associated parameters stored on a chip, which is integral with the window, while the more sophisticated circuitry and components can be combined later (e.g., shipped separately and installed by the window manufacturer after the glazier has installed the windows, followed by commissioning by the window manufacturer). In some embodiments, the chip is included in a wire or wire connector attached to the window controller. Such wires with connectors are sometimes referred to as pigtails.

As used herein, the term “outboard” means closer to the outside environment, while the term “inboard” means closer to the interior of a building. For example, in the case of an IGU having two panes, the pane located closer to the outside environment is referred to as the outboard pane or outer pane, while the pane located closer to the inside of the building is referred to as the inboard pane or inner pane. The different surfaces of the IGU may be referred to as S1, S2, S3, and S4 (assuming a two-pane IGU). S1 refers to the exterior-facing surface of the outboard lite (i.e., the surface that can be physically touched by someone standing outside). S2 refers to the interior-facing surface of the outboard lite. S3 refers to the exterior-facing surface of the inboard lite. S4 refers to the interior-facing surface of the inboard lite (i.e., the surface that can be physically touched by someone standing inside the building). In other words, the surfaces are labeled S1-S4, starting from the outermost surface of the IGU and counting inwards. In cases where an IGU includes three panes, this same trend holds (with S6 being the surface that can be physically touched by someone standing inside the building). In some embodiments employing two panes, the electrochromic device (or other optically switchable device) is disposed on S3.

Examples of tintable windows, window controllers, their methods of use and their features are presented in U.S. patent application Ser. No. 15/334,832, filed Oct. 26, 2016, titled “CONTROLLERS FOR OPTICALLY-SWITCHABLE DEVICES,” and U.S. patent application Ser. No. 16/082,793, filed Sep. 6, 2018, titled “METHOD OF COMMISSIONING ELECTROCHROMIC WINDOWS,” each of which is herein incorporated by reference in its entirety.

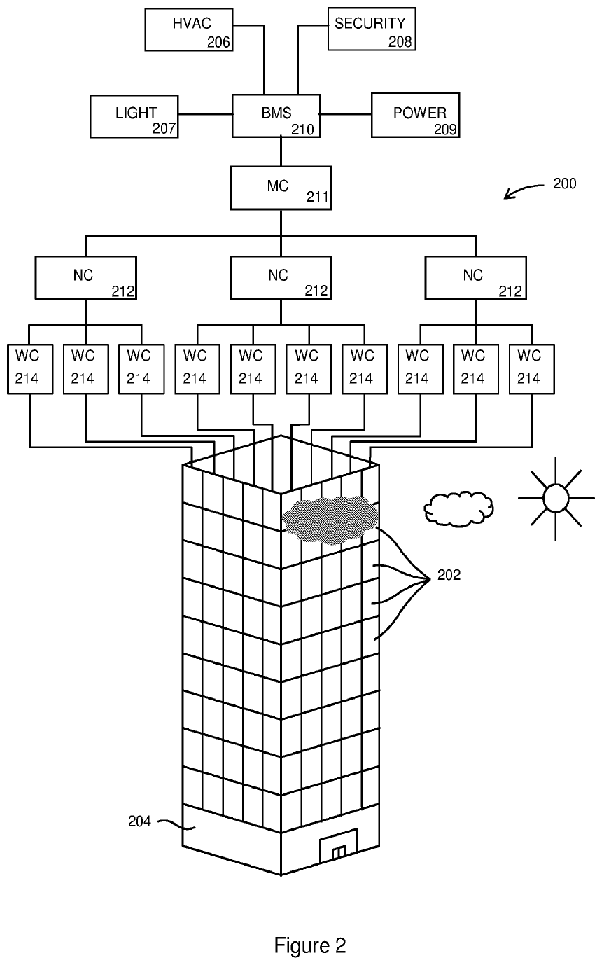

FIG. 2 shows a depiction of a system 200 for controlling and driving a plurality of tintable windows. It may be employed to control the operation of one or more devices associated with a tintable window such as a window antenna. The system 200 can be adapted for use with facility (e.g., a building 204) comprising a commercial office building or a residential building. In some embodiments, the system 200 is designed to function in conjunction with modern heating, ventilation, and air conditioning (HVAC) systems 206, interior lighting systems 207, security systems 208, and power systems 209 as a single holistic and efficient energy control system for the entire building 204, or a campus of buildings 204. Some embodiments of the system 200 are particularly well-suited for integration with a building management system (BMS) 210. The BMS 210 is a computer-based control system that can be installed in a building to monitor and control the building's mechanical and electrical equipment such as HVAC systems, lighting systems, power systems, elevators, fire systems, and security systems. The BMS 210 can include hardware and associated firmware or software for maintaining conditions in the building 204 according to preferences set by the occupants or by a building manager or other administrator. The software can be based on, for example, internet protocols or open standards.

A BMS can be used in large buildings where it functions to control the environment within the building. For example, the BMS 210 may control lighting, temperature, carbon dioxide levels, and/or humidity within the building 204. There can be several (e.g., numerous) mechanical and/or electrical devices that are controlled by the BMS 210 including, for example, furnaces or other heaters, air conditioners, blowers, and/or vents. To control the building environment, the BMS 210 can turn on and off these various devices, e.g., according to rules and/or in response to conditions. Such rules and/or conditions may be selected and/or specified by a user (e.g., building manager and/or administrator). One function of the BMS 210 may be to maintain a comfortable environment for the occupants of the building 204, e.g., while minimizing heating and cooling energy losses and costs. In some embodiments, the BMS 210 is configured not (e.g., only) to monitor and control, but also to optimize the synergy between various systems, for example, to conserve energy and lower building operation costs.

Some embodiments are designed to function responsively or reactively based on feedback. The feedback control scheme may comprise measurements sensed through, for example, thermal, optical, or other sensors. The feedback control scheme may comprise input from an HVAC, interior lighting system, and/or an input from a user control. Examples of control system, methods of its use, and its related software, may be found in U.S. Pat. No. 8,705,162, issued Apr. 22, 2014, which is incorporated herein by reference in its entirety. Some embodiments are utilized in existing structures, including commercial and/or residential structures, e.g., having traditional or conventional HVAC and/or interior lighting systems. Some embodiments are retrofitted for use in older facilities (e.g., residential homes).

The system 200 includes network controllers 212 configured to control a plurality of window controllers 214. For example, one network controller 212 may control at least tens, hundreds, or thousands of window controllers 214. Each window controller 214, in turn, may control and drive one or more electrochromic windows 202. In some embodiments, the network controller 212 can issue high level instructions such as the final tint state of a tintable window. The window controllers may receive these commands and directly control their associated windows, e.g., by applying electrical stimuli to appropriately drive tint state transitions and/or maintain tint states. The number and size of the tintable (e.g., electrochromic) windows 202 that each window controller 214 can drive, may be generally limited by the voltage and/or current characteristics of the load on the window controller 214 controlling the respective electrochromic windows 202. In some embodiments, the maximum window size that the window controller 214 can drive is limited by the voltage, current, and/or power requirements, to cause the requested optical transitions in the electrochromic window 202 within a requested time-frame. Such requirements are, in turn, a function of the surface area of the window. In some embodiments, this relationship is nonlinear. For example, the voltage, current, and/or power requirements can increase nonlinearly with the surface area of the electrochromic window 202. Without wishing to be bound to theory, in some cases the relationship is nonlinear at least in part because the sheet resistance of the first and second conductive layers increases nonlinearly with distance across the length and width of the first or second conductive layers. In some embodiments, the relationship between the voltage, current, and/or power requirements required to drive multiple electrochromic windows 202 of equal size and shape is directly proportional to the number of the electrochromic windows 202 being driven.

FIG. 2 shows an example of a master controller 211. The master controller 211 communicates and functions in conjunction with multiple network controllers 212, each of which network controllers 212 is capable of addressing a plurality of window controllers 214. In some embodiments, the master controller 211 issues the high level instructions (such as the final tint states of the tintable windows) to the network controllers 212, and the network controllers 212 then communicate the instructions to the corresponding window controllers 214. FIG. 2 shows an example of a hierarchical control system comprising the master controller, the network controllers, and the window controllers.

In some implementations, the various electrochromic windows 202, antennas, and/or other target devices of the facility (e.g., comprising building or other structure) are (e.g., advantageously) grouped into zones or groups of zones (e.g., wherein each of which includes a subset of the electrochromic windows 202). For example, each zone may correspond to a set of electrochromic windows 202 in a specific location or area of the facility that should be tinted (or otherwise transitioned) to the same or similar optical states, based at least in part on their location. As another example, consider a building having four faces or sides: A North face, a South face, an East Face, and a West Face. Consider that the building has ten floors. In such an example, each zone can correspond to the set of electrochromic windows 202 on a particular floor and on a particular one of the four faces. In some such embodiments, each network controller 212 can address one or more zones or groups of zones. For example, the master controller 211 can issue a final tint state command for a particular zone or group of zones to a respective one or more of the network controllers 212. For example, the final tint state command can include an abstract identification of each of the target zones. The designated network controllers 212 receiving the final tint state command may then map the abstract identification of the zone(s) to the specific network addresses of the respective window controllers 214 that control the voltage or current profiles to be applied to the electrochromic windows 202 in the zone(s).

In some embodiments, a distributed network of controllers is used to control the optically-switchable windows. For example, a network system may be operable to control a plurality of IGUs in accordance with some implementations. One primary function of the network system may be to control the optical states of the electrochromic devices (or other optically-switchable devices) within the IGUs.

In some embodiments, another function of the network system is to acquire status information (e.g., data) from the IGUs. For example, the status information for a given IGU can include an identification of, or information about, a current tint state of the tintable device(s) within the IGU. The network system may be operable to acquire data from various sensors, such as temperature sensors, photosensors (referred to herein as light sensors), humidity sensors, air flow sensors, or occupancy sensors, antennas, whether integrated on or within the IGUs or located at various other positions in, on or around the building. At least one sensor may be configured (e.g., designed) to measure one or more environmental characteristics, for example, temperature, humidity, ambient noise, carbon dioxide, VOC, particulate matter, oxygen, and/or any other aspects of an environment (e.g., atmosphere thereof). The sensors may comprise electromagnetic sensors.

The electromagnetic sensor may be configured to sense ultraviolet, visible, infrared, and/or radio wave radiation. The infrared radiation may be passive infrared radiation (e.g., black body radiation). The electromagnetic sensor may sense radio waves. The radio waves may comprise wide band, or ultra-wideband radio signals. The radio waves may comprise pulse radio waves. The radio waves may comprise radio waves utilized in communication. The radio waves may be at a medium frequency of at least about 300 kilohertz (KHz), 500 KHz, 800 KHz, 1000 KHz, 1500 KHz, 2000 KHz, or 2500 KHz. The radio waves may be at a medium frequency of at most about 500 KHz, 800 KHz, 1000 KHz, 1500 KHz, 2000 KHz, 2500 KHz, or 3000 KHz. The radio waves may be at any frequency between the aforementioned frequency ranges (e.g., from about 300 KHz to about 3000 KHz). The radio waves may be at a high frequency of at least about 3 megahertz (MHz), 5 MHz, 8 MHz, 10 MHz, 15 MHz, 20 MHz, or 25 MHz. The radio waves may be at a high frequency of at most about 5 MHz, 8 MHz, 10 MHz, 15 MHz, 20 MHz, 25 MHz, or 30 MHz. The radio waves may be at any frequency between the aforementioned frequency ranges (e.g., from about 3 MHz to about 30 MHz). The radio waves may be at a very high frequency of at least about 30 Megahertz (MHz), 50 MHz, 80 MHz, 100 MHz, 150 MHz, 200 MHz, or 250 MHz. The radio waves may be at a very high frequency of at most about 50 MHz, 80 MHz, 100 MHz, 150 MHz, 200 MHz, 250 MHz, or 300 MHz. The radio waves may be at any frequency between the aforementioned frequency ranges (e.g., from about 30 MHz to about 300 MHz). The radio waves may be at an ultra-high frequency of at least about 300 kilohertz (MHz), 500 MHz, 800 MHz, 1000 MHz, 1500 MHz, 2000 MHz, or 2500 MHz. The radio waves may be at an ultra-high frequency of at most about 500 MHz, 800 MHz, 1000 MHz, 1500 MHz, 2000 MHz, 2500 MHz, or 3000 MHz. The radio waves may be at any frequency between the aforementioned frequency ranges (e.g., from about 300 MHz to about 3000 MHz). The radio waves may be at a super high frequency of at least about 3 gigahertz (GHz), 5 GHz, 8 GHz, 10 GHz, 15 GHz, 20 GHz, or 25 GHz. The radio waves may be at a super high frequency of at most about 5 GHz, 8 GHz, 10 GHz, 15 GHz, 20 GHz, 25 GHz, or 30 GHz. The radio waves may be at any frequency between the aforementioned frequency ranges (e.g., from about 3 GHz to about 30 GHz).

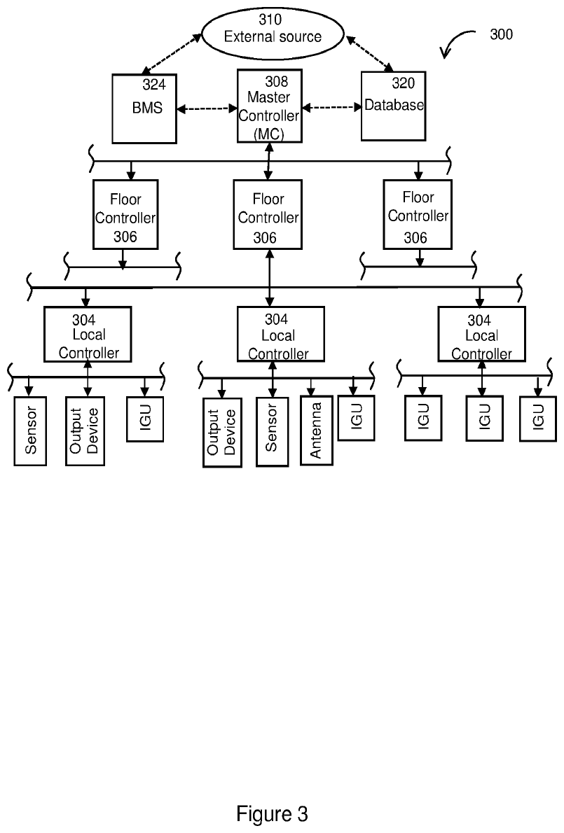

The network system may include any suitable number of distributed controllers having various capabilities or functions. In some embodiments, the functions and arrangements of the various controllers are defined hierarchically. FIG. 3 shows an example of a network system 300 including a plurality of distributed local (e.g., window) controllers (WCs) 304, a plurality of floor (e.g., network) controllers (NCs) 306, and a master controller (MC) 308. In some embodiments, the MC 308 can communicate with and control at least two, ten, tens, hundred, or hundreds of floor using floor controllers (e.g., network controllers NC) 306. The floor controller may be configured to control a floor or a portion of a floor. In various embodiments, the master controller MC 308 issues high level instructions to the NCs 306 over one or more wired and/or wireless communication links. The instructions can include, for example, tint commands for causing transitions in the optical states of the IGUs controlled by the respective NCs 306. Each NC 306 may, in turn, communicate with and control a number of window controllers (WCs) 304 over one or more wired and/or wireless links. The communication links may be bidirectional communication links.

The MC 308 may issue communications including tint commands, status request commands, data (for example, sensor data) request commands or other instructions. In some embodiments, the MC 308 issues such communications periodically, at certain predefined times of day (which may change based on the day of week or year), or based at least in part on the detection of particular events, conditions or combinations of events or conditions (for example, as determined by acquired sensor data or based at least in part on the receipt of a request initiated by a user and/or by an application or a combination of such sensor data and such a request). In some embodiments, when the MC 308 determines to cause a tint state change (e.g., alteration) in a set of one or more IGUs, the MC 308 generates or selects a tint value corresponding to the requested tint state. In some implementations, the set of IGUs is associated with a first protocol identifier (ID) (for example, a Building Automation and Control (BAC) network identification (BACnet ID)). The MC 308 may then generate and transmit a communication-referred to herein as a “primary tint command”—including the tint value and the first protocol ID over the link via a first communication protocol (for example, a BACnet compatible protocol). In some embodiments, the MC 308 addresses the primary tint command to the particular NC 306 that controls the particular one or more WCs 304 that, in turn, control the set of IGUs to be transitioned. The NC 306 may receive the primary tint command including the tint value and the first protocol ID and map the first protocol ID to one or more second protocol IDs. In some embodiments, each of the second protocol IDs identifies a corresponding one of the WCs 304. The NC 306 may subsequently transmit a secondary tint command including the tint value to each of the identified WCs 304 over the link via a second communication protocol. In some embodiments, each of the WCs 304 that receives the secondary tint command then selects a voltage and/or current profile from an internal memory based on the tint value to drive its respectively connected IGUs to a tint state consistent with the tint value. Each of the WCs 304 may then generate and provide voltage and/or current signals over the link to its respectively connected IGUs to apply the voltage or current profile.

In a similar manner to how the function and/or arrangement of controllers may be arranged hierarchically, tintable windows may be arranged in a hierarchical structure. A hierarchical structure can help facilitate the control of tintable windows at a particular site by allowing rules or user control to be applied to various groupings of tintable windows or IGUs. Further, for aesthetics, multiple contiguous windows in a room and/or other site location may sometimes need to have their optical states correspond and/or tint at the same rate. Treating a group of contiguous windows as a zone can facilitate these goals.

In some embodiments, IGUs are grouped into zones of tintable windows, each of which zones includes at least one window controller and its respective IGUs. Each zone of IGUs may be controlled by one or more respective NCs and one or more respective WCs controlled by these NCs. For example, each zone can be controlled by a single NC and two or more WCs controlled by the single NC.

In some embodiments, at least one device is operated in coordination with at least one other device, which devices are coupled to the network. Control of the at least one device may be via Ethernet. For example, A tint level of tintable windows may be adjusted concurrently. When the devices are in use, a zone of devices may have at least one characteristics that is the same. For example, when the tintable windows are in a zone, a zone of tintable windows may have its tint level (automatically) altered (e.g., darkened or lightened) to the same level. For example, when sounds sensors are in a zone, they may sample sound at the same frequency and/or at the same time window. A zone of devices may comprise a plurality of devices (e.g., of the same type). The zone may comprise (i) devices (e.g., tintable windows) facing a particular direction of an enclosure (e.g., facility), (ii) a plurality of devices disposed on a particular face (e.g., façade) of the enclosure, (iii) devices on a particular floor of a facility, (iv) devices in a particular type of room and/or activity (e.g., open space, office, conference room, lecture hall, corridor, reception hall, or cafeteria), (v) devices disposed on the same fixture (e.g., internal or external wall), and/or (vi) devices that are user defined (e.g., a group of tintable windows in a room or on a façade that are a subset of a larger group of tintable windows. The (automatic) adjustment of the devices may done automatically and/or by a user. The automatic changing of device properties and/or status in a zone, may be overridden by a user (e.g., by manually adjusting the tint level). A user may override the automatic adjustment of the devices in a zone using mobile circuitry (e.g., a remote controller, a virtual reality controller, a cellular phone, an electronic notepad, a laptop computer and/or by a similar mobile device).

In some embodiments, when instructions relating to the control of a device (e.g., instructions for a window controller or an IGU) are passed through the network system, they are accompanied with a unique network ID of the device they are sent to. Networks IDs may be helpful to ensure that instructions reach and are carried out on the intended device. For example, a window controller that controls the tint states of more than one IGU, may determine which IGU to control based upon a network ID such as a Controller Area Network (CAN) ID (a form of network ID) that is passed along with the tinting command. In a window network such as those described herein, the term network ID includes but is not limited to CAN IDs, and BACnet IDs. Such network IDs may be applied to window network nodes such as window controllers, network controllers, and master controllers. A network ID for a device may include the network ID of every device that controls it in the hierarchical structure. For example, the network ID of an IGU may include a window controller ID, a network controller ID, and a master controller ID in addition to its own CAN ID.

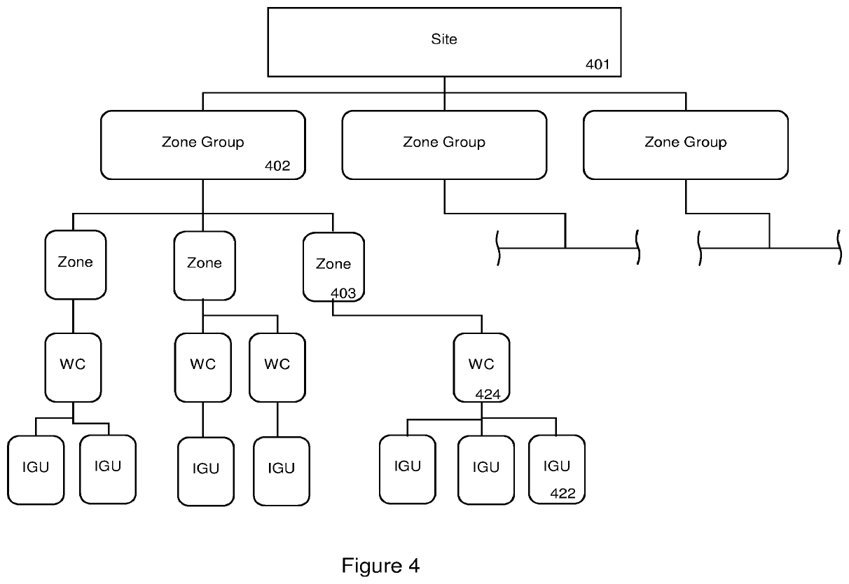

FIG. 4 shows various IGUs 422 grouped into zones 403 of tintable windows, each of which zones 403 includes at least one window controller 424 and its respective IGUs 422. In some embodiments, each zone of IGUs 422 is controlled by one or more respective NCs and one or more respective WCs 424 controlled by these NCs. Each zone 403 may be controlled by a single NC and two or more WCs 424 controlled by the single NC. Thus, a zone 403 can represent a logical grouping of the IGUs 422. For example, each zone 403 may correspond to a set of IGUs 422 in a specific location or area of the building that are driven together based on their location. As a more specific example, consider a site 401 that is a building having four faces or sides: A North face, a South face, an East Face, and a West Face. Consider that the building has ten floors. In such an example, each zone 403 may correspond to the set of tintable windows 422 on a particular floor and on a particular one of the four faces. Each zone 403 may correspond to a set of IGUs 422 that share one or more physical characteristics (for example, device parameters such as size or age). In some embodiments, a zone 403 of IGUs 422 is grouped based at least in part on one or more non-physical characteristics comprising a security designation or a business hierarchy (for example, IGUs 422 bounding managers' offices can be grouped in one or more zones while IGUs 422 bounding non-managers' offices can be grouped in one or more different zones).

In some such implementations, each NC can address all of the IGUs 422 in each of one or more respective zones 403. For example, the MC can issue a primary tint command to the NC that controls a target zone 403. The primary tint command can include an abstract identification of the target zone (hereinafter referred to as a “zone ID”). In some such implementations, the zone ID can be a first protocol ID such as that just described in the example above. The NC may receive the primary tint command including the tint value and the zone ID and may map the zone ID to the second protocol IDs associated with the WCs 424 within the zone. In some embodiments, the zone ID can be a higher level abstraction than the first protocol IDs. In such cases, the NC can first map the zone ID to one or more first protocol IDs, and subsequently map the first protocol IDs to the second protocol IDs.

In order for tint controls to work (e.g., to allow the window control system to change the tint state of one or a set of specific windows or IGUs), a master controller, network controller, and/or other controller responsible for tint decisions, may utilize the network address of the window controller(s) connected to that specific window or set of windows. To this end, a function of commissioning may be used to provide correct assignment of window controller addresses and/or other identifying information to specific windows and window controllers, as well the physical locations of the windows and/or window controllers in buildings. In some embodiments, a goal of commissioning is to correct mistakes and/or other problems made in installing windows in the wrong locations or connecting cables to the wrong window controllers. In some embodiments, a goal of commissioning is to provide semi- or fully-automated installation. In other words, allowing installation with little or no location guidance for installers.

In some embodiments, the commissioning process for a particular window or IGU may involve associating an ID for a device (e.g., the window and/or other window-related component), with its corresponding local (e.g., window) controller. The process may assign a building location, a relative location, and/or absolute location (e.g., latitude, longitude, and elevation) to the device (e.g., window or another component). Examples relating to commissioning and/or configuring a network of tintable windows can be found in U.S. patent application Ser. No. 14/391,122, filed Oct. 7, 2014, titled “APPLICATIONS FOR CONTROLLING OPTICALLY SWITCHABLE DEVICES,” U.S. patent application Ser. No. 14/951,410, filed Nov. 24, 2015, titled “SELF-CONTAINED EC IGU,” U.S. Provisional Patent Application Ser. No. 62/305,892, filed Mar. 9, 2016, titled “METHOD OF COMMISSIONING ELECTROCHROMIC WINDOWS,” and U.S. Provisional Patent Application Ser. No. 62/370,174, filed Aug. 2, 2016, titled “METHOD OF COMMISSIONING ELECTROCHROMIC WINDOWS,” each of which is herein incorporated by reference in its entirety.

After a network of devices (e.g., optically switchable windows) is physically installed, the network can be commissioned to correct any incorrect assignment of window controllers to the wrong windows (often as IGUs) or building locations. In some embodiments, commissioning maps pairs or links individual devices (e.g., windows) and their locations with associated location (e.g., window) controllers.

In some embodiments, commissioning is intended to address mis-pairing of local (e.g., window) controllers and associated devices (e.g., windows), for example, during installation. For example, before installation, a local (e.g., window) controller may be assigned to a particular device (e.g., window), which may be assigned to a particular location in the building. However, during installation a local (e.g., window) controller and/or devices (e.g., window) may be installed in an incorrect location. For instance, a local (e.g., window) controller may be paired with the wrong device (e.g., window), or the device (e.g., window) may be installed in the wrong location. These mis-pairings can be difficult to address and/or require substantial (e.g., manual) labor, time and/or cost to address and/or rectify. Additionally, during the construction process, the physical device (e.g., window) installation and the wiring installation in the building may be done by different teams at different times. Recognizing this challenge, in some implementations, the devices (e.g., windows) and/or local controllers are not pre-assigned to one another, but rather are paired during a commissioning process. Even if mis-pairing is not a problem because, for example, local (e.g., window) controllers are physically affixed to their corresponding devices (e.g., windows), the installer might not know or care which device (e.g., window) (and hence which local controller) is installed at which location. For example, devices (e.g., windows) may be identical in size, shape, and/or optical properties, and hence be interchangeable. The installer may install such devices (e.g., windows) at any convenient location, without regard for the unique local controller associated with each such device (e.g., window). Various commissioning embodiments described herein permit such flexible installation.

Some examples of issues that can arise during installation are the following: (I) Mistakes in placing windows in correct locations: electrically controllable windows may be susceptible to mis-installation, e.g., by technicians who are not accustomed to working with electrically controllable windows. These technicians may include tradespeople such as glaziers and/or low voltage electricians (LVE's); (II) Misconnecting cables to window controllers: this can be occur, e.g., when multiple windows are disposed in close proximity; (III) Malfunctioning (e.g., broken) tintable windows and/or window controllers: An installer can install an available window and/or controller in place of the malfunctioning (e.g., broken) one. The new window and/or controller may not be in the installation and/or building (e.g., BIM) plan, and thus may not be accounted for and/or recognized during commissioning; and (IV) The process of installing many windows at the correct locations may be complicated. It would be desirable to replace the paradigm of having installers be responsible for installing many unique windows in unique locations, which installation may be prone to human error. Therefore, it could be useful to do away with (e.g., much, or all of) the window and/or controller location considerations, which can complicate the installation process. A similar discussion can apply for any device (substituting the window), and any local controller that controls the device (substituting the window controller). The device can by any device, e.g., as disclosed herein.

In one example, installation and attendant problems requiring improved methods of commissioning may arise from the following operations:
a. A unique network address (e.g., a CANID) is assigned to each window controller when the window controllers are manufactured.
b. The window manufacturer (that is not necessarily the window controller manufacturer), a building designer, or other entity, specifies information about the window controller (with specified network address) and window (IGU). It does this by assigning a window controller ID (WCID), which is not (e.g., which differs from) the window controller's network address. The window manufacturer and/or other entity specifies which IGU(s) are associated with the window controller (WCID). To this end, the entity specifies window IDs (WIDs) for the windows. In certain cases, the manufacturer and/or other entity does not specify a correlation between IGU and controllers, e.g., to which specific IGU(s) a controller needs to be connected. For example, the window manufacture need not specify that a WC (with a CANID (e.g., 19196997)) needs to connect to any particular WID (e.g., 04349′0524′0071′0017′00). Instead, the manufacturer or other entity specifies that a WC (with CANID (e.g., 19196997)) has a window controller ID of, e.g., WC10. The window controller ID may be reflected (e.g., appear) as a location tag (e.g., an arbitrary number assigned to windows in an installation) on an interconnect drawing, architectural drawing, or other representation of a building, which may specify that the window controller connects to particular IGUs identified by window IDs (e.g., W31 and W32 (location tag for IGs)).
c. As indicated, the manufacturer or other entity applies a window controller ID (WCxx label) on each window controller. The entity enters a WCxx/CAN ID pair information in a configuration file used by master controller/network controller or other device containing logic responsible for issuing individual tint decisions.
d. This process requires that an LVE or other technician charged with installing and/or connecting electrically controllable windows to select a specific window controller from the boxes of window controllers and install it in a specific location in the building.
e. Any errors made in operations (c) or (d) lead to difficult troubleshooting in the field to find the mis-mapping and correct it.
f. Even if operations (c) and (d) are executed correctly, a window controller and/or window can be damaged, in which case it must be replaced during the installation. This again can cause problems unless the change is tracked manually and reflected in the configuration file. A similar discussion can apply for any device (substituting the window), and any local controller that controls the device (substituting the window controller). The device can by any device, e.g., as disclosed herein.

As indicated, in various embodiments, the commissioning process pairs individual devices (e.g., tintable windows, device ensemble, or any other individual device) with individual local (e.g., window) controllers responsible for controlling various attributes of the device (e.g., for controlling the optical states of the tintable windows). In some embodiments, the commissioning process pairs a device and/or local controller locations with local controller IDs and/or controller network identifiers (e.g., CANIDs) for controllers that are directly control the devices (e.g., with no intervening controller) and/or for controllers disposed on or proximate to devices. For example, the commissioning process pairs window and/or window controller locations with window controller IDs and/or window controller network identifiers (e.g., CANIDs) for controllers that are disposed on or proximate to windows. Such controllers may be configured to control one or more properties of the device (e.g., the optical states of windows). The local controllers may directly control the device, may be located on or proximate to the device (e.g., may be located on the window or device ensemble housing or proximate to). In some embodiments, the commissioning process specifies the type of controller in a hierarchical network and/or the logical position of the controller in that network's topology. Each individual device (e.g., sensor, device ensemble, and/or optically switchable window) may have a physical ID (e.g., the window or lite ID (WID) mentioned herein) and an associated controller with a unique network ID (e.g., the above-mentioned CANID). In some embodiments, the local controller includes a physical ID (e.g., the WCID). In general, a commissioning process may be used to link or pair any two related network components including but not limited to IGUs (or lites in IGUs), window controllers, network controllers, master controllers, sensors, emitters, antenna, receivers, transceivers, processors, and/or device ensembles. In some embodiments, the commissioning process involves pairing network identifiers associated with devices (e.g., IGUs) and/or controllers, to fixtures, surfaces and/or any other features on a three-dimensional building model (e.g., BIM file). Device ensembles may be referred to herein as “digital architectural element.”

In some embodiments, a commissioning linkage is made by comparing an architecturally determined location of a first component with a wirelessly measured location of a second component, which second component is associated with the first component. For example, the first component may be an optically switchable window and the second component may be a window controller configured to control the optical state of the optically switchable component. In another example, the first component may be a sensor that provides measured radiation data to a local (e.g., window or sensor) controller, which is the second component. At times, the location of the first component may be known with greater accuracy than the location of the second component. The location may be determined by a wireless measurement (e.g., by a traveler such as a field service engineer or a robot such as a drone). While the accurate location of the first component may be determined from architectural drawings or a similar source (e.g., BIM file), the commissioning process may employ alternative sources such as manually-measured post-installation locations of the devices (e.g., windows or other components). Geographic auto location technology (e.g., Global positioning system (GPS), ultrawide band radio waves (UWB), infrared radiation, Bluetooth technology, and the like) may be used. In various embodiments, the component whose location is determined by wireless measurement (e.g., a local controller) has a network ID. The network ID can be made available during the commissioning process, e.g., via a configuration (e.g., BIM) file. In such cases, the commissioning process may pair the accurate physical location of the first component with the network ID of the second component. In some embodiments, the first and second components are a single component. For example, a window controller may be such component; e.g., its position may be both determined from an architectural drawing and from wireless measurement. The commissioning process may ascribe the physical location from the architectural drawing (e.g., BIM file) with the network ID from the configuration file. The BIM file may constitute a digital twin of the facility (e.g., building).

In some embodiments, the linkages determined during commissioning are stored in a file, data structure, database, or the like (e.g., BIM file) that can be consulted by various window network components and/or associated systems such as mobile applications, window control intelligence algorithms, Building Management Systems (BMSs), security systems, lighting systems, and the like. In some embodiments, the commissioning linkages are stored in a network configuration file which may be included in the digital twin of the facility. In some embodiments, a network configuration file is used by the network to send appropriate commands between components on the network; e.g., a master controller sends a tint command to the local (e.g., window) controller for a designated device (e.g., tintable window), by its location in a structure, for a (e.g., configuration and/or tint) change.

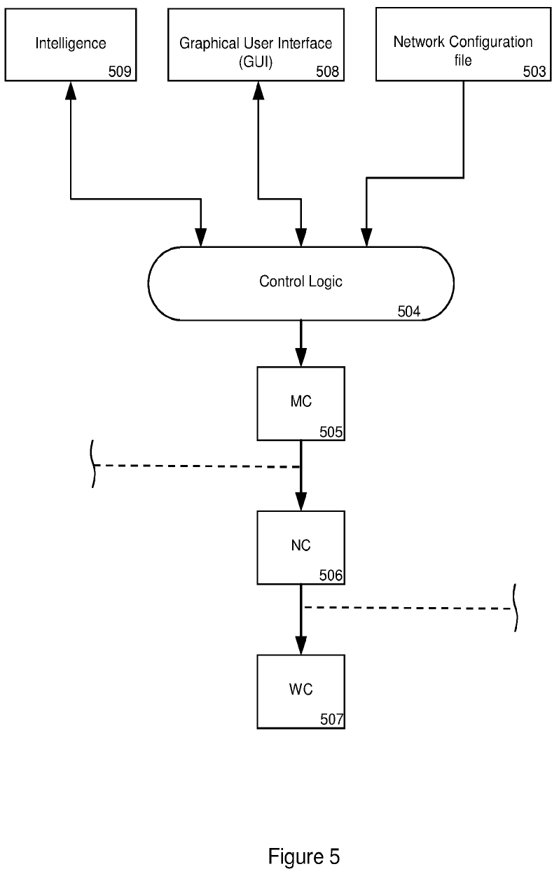

FIG. 5 depicts an example of an embodiment in which a network configuration file 503, may be used by control logic 504 to facilitate various functions on a network. While the following description uses the term “network configuration file,” it should be understood that any suitable file, data structure, database, etc. may be used for the same purpose. Such file (or other feature) can provide linkages between physical components of a network (e.g., lite positions identified by a Lite ID) and network IDs (which may be or include network addresses) of controllers associated with such physical components (e.g., window controllers that directly control states of lites). Control logic refers to any logic that may use for making decisions or other purposes the linkages between physical components and associated controllers. For example, such logic may include logic provided with device network master controllers, network controllers, and local controllers, as well as associated or interfacing systems such as mobile applications for controlling device types and/or configurations (e.g., states), device control intelligence algorithms, building management systems, security systems, lighting systems, and the like. For example, such logic may include logic provided with window network master controllers, network controllers, and window controllers, as well as associated or interfacing systems such as mobile applications for controlling window states, window control intelligence algorithms, building management systems, security systems, lighting systems, and the like. In some embodiments, network configuration file 503 is used by control logic 504 to provide network information to a graphical user interface (GUI) 508 for controlling the network, such as an application on a remote wireless device, or to an intelligence system 509 or a building management system (BMS). In some embodiments, a user interface 508 of a mobile application is configured to use information provided by a network configuration file to control target devices, such as a master controller, a network controller, a local controller, or other network components.

In some embodiments, a digital twin includes a network configuration file which is created and updated according to a building layout, equipment installations, and unique identifiers of installed devices. In some embodiments, the first operation is to determine the physical layout of a site from building plans such as architectural drawings so that the layout of a window network can be determined. The architectural drawings (e.g., included in the digital twin) may provide building dimensions, locations of fixtures, wiring, openings (e.g., piers), plumbing, stairs, electrical closets, and various other structural and architectural features. In some embodiments, such as when architectural drawings are not available, architectural drawings are created by first surveying a site (e.g., using a traveler such as a human or robotic traveler). Using architectural drawings, an individual or team may design the wiring infrastructure and/or power delivery system for the device (e.g., including tintable window) network. This infrastructure, which includes power distribution components, may be depicted visually in modified architectural drawings that are sometimes referred to as interconnect drawings. Interconnect drawings may depict wire routing (e.g., trunk lines) at a site, the positioning of various devices on the network (e.g., controllers, power supplies, control panels, windows, emitters, and/or sensors), and identifying information of network components (e.g., a network ID). In some embodiments, an interconnect drawing is not completed until the IDs (WIDs or other IDs) of installed devices (e.g., optically switchable windows) are matched to the devices installed locations. Inherently or explicitly, an interconnect drawing may depict a hierarchical communications network including the devices and their controllers (e.g., windows, window controllers, network controllers, and a master controller) at a particular site. An interconnect drawing as initially rendered may not include network IDs for the devices (e.g., lites or other components) on the network.

In some embodiments, after an interconnect drawing is created, it is used to create a network configuration file which may be a textual representation of the interconnect drawing. Network configuration files may then be provided in a medium that is readable by control logic and/or other interfacing system, which allows the window network to be controlled in its intended fashion. So long as the interconnect drawing and the network configuration file accurately reflect the installed network, the process of creating a preliminary network configuration file is complete. However, commissioning may add other information to the file to link installed optically switchable windows are matched to corresponding window controller network IDs. If at any point it is determined that the interconnect drawing and network configuration file do not match the installed network, manual user intervention may be required to update the interconnect drawing with accurate lite ID (or other ID) information. From the updated interconnect drawing the network configuration file is then updated to reflect changes that have been made.

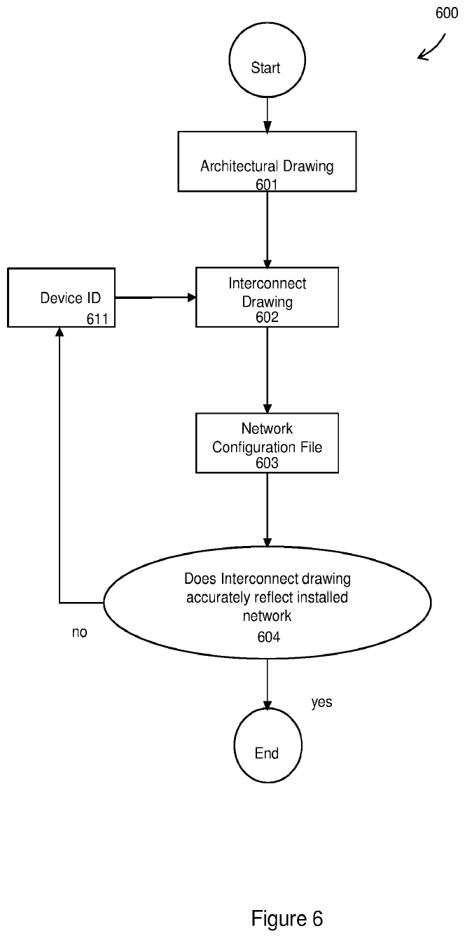

FIG. 6 shows an example method of creating a network configuration file. The physical layout of a site is determined in an operation 601. Interconnect drawings defining the types and positioning of various devices to be included in a network are added in an operation 602. Device (e.g., Lite) IDs 611 (which may be specified in advance, determined at the time of installation, or collected after installation) may be input to the interconnect drawing 602. The network configuration file is generated in an operation 603. In an operation 604, it is verified whether the interconnect drawing portion of the network configuration file matches what has been installed. If there are any inaccuracies, then operation 611 is repeated to update the interconnect drawing 602.

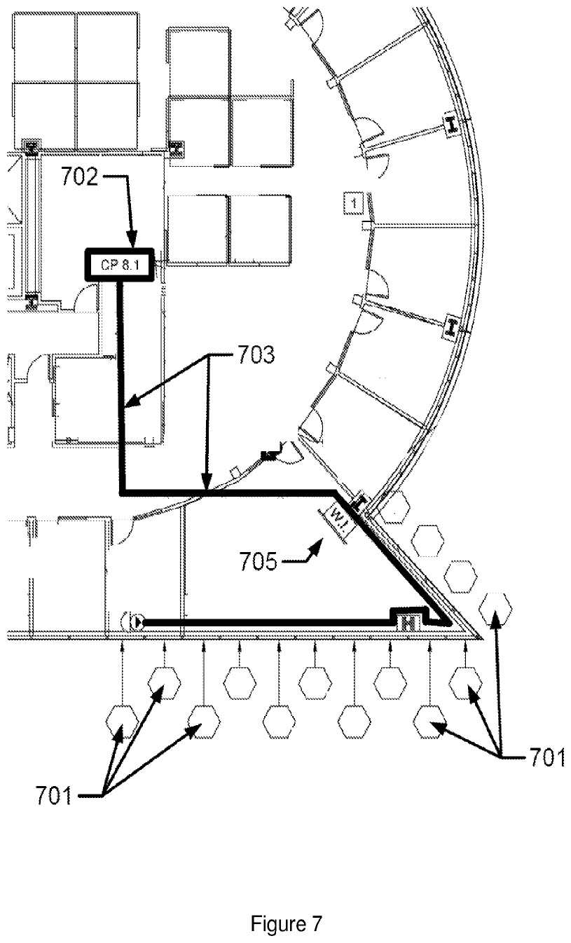

FIG. 7 provides one example of an interconnect drawing which is created from architectural drawing (e.g., floorplan) of the building. Interconnect drawings include the placement of IGUs and window controllers 701, control panels 702, trunk lines 703, wall interfaces 705, and various other network components such as master controllers, network controllers, sensors. Although not shown, interconnect drawings may include additional information such as structural information, structural dimensions, and information such as the network IDs of various network components depicted.

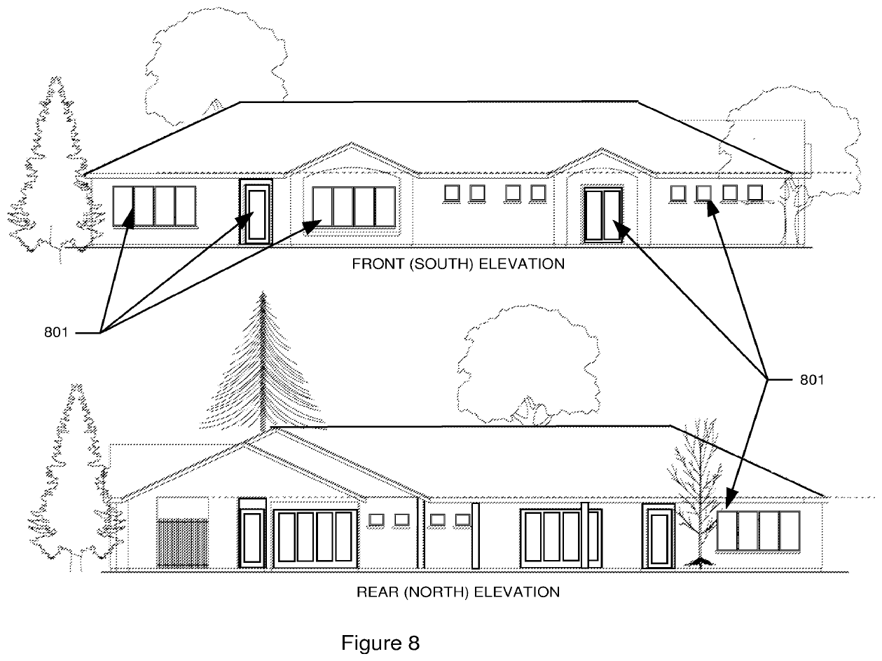

In some embodiments, an interconnect drawing is a package of drawings depicting many views of a structure. In some embodiments, an interconnect drawing package includes drawings that are similar but provide different information. For example, two drawings may depict the same floorplan, and one drawing may provide dimensional information, while another provides network IDs of components on the network. FIG. 8 provides an example of an interconnect drawing that depicts an elevation view of a structure from which the coordinates of IGUs 801 and other network components may be determined. In some embodiments, interconnect drawings provide information relating to power distribution networks for electrochromic devices such as has been described in U.S. Pat. No. 10,253,558, issued Apr. 9, 2019, which is incorporated herein by reference in its entirety.

Modifications to interconnect drawings may be required in certain situations. For example, an installer might determine that a window opening is too small for the window prescribed by the instructions in the digital twin (e.g., interconnect drawings and/or BIM) and decide to install a smaller window. To correct for the change, the digital twin may need to be updated. A network configuration file or other structure storing mappings between devices (e.g., optically switchable windows) and associated controllers may be created or modified to reflect the real-world installation. With the correct mapping in place, the network will function properly. In some cases, if a network configuration file is not representative of the physical network, then device configuration instructions (e.g., window tinting instructions) may be sent to the wrong component, or communications may not be received at all.

When the digital twin (e.g., interconnect drawing) of the facility is revised, the corresponding (e.g., linked) network configuration file will be revised as well. Such revision may be manual and/or automatic. Such revisions may be done in real-time (e.g., during update of the digital twin file, at a predetermined time, or at a whim. In some embodiments, a network configuration file is not created until physical installation has been completed, e.g., to ensure that any changes in the digital twin are reflected in the network configuration file. In cases where the interconnect file is modified after the network file is created, care should be taken to ensure that the network configuration file is updated to reflect changes. Failure to update an interconnect drawing or failure to update a network configuration file to reflect changes made to the digital twin (e.g., an interconnect drawing) may result in a network that does not respond to instructions as intended. Further, the digital twin (e.g., an interconnect drawing) may be updated when commissioning takes place (e.g., in real time). To correct for changes made during installation that deviate from an interconnect drawing, device (e.g., optically switchable window) information may be obtained from a file containing the device ID (lite ID for a window, for example).

When the digital twin (e.g., an interconnect drawing) has been created, or when the digital twin has been updated to account for a change in installation, a network configuration file may be created or updated. The configuration file may be further updated when commissioning takes place (e.g., in real time), or at a (e.g., designated) time thereafter. As with the digital twin (e.g., an interconnect drawing), the network configuration file when initially rendered, does not include network IDs for controllers or other components (e.g., devices) on or operatively (e.g., communicatively) coupled to the network.

In some embodiments, a network configuration file is a transcript of the digital twin (e.g., an interconnect drawing) in a computer readable format that can be read, interpreted, and in some cases updated by control logic software. At least some (e.g., all) of the network components (e.g., windows, window controllers, network controllers, sensors, emitters, and sensor ensembles) may be represented in a network configuration file. The network configuration file may contain information regarding how various devices on the network relate to each other in a hierarchical structure.

In some embodiments, a network configuration file is a textual description of the digital twin (e.g., the interconnect drawings). Network configuration files may have a flat file format with no structure for indexing and/or no structural relationship between records. Examples of flat file types include plain text files, comma-separated value files, and delimiter-separated value files. A JavaScript object notation format (JSON), or other object notation format that uses human-readable text to transmit data objects consisting of attribute-value pairs, may be used for a network configuration file. The information in a network configuration file can be stored in other formats and/or locations.

In some embodiments, a network configuration file takes a JSON format. Various devices and groupings of devices may be defined as JSON objects. For example, when defining a zone of windows as an object, comma-separated text may be used to encode what zone group the zone is a part of, what network controller or controllers the zone group reports to, and the master controller in charge of the network. The object may provide what window controllers, windows, and/or any additional network components (e.g., a photo sensor or window antenna) are included in the zone. Network components may be referenced in an object by at least a network ID. When initially generated from the digital twin (e.g., the interconnect drawing), a network configuration file may be incomplete in the sense that it does not yet include network IDs for at least one of the controllers.

Network configuration files may be stored at various locations in the window network. For example, a network configuration file may be stored on memory attached to a master controller, a network controller, a remote wireless device, or in the cloud. In some embodiments, a network configuration file is stored in one location from which all other devices on the network can access it. In another embodiment, network configuration files are stored locally on a plurality of devices on the window controller network; when a network configuration file is updated at one location, as when a new device is added to the network, the updated network configuration file is used to replace the out of date network files at other locations.

Using information from the network configuration file, control logic may send instructions to windows and/or other components (e.g., devices) on the network. Control logic can transmit instructions to a master controller 405, which in turn may transmit instructions to the appropriate network controller 406. In some embodiments, a network controller transmits instructions to the appropriate local controller (e.g., window controller 407) over, e.g., a BACnet communication protocol (building automation and control networks protocol, ISO16484-5). Local controllers may then apply electrical signals to control the configuration of the device(s) based at least in part upon a local controller's CAN ID. For example, the window controllers may then apply electrical signals to control the tint state of optically switching windows based at least in part upon a window controller's CAN ID.

Control logic may be stored and/or used at various places on a network. For example, control logic may be stored and used on a master controller. In some embodiments, software containing the control logic is run, locally, on the cloud, or on a remote device, e.g., which sends instructions to a higher hierarchy (e.g., master) controller. In some embodiments, a control logic is at least partially implemented via a facility management application that be operated from an electronic device.

One purpose of control logic is to present controllable options to a user in the form of a graphical user interface that enables a user to choose and/or control one or more electrochromic windows, and/or any other device, on the network. For example, a user may be presented with a list of lite IDs on the network from which the user may select and/or modify the attributes and/or configurations of the device, e.g., the tint state of a particular window. A user may send instructions to control a grouping of devices (e.g., windows) based at least in part upon a zone of devices that has been predetermined or selected, e.g., by a user.

In some embodiments, control logic communicates with window control intelligence, a BMS, and/or a security system. For example, a BMS may configure all windows to their tinted state in order to save cooling costs in the event of a power outage.

One aspect of the present disclosure allows for automated window location determination after installation. Various devices (e.g., sensor ensembles, window controllers, windows configured with antennas and/or onboard controllers) may be configured with a transmitter to communicate via various forms of wireless electromagnetic transmission; e.g., time-varying electric, magnetic, or electromagnetic fields. Various wireless protocols used for electromagnetic communication include, but are not limited to, Bluetooth, BLE, Wi-Fi, RF, and/or ultra-wideband (UWB). The relative location between two or more devices may be determined from information relating to received transmissions at one or more antennas such as the received strength or power, time of arrival or phase, frequency, and/or angle of arrival of wirelessly transmitted signals. When determining a device's location from these metrics, a triangulation algorithm may be implemented that in some instances to account for the physical layout of a building, e.g., fixtures such as walls and non-fixtures such as mobile furniture. Ultimately, an accurate location of individual network components (e.g., devices) can be obtained using such technologies. For example, the location of a window controller having a UWB micro-location chip can be determined to an accuracy of at least about 2.5 cm, 5 cm, 10 cm, 15 cm, 20 (cm) centimeters of its actual location, or a higher accuracy. In some instances, the location of one or more devices (e.g., windows) may be determined using geo-positioning methods such as those described in International Patent Application Serial No. PCT/US17/31106, filed May 4, 2017, titled “WINDOW ANTENNAS,” which is hereby incorporated by reference in its entirety. As used herein, geo-positioning and geolocation may refer to any method in which the position or relative position of a window or device is determined in part by analysis of electromagnetic signals.

Pulse-based ultra-wideband (UWB) technology (ECMA-368 and ECMA-369) is a wireless technology for transmitting large amounts of data at low power (e.g., of at most about 0.3, 0.5, or 0.8 milliwatts (mW)) over short distances (e.g., of at most about 200′, 230′, or 250′ (feet)). A characteristic of a UWB signal is that it occupies at least about 500 MHz of bandwidth spectrum or at least about 20% of its center frequency. A component UWB broadcasts digital signal pulses may be timed precisely on a carrier signal across a number of frequency channels at the same time. Information may be transmitted by modulating the timing and/or positioning of pulses. Information may be transmitted by encoding the polarity of the pulse, its amplitude and/or by using orthogonal pulses. Aside from being a low power information transfer protocol, UWB technology may provide several advantages for indoor location applications over other wireless protocols. In some embodiments, the broad range of the UWB spectrum comprises low frequencies having long wavelengths, which allows UWB signals to penetrate a variety of materials, including fixtures such as walls. The wide range of frequencies, including these low penetrating frequencies, decreases the chance of multipath propagation errors as some wavelengths will have a line-of-sight trajectory. Another advantage of pulse-based UWB communication may be that pulses are short (e.g., at most about 50 cm, 60 cm, or 70 cm for a 500 MHz-wide pulse, at most about 20 cm, 23 cm, or 25 cm for a 1.3 GHz-bandwidth pulse) reducing the chances that reflecting pulses will overlap with the original pulse.

The relative locations of window controllers having geo-location technology (e.g., having micro-location chip) can be determined using the UWB protocol. For example, using micro-location chips, the relative position of each device may be determined to an accuracy of at least about 2.5 cm, 5 cm, 10 cm, 15 cm, 20 cm, or higher accuracy. In some embodiments, the devices (e.g., device ensembles, window controllers, and in some cases, antennas disposed on or proximate windows or window controllers) are configured to communicate via a micro-location chip. In some embodiments, a controller is equipped with a tag having a micro-location chip configured to broadcast (e.g., UWB) signals. The signals may be omnidirectional signals. Receiving stationary micro-location chip (referred to as anchors), may be located at a variety of locations such as a wireless router, a network controller, or a window controller. The anchors may have a known (e.g., absolute, or relative) location in the facility. The tags may be stationary or mobile. For example, the tag may be embedded in a sensor ensemble. For example, the tag may be embedded in a furniture or a service machine (e.g., an asset). For example, the tag may be carried by an occupant. By analyzing the time taken for a broadcast signal to reach the anchors within the transmittable distance of the tag, the location of the tag may be determined, e.g., relative to the anchors. In some embodiments, an installer places temporary anchors within a building for the purpose of commissioning which are then removed after the commissioning process is complete. In some embodiments in which there are a plurality of devices (e.g., optically switchable windows, window controllers) are equipped with micro-location chips that are configured to send and/or receive UWB signals. By analysis of the received UWB signals at each device (e.g., window controller), the relative distance between the devices (e.g., window controller) located within the transmission range limits, may be determined. By aggregating this information, the relative locations between (e.g., all) the devices (e.g., window controllers) may be determined. When the location of at least one device (e.g., window controller) is known, or if an anchor is used, the relative location of other devices having a micro-location chip, may be determined. Such technology may be employed in an auto-commissioning procedure as described herein. It should be understood that the disclosure is not limited to UWB technology; any technology for automatically reporting (e.g., high-resolution) geographic location information may be used. Such technology may employ one or more antennas associated with the components to be automatically located.

A digital twin (e.g., Interconnect drawings or other sources of architectural information) of the facility may include location information for various network components. For example, devices (e.g., windows) may have their physical location coordinates listed in x, y, and z dimensions, with the technology prescribed accuracy; e.g., to within at least about 1 centimeter. Files or documents derived from such digital twin (e.g., comprising drawings), such as network configuration files, may contain accurate physical locations of network components. In certain embodiments, coordinates correspond to one corner of (e.g., of a lite or IGU as installed in) the facility structure. The choice of a particular corner or other feature for specifying in the digital twin (e.g., interconnect drawing) coordinates may be influenced by the placement of an antenna or other location aware component. For example, a window and/or paired window controller may have a micro-location chip placed near a first corner of an associated IGU (e.g., the lower left corner); in which case the interconnect drawing coordinates for the lite may be specified for the first corner. In the case where an IGU has a window antenna, listed coordinates on a digital twin (e.g., interconnect drawing) may represent the location of the antenna on the surface of an IGU lite or a corner proximate the antenna. In some embodiments, coordinates are obtained from architectural drawings and knowledge of the antenna placement on larger window components such as an IGU. In some embodiments, a window's orientation is included in the interconnect drawing.

While this specification often refers to digital twin (e.g., interconnect drawing) as a source of accurate physical location information for windows, the disclosure is not limited to digital twin (e.g., interconnect drawing). Any similarly accurate representation of component locations in a building or other structure having optically switchable windows may be used. This includes files derived from interconnect drawings (e.g., network configuration files) as well as files or drawings produced independently of interconnect drawings, e.g., via manual or automated measurements made during construction of a building. In some cases where coordinates cannot be determined from architectural drawings, e.g., the vertical position of a window controller on a wall, unknown coordinates can be determined by personnel responsible for installation and/or commissioning. Because architectural and interconnect drawings are widely used in building design and construction, they are used here for convenience, but the disclosure is not limited to interconnect drawings as a source of physical location information.

In some embodiments using digital twin (e.g., interconnect drawing) or similarly detailed representation of component locations and geo-positioning, commissioning logic pairs component locations, as specified by interconnect drawings, with the network IDs (or other information not available in interconnect drawings) of components (e.g., devices) such as window controllers for optically switchable windows. In some embodiments, this is done by comparing the measured relative distances between device locations provided by geo-positioning and the listed coordinates provided on an interconnect drawing. Since the location of network components may be determined with a high accuracy, e.g., as disclosed herein for UWB such as better than about 10 cm, automatic commissioning may be performed in a manner that avoids the complications that may be introduced by manually commissioning windows.

The controller network IDs or other information paired with the physical location of a device (e.g., window or other component) may come from various sources. In some embodiments, a controller's network ID is stored on a memory device. The memory device can be operatively coupled to the network. The memory can be attached to a window (e.g., a dock for the window controller or a pigtail) or may be downloaded from the cloud based upon a device serial number. One example of a controller's network ID is a CAN ID (an identifier used for communicating over a CAN bus). In addition to the controller's network ID, other stored device information may include the controller's ID (not its network ID), the device component ID (e.g., a serial number for the lite), device type, device (e.g., window) dimensions, manufacturing date, bus bar length, zone membership, current firmware, and various other device details (e.g., layer makeup of an electrochromic device and their (e.g., relative) dimensionality). Regardless of which information is stored, at least part of this information (e.g., all the information) may be accessed during device use and/or during the commissioning process. Permission to access the information may comprise security layers. Once accessed, any or all portions of such information may be linked to the physical location information obtained from the digital twin (e.g., interconnect drawing), partially completed network configuration file, or other source.

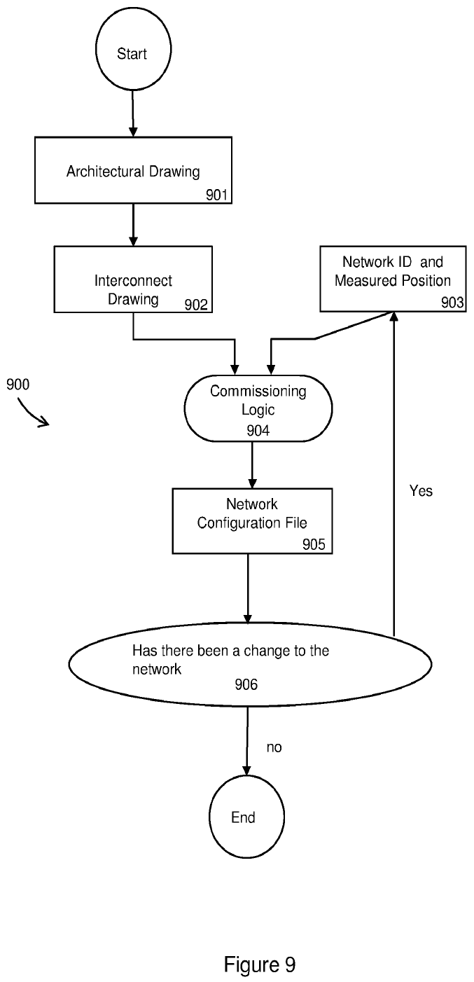

FIG. 9 depicts an example of a process 900 involving commissioning logic 904 (part of a commissioning system) and a network configuration file 905. Process 900 begins by gathering building information from architectural drawings 901. Using the building information provided by architectural drawings, a designer or design team creates interconnect drawings 902 which include plans for a network at a particular site. Once network components such as IGUs and controllers are installed, the relative positions between devices can be measured by analysis of electromagnetic transmissions as has been described herein. The measured positions and network ID information 903 is then passed to commissioning logic 904 which pairs the network ID (or other unique information) of a device with its place within a hierarchal network as depicted in the interconnect drawings 902. The location of an associated device, as taken or derived from the interconnect drawing, is paired with the network ID or other unique information. The paired information is stored in a network configuration file 905. As long as no changes are made to the network or device installations, no changes are needed to the network configuration file. If, however, a change is made, for example an IGU is replaced with one having a different window controller, then commissioning logic 904 is used to determine the change and update the network configuration file 905 accordingly.

As a teaching example, consider an interconnect drawing having window controllers located at three positions (each associated with the lower left corner of an associated window) along the wall of the building: a first position intended to have a first window controller at (0 ft, 0 ft, 0 ft), a second position intended to have a second window controller at (5 ft, 0 ft, 0 ft), and a third position intended to have a third window controller at (5 ft, 4 ft, 0 ft). When measuring coordinates of the three controllers, one of the controllers may be set as a reference location (e.g., the controller personnel responsible for commissioning sets the controller in the first position as a reference point). From this reference point the coordinates of the other two windows are measured resulting in window coordinates of (5.1 ft, 0.2 ft, 0.1 ft) and (5.0 ft, 3.9 ft, −0.1 ft). Commissioning logic then easily perceives the window having coordinates (5.1 ft, 0.2 ft, 0.1 ft) to be in the second position and a window having coordinates (5.0 ft, 3.9 ft, −0.1 ft) to be in the third position. Information describing the physical and hierarchical position of each component from interconnect drawings may then be paired with the network ID information (or other unique information) which may be transmitted to the commissioning logic over the network when the position of network components is determined.

Commissioning logic may incorporate a range of statistical methods to match physical device coordinates with coordinates listed on an interconnect drawing. In one embodiment, matching is performed by iterating through the various permutations of assigning a device to each of the possible interconnect locations and then observing how closely the location of other components, as determined using relative distance measurements, correspond to the locations of other network component locations as specified on the interconnect drawing. In some embodiments, network components are matched with coordinates listed on an interconnect drawing by selecting the permutation that minimizes the mean squared error of the distance of each component to the closest component location specified by the interconnect drawing.

This auto commissioning method may be useful if, for example, a new component (e.g., device) is added to the network, an old component is removed from a network, or replaced on the network. In the case of a new component, the component may be recognized by the network and its location may be determined by one of the previously described methods. Commissioning logic may then update the network configuration file to reflect the addition. Similarly, commissioning logic may update a network configuration file when a component is removed and no longer recognized by the network. In cases where a component is replaced, commissioning logic may notice the absence of a component on the network and the presence of a new component reporting from the same coordinates of the missing component. Commissioning logic may conclude that a component has been replaced, and thus updates the network configuration file with the network ID of the new component.

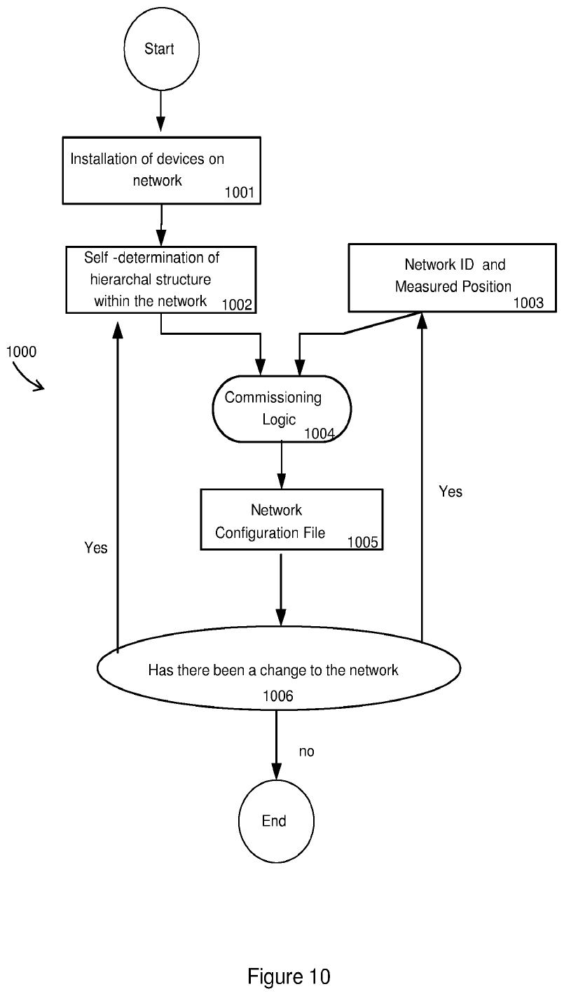

FIG. 10 shows a process 1000 in which the commissioning logic generates the network topology portion of a network configuration file. Window devices (or other network-connected devices) are installed at a site 1001 and network components self-determine the hierarchical structure of the network by communicating with each other 1002. The hieratical structure of a network may be determined when each component self-reports to the network component above it reporting its network ID (or other ID) information as well the network ID (or other ID) information of any devices below it in the hierarchy. For example, a device (e.g., a sensor or an IGU) may report to a local controller (e.g., WC), which may report to an NC, which may report to a MC. When this pattern is repeated for every component on the network, then the system hierarchy may be self-determined. Thus, a network may avoid network topology errors that may easily be introduced by deviations from an interconnect drawing that occur during installation. This self-determined structure is then passed to commissioning logic 1004 which may use the measured positions 1003 of devices when creating a network configuration file 1005.

The instructions and logic for performing commissioning procedures described herein may be deployed on any suitable processing apparatus including any controller on the network with sufficient memory and processing capability. Examples include master controllers, network controllers, and local controllers. In other embodiments, the commissioning system executes on a dedicated administrative processing machine that performs (e.g., only) commissioning or related administrative functions, and may communicate with the associated network. In some embodiments, the commissioning system resides outside the building having the devices to be commissioned. For example, the commissioning system may reside in a network of a remote monitoring site, console, or any ancillary system such as a building lighting system, a BMS, a building thermostat system (e.g., NEST (Nest Labs of Palo Alto, California), or the like. Examples of such systems, methods of their use, and related software are described in International Patent Application Serial No. PCT/US15/64555, filed Dec. 8, 2015, titled “MULTIPLE INTERACTING SYSTEMS AT A SITE,” and International Patent Application Serial No. PCT/US15/19031, filed Mar. 5, 2015, titled “MONITORING SITES CONTAINING SWITCHABLE OPTICAL DEVICES AND CONTROLLERS” each incorporated herein by reference in its entirety. In some embodiments, the commissioning system executes in a shared computational resource such as a leased server farm or the cloud.

In some embodiments, a control system and/or control interface comprises a “digital twin” of a facility. For example, the digital twin may comprise a representative model (e.g., a two-dimensional or three-dimensional virtual depiction) containing structural elements (e.g., walls and doors), building fixtures/furnishings, and one or more interactive target devices (e.g., optically switchable windows, sensors, emitters, and/or media displays). The digital twin may reside on a server which is accessible via a graphical user interface, or which can be accessed using a virtual reality (VR) user interface. The VR interface may include an augmented reality (AR) aspect. The digital twin may be utilized in connection with monitoring and servicing of the building infrastructure and/or in connection with controlling any interactive target devices, for example. When a new device is installed in the facility (e.g., in a room thereof) and is operatively coupled to the network, the new device may be detected (e.g., and included into the digital twin). The detection of the new device and/or inclusion of the new device into the digital twin may be done automatically and/or manually. For example, the detection of the new device and/or inclusion of the new device into the digital twin may be without requiring (e.g., any) manual intervention. Whether present in the original design plans of the enclosure or added at a later time, full details regarding (e.g., each) device (including any unique identification codes) may be stored in the digital twin, network configuration file, interconnect drawing, and/or architectural drawing (e.g., BIM file such as a Revit file) to facilitate the monitoring, servicing, and/or control functions.

In some embodiments, a digital twin comprises a digital model of the facility. The digital twin may be comprised of a virtual three dimensional (3D) model of the facility. The facility may include static and/or dynamic elements. For example, the static elements may include representations of a structural feature of the facility (e.g., fixtures) and the dynamic elements may include representations of an interactive device with a controllable feature. The 3D model may include visual elements. The visual elements may represent facility fixture(s). The fixture may comprise a wall, a floor, wall, door, shelf, a structural (e.g., walk-in) closet, a fixed lamp, electrical panel, elevator shaft, or a window. The fixtures may be affixed to the structure. The visual elements may represent non-fixture(s). The non-fixtures may comprise a person, a chair, a movable lamp, a table, a sofa, a movable closet, or a media projection. The non-fixtures may comprise mobile elements. The visual elements may represent facility features comprising a floor, wall, door, window, furniture, appliance, people, and/or interactive device(s)). The digital twin may be similar to virtual worlds used in computer gaming and simulations, representing the environment of the real facility. Creation of a 3D model may include the analysis of a Building Information Modeling (BIM) model (e.g., an Autodesk Revit file), e.g., to derive a representation of (e.g., basic) fixed structures and movable items such as doors, windows, and elevators. In some embodiments, the digital twin (e.g., 3D model of the facility) is defined at least in part by using one or more sensors (e.g., optical, acoustic, pressure, gas velocity, and/or distance measuring sensor(s)), to determine the layout of the real facility. Usage of sensor data can be used (e.g., exclusively) to model the environment of the enclosure. Usage of sensor data can be used in conjunction with a 3D model of the facility (e.g., (BIM model) to model and/or control the environment of the enclosure. The BIM model of the facility may be obtained before, during (e.g., in real time), and/or after the facility has been constructed. The BIM model of the facility can be updated (e.g., manually and/or using the sensor data) during operation and/or commissioning of the facility (e.g., in real time).

In some embodiments, dynamic elements in the digital twin include device settings. The device setting may comprise (e.g., existing and/or predetermined): tint values, temperature settings, and/or light switch settings. The device settings may comprise available actions in media displays. The available actions may comprise menu items or hotspots in displayed content. The digital twin may include virtual representation of the device and/or of movable objects (e.g., chairs or doors), and/or occupants (actual images from a camera or from stored avatars). In some embodiments, the dynamic elements can be devices that are newly plugged into the network, and/or disappear from the network (e.g., due to a malfunction or relocation). The digital twin can reside in any circuitry (e.g., processor) operatively coupled to the network. The circuitry in which the digital circuitry resides may be in the facility, outside of the facility, and/or in the cloud. In some embodiments, a two-way (e.g., bidirectional) link is maintained between the digital twin and a real circuitry. The real circuitry may be part of the control system. The real circuitry may be included in the master controller, network controller, floor controller, local controller, or in any other node in a processing system (e.g., in the facility or outside of the facility). For example, the two-way link can be used by the real circuitry to inform the digital twin of changes in the dynamic and/or static elements so that the 3D representation of the enclosure can be updated, e.g., in real time or at a later (e.g., designated) time. The two-way link may be used by the digital twin to inform the real circuitry of manipulative (e.g., control) actions entered by a user on a mobile circuitry. The mobile circuitry can be a remote controller (e.g., comprising a handheld pointer, manual input buttons, or touchscreen).

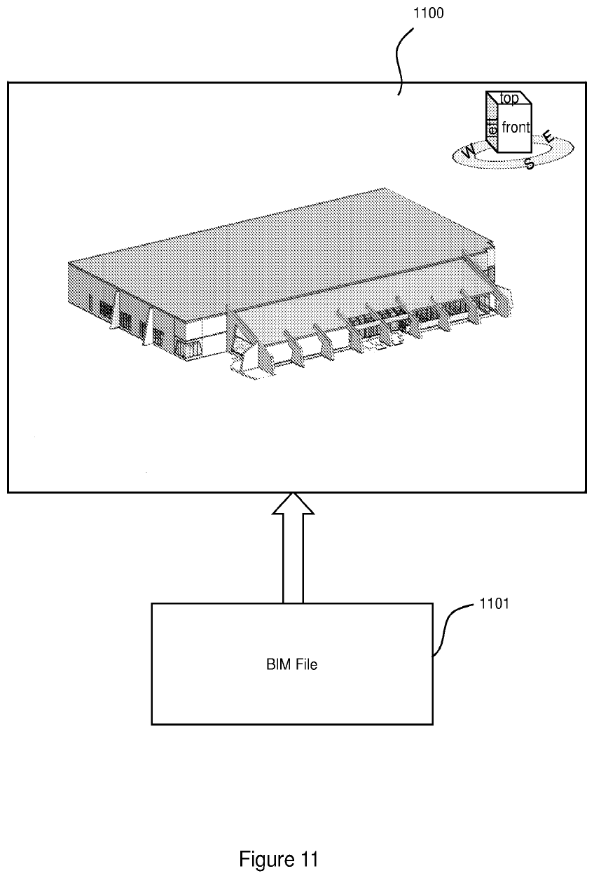

FIG. 11 depicts a visual representation of a digital twin 1100 which is based, at least in part, on a BIM (e.g., Revit) file 1101. In some embodiments, digital twin 1100 includes a 3D virtual construct which may be virtually navigated to view and interact with target devices using an interface device. The interface may be a mobile device such as a smartphone or a tablet computer. In some embodiments, a virtual representation of the enclosure comprises a virtual augmented reality representation of the digital twin displayed on the mobile device, wherein the virtual augmented reality representation includes virtual representations of at least some of the real target devices. The navigation within the digital twin using a mobile device may be independent of the actual location of the mobile device, or may coincide with the movement of the mobile device within the real enclosure represented by the digital twin. The mobile device may be operatively (e.g., communicatively coupled to the network. The mobile device may register its present position in the real facility with a respective position in the digital twin, e.g., using any geo-location technology. For example, the geo-location anchors coupled to the network.

In some embodiments, a mobile device (e.g., a smartphone, tablet, or handheld controller) is utilized to detect commissioning data of respective target devices and transmit the commissioning data to the digital twin and/or BIM system. The mobile device may include geographic tracking capability (e.g., GPS, UWB, Bluetooth, and/or dead-reckoning) so that location coordinates of the mobile device can be transmitted to the digital twin using any suitable network connection established by the user between the mobile device and the digital twin. For example, a network connection may at least partly include the transport links used by a hierarchical controller network within a facility. The network connection may be (e.g., entirely) separate from the controller network of the facility (e.g., using a wireless network such as a cellular network). The target device may be outfitted with an optically recognizable ID tag (e.g., sticker with a barcode or a Quick Response (QR) code). Interaction of the mobile device with the target device may be used to populate a virtual representation of the target device in the digital twin, with a unique identification code and/or other information relating to the target device that is associated with the ID code (e.g., comprised in the ID tag).

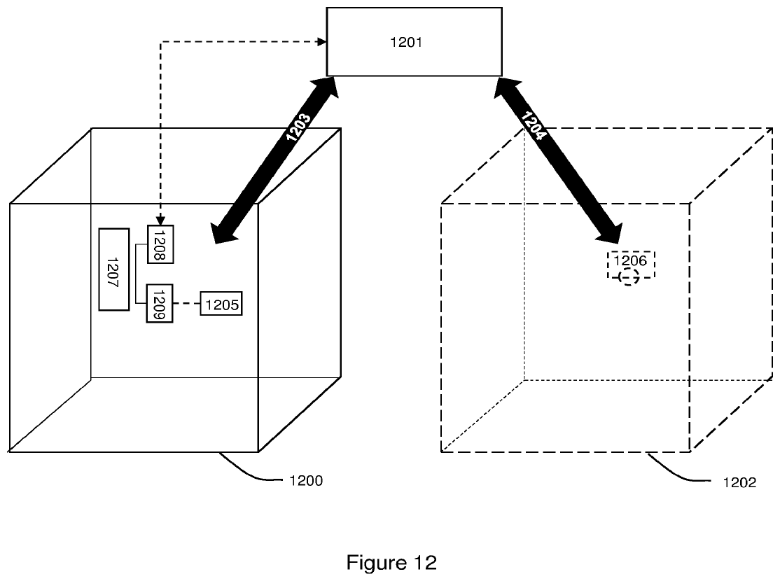

FIG. 12 shows an example embodiment of a control system in which a real, physical enclosure (e.g., room) 1200 includes a controller network for managing interactive network devices under control of a controller 1201 (e.g., a master controller comprising a processor). The structure and contents of building 1200 are represented in a 3-D model digital twin 1202 as part of a modeling and/or simulation system executed in a computing asset. The computing asset may be co-located with or remote from enclosure 1200 and/or master controller 1201. A network link 1203 in enclosure 1200 connects controller 1201 with a plurality of network nodes including an interactive target device 1205. Interactive target device 1205 is represented as a virtual object 1206 within digital twin 1202. A network link 1204 connects controller 1201 with digital twin 1202.

In the example of FIG. 12, a traveler 1207 located in enclosure 1200 carries a mobile device (e.g., handheld control unit) 1208. Mobile device 1208 may include an integrated scanning capability (e.g., a camera for capturing an image of a barcode or QR code), or a separate identification capture device 1209 coupled to mobile device 1208 (e.g., a handheld barcode scanner connected with mobile device 1208, e.g., via a Bluetooth link).

ID tags may be comprised of RFID, UWB, radiogenic, reflective, or absorptive materials to enable use of various scanning tools (e.g., identification capture devices). The code(s) or printed matter on an ID tag may comprise device type, electronic and/or material properties of the target device, serial number, types, identifiers of component parts, manufacturer, manufacturing date, and/or any other pertinent information.

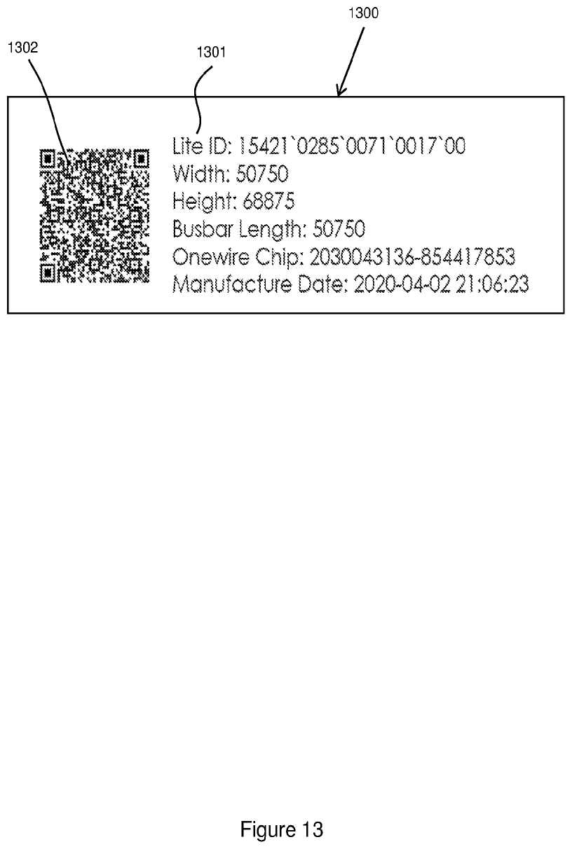

FIG. 13 depicts an ID tag 1300 of a kind to be affixed to an accessible surface of a target device (e.g., IGU). Printed data on tag 1300 may include a Lite ID 1301. Some or all of the printed (e.g., human readable) data may be encoded into a QR coded 1302 which can be scanned, transmitted, decoded, and/or stored in association with the virtual representation of the enclosure and of the virtual target device.

In some embodiments, target devices in the enclosure space and behind fixtures of the enclosure (e.g., walls) can be recognized and commissioned. The mobile device (e.g., possibly assisted by remote computing resources on a cloud server and/or in the digital twin) may use image recognition and/or location tracking (e.g., geo-location technology) to identify real target devices and match them to a virtual representation within the model of the digital twin. A traveler (e.g., a human user with a carried mobile device and/or identification capture device, or a robot such as a drone with its corresponding mobile device and scanner) may use Augmented Reality (e.g., digital twin) depicting fixtures and target devices in the enclosure, e.g., to isolate and select a particular target device to be commissioned. Based at least in part on details provided by the Building Information Model (BIM) and the corresponding digital twin, the traveler may select a virtual representation of the target device, e.g., to inform the digital twin which target device will be scanned for an identification code, location information, or other details. The target device may or may not be operatively cooled to the network. For example, the target device may be a non-fixture such as a table.

In some embodiments, a mobile device includes a circuitry (e.g., smartphone or tablet) coupled to (e.g., having) a sensor (e.g., camera), display screen, and software app configured to register one or more real target devices to a digital twin and/or supporting file (e.g., network configuration file, interconnect file, and/or BIM (Revit) file). The display screen may show images corresponding to views within the digital twin. The display screen may show at least a portion of the digital twin that correspond to (e.g., and centered in) the location of the mobile circuitry. For example, the display screen may show the position in the virtual digital twin that corresponds to the real position of the mobile circuitry, as well as its immediate surrounding. In some embodiments, as the mobile circuitry travels in the enclosure (e.g., as it is carried by the traveler who travels in the enclosure), the virtual screen changes (e.g., in real time) the corresponding virtual position of the circuitry in the digital twin (e.g., by altering the center of the digital twin image displayed in the display screen). As the mobile circuitry travels in the real enclosure, the display screen can depict at least an immediate surrounding of the mobile circuitry in the digital twin that alters (e.g., in real time), which virtual immediate surrounding correspond to the changing real immediate surrounding relative to the position of the real mobile circuitry in the real enclosure. The image of at least a portion of the virtual twin depicted in the display screen may be for navigation and/or orientation purposes. For example, the image of at least a portion of the virtual twin depicted in the display screen may aid in navigating to a previously placed representation of a target device, or to navigate to a virtual location corresponding to a real location having a real target device which is to be added and commissioned to the digital twin (and/or any supporting file(s)). In some embodiments, the user can assign the central position of the depicted image of the virtual twin to be different from the position of the real mobile device. For example, it can be at a (e.g., lateral) distance from the real mobile device. The user may be able to select the distance, e.g., using a dropdown menu, using a cursor, and/or using a touch screen functionality of the mobile device. The camera (or other integrated sensor in, or coupled to the mobile device) may capture (e.g., scan) an identification code of the real target device. The captured (e.g., scanned) code may be (i) linked within (e.g., associated by) the digital twin to the selected target device or (ii) be linked to an inventory of codes associated with target devices and populate the digital twin with the target device identified by its code in the inventory (e.g., file).

In some embodiments, a separate identification capture device such as a handheld scanner may be linked to the mobile device and operated by the traveler to capture the code. The sensor (e.g., camera) may comprise a Charged Coupled Device (CCD) camera. The sensor may comprise a sensor array. The system may be configured to perform (or direct performance of) image processing on the captured code (e.g., image of the code), e.g., to recognize and/or decipher the code.

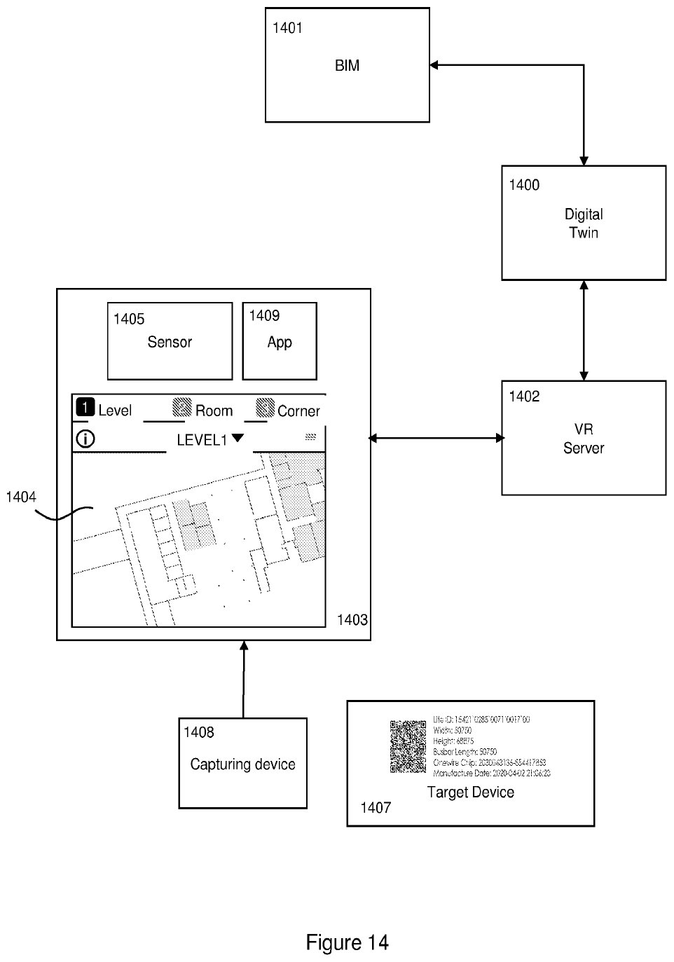

FIG. 14 shows an example of a registration and/or commissioning system in which a digital twin 1400 is used to present a 2D or 3D virtual model of an enclosure to a user (e.g., traveler) based at least in part on building information from a BIM system 1401. In some embodiments, the presented virtual model is created as a virtual reality (VR) model in a server 1402. The VR model may be augmented with additional virtual representations (e.g., combined with a sensor (e.g., camera) view and/or graphic overlays) and then rendered into a VR-based perspective view by server 1402. The model may be interactively navigated in conjunction with a display 1404 of a mobile device 1403. Mobile device 1403 includes a sensor (e.g., camera) 1405 for capturing data (e.g., images) that may be used (i) as at least a partial basis for generating an augmented VR representation of a facility containing a target device, (ii) as a locator for establishing a present location of the traveler within the facility and/or a location of a target device, and/or (iii) as a sensor for reading an ID tag or other markings to establish an identification code. At least one application 1409 is configured to perform the rendering, navigation, and identification functions in concert with VR server 1402 and digital twin 1400. A target device 1407 is labelled with an identification code and optionally other information which can be read by sensor 1405 and/or by using a peripheral device linked to mobile device 1403 such as another capturing device (e.g., QR scanner) 1408. The other capturing device can be operatively coupled to the mobile circuitry (e.g., wired and/or wirelessly). The other capturing device may be configured for hand-held operation. The other capturing device may be easier to manipulate and reach to various location. The other capturing device may have a sensor that is dedicated for ID capture operation (e.g., barcode scanning, QR code scanning, or RFID reader).

In some embodiments, using the mobile device, virtual representations of target devices within the enclosure space can be recognized, e.g., even when a target device is behind fixtures of the enclosure (e.g., walls). Selection of a device contained in the digital twin can be achieved using image recognition of target devices (e.g., when a traveler is autonomous) or by manual indication with the user interface (e.g., tapping a touchscreen (e.g., when the traveler is a person)). In some embodiments, a traveler (e.g., person) initiates the augmented virtual reality (e.g., digital twin) depicting fixtures of the enclosure on a mobile device (e.g., tablet computer). For ease of use, movement of the traveler may be tracked (e.g., using relative and/or absolute location data sent from the mobile device to the VR server) so that the VR scene presented on the mobile device to the traveler follows along with the movement (e.g., as disclosed herein). For initiating the tracked navigation, the mobile device may become anchored to the digital twin at an initiation point. For example, by pairing to the network of the enclosure having image sensors (e.g., camera) and/or geo-location sensor(s) (e.g., RF sensors such as UWB sensors). For example, by pairing to a fixed sensor (e.g., of the device ensemble) that has a fixed (e.g., and known) position relative to (e.g., and in) the enclosure). For example, by manually identifying a location of a virtual representation of the real mobile circuitry in the digital twin enclosure. Based at least in part on change of position and/or spatial orientation of the mobile device, the displayed augmented reality may update in order to track the movement of the mobile device, e.g., thereby allowing the traveler to manipulate the mobile device until the display shows a virtual representation of a requested target device and/or a location where a target device is being added. The user may select the virtual representation of a target device on the mobile device to proceed with capturing (e.g., scanning) an identification code of the real target device corresponding to the selected virtual device. The user may capture an identification code of the real target device that may be identified and subsequently populated as a virtual representation in the digital twin. Identification of the scanned device may be done using at least one database in which ID codes and devices (e.g., and optionally their related information) may reside (e.g., in a memory). The database may be in the enclosure, or outside of the enclosure (e.g., in another facility or in the cloud). The one or more databases may comprise the internet. The at least one database may comprise virtual representation images of the device configured to populate the virtual twin.

In some embodiments, the application in the mobile device may be configured to retrieve universal codes (e.g., of devices), for example, by being connected to the Internet. In some embodiments, the traveler captures information from an ID tag using portable circuitry of the mobile device (e.g., cellular phone or tablet), associates the ID tag information (e.g., the ID code) with the selected target device and/or its location, and then communicates the associated information to the digital twin (and/or centralized BIM). The traveler may capture (e.g., scan and/or sense) the code with a separate capturing device (e.g., Bluetooth scanner such as a gun scanner) coupled to the mobile device. Such a portable gun capturing device may allow capturing hard to reach and/or remote areas. In some embodiments, the identification capture device (e.g., scanner) comprises a low resolution sensor (e.g., camera). The low resolution sensor may comprise a single pixel sensor, e.g., an array of single pixel sensors. At least two of the sensors in the array may be of the same type (e.g., sensitive to the same radiation wavelengths). At least two of the sensors in the array may be of different types (e.g., sensitive to different radiation wavelengths). The identification capture device may comprise an IR, UV, or visible radiation sensor, an RFID reader, and/or a radio transceiver (e.g., an UWB transceiver). The captured ID (e.g., scanned text or pattern) may be presented in an easy to detect format, e.g., so that complex image processing is not required for the capturing device (e.g., scanner) and/or mobile device. For example, a barcode may be placed on the target device at least during the installation and/or commissioning stage. After ascertaining the identification and/or location information to be associated with a target device, the ID tag (e.g., comprising a barcode) may be (i) removed (e.g., when a barcode label is attached to a device surface, e.g., a glass surface or a display construct surface) or (ii) can remain on the object (e.g., when attached to a controller unit, or when it is an RFID embedded in the target device).

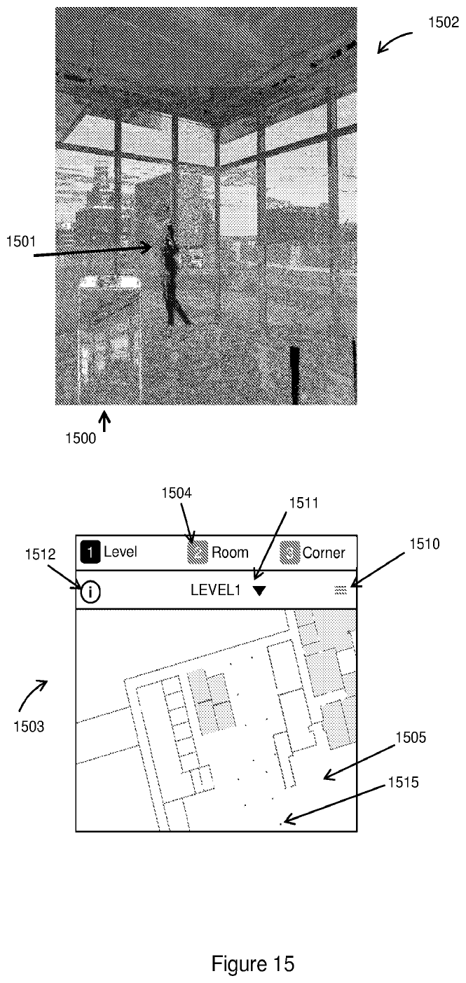

FIG. 15 depicts an example of a mobile device 1500 carried by a human traveler 1501 while commissioning target devices in a real facility 1502. Mobile device 1500 may execute an application (abbreviated as “app”) for performing functions including the display of a virtual augmented reality model, which may be at least in part comprised of a visual display portion 1503 showing a virtual representation 1505 of a digital twin comprising a virtual target device 1515 (e.g., sensor). In some embodiments, the virtual representation is selected by interacting with display 1503. The interaction may include app control icons such as 1504 shown on display 1503 of the mobile device. The application may provide information regarding the displayed image. For example, the enclosure characteristics (e.g., facility, building, floor, facility section, and/or room). For example, display 1503 shows that the digital twin displays room #2 in level #1. The application may comprise dropdown menu 1510 having various options that the user can select from, e.g., relative magnification of the virtual display shown on the mobile device display, settings of the virtual twin displayed (e.g., color scheme and/or font), various options related to target devices (e.g., device types), and security settings (e.g., login settings). The application may allow the user to select different portions of the virtual twin, e.g., a different level, different floor, different room, or a different building in the facility. The different portions may be more remote from the mobile circuitry location. The application may allow the user to select a virtual image of a target device in the digital twin and retrieve information (e.g., 1512) relating to its real counterpart. The information may include ID number of the target device, its location, whether it is installed or not, whether it is coupled to the network or not, its status (functional/not), any maintenance history, any projected maintenance, any last maintenance data (at details of the maintenance), any risk of malfunction, and/or any other characteristics of the target device (e.g., color, maker, installation data, production date, associated controller, and/or any other associated technical data).

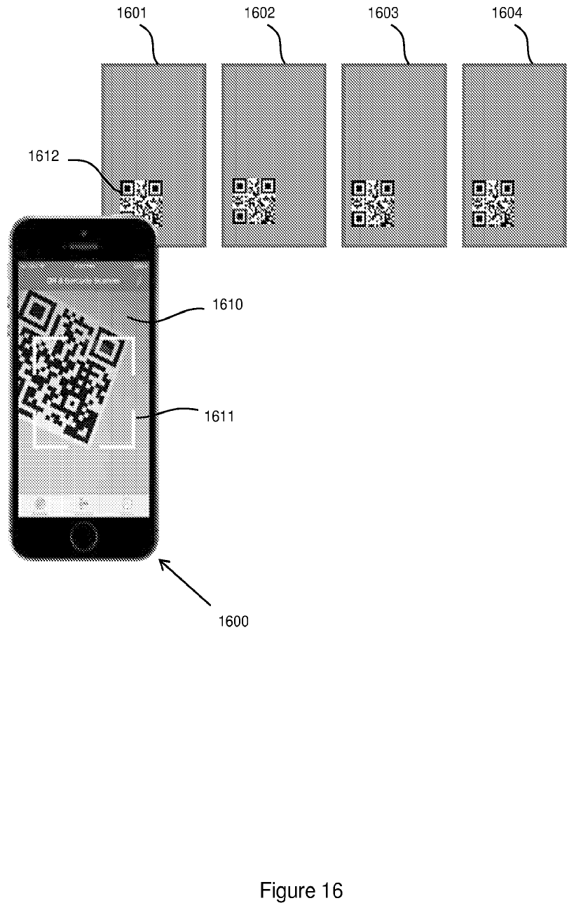

FIG. 16 shows an example of a mobile device 1600 in proximity to real target devices 1601, 1602, 1603, and 1604. A traveler (e.g., human user or a robot) may hold mobile device 1600 so that its camera captures a view 1610 displayed to the traveler. In order to detect an ID code (e.g., QR code 1612) affixed to target device 1601, mobile device 1600 may be positioned capture (e.g., an image of) the ID code 1612 that conforms to a capture box 1611. Mobile device 1601 may use known methods to decode the textual information embedded in the ID code 1612 to be used for populating an identification code and/or other identifying information corresponding to target device 1601 into the digital twin and/or other BIM databases and/or models, and any associated controller related files (e.g., configuration file).

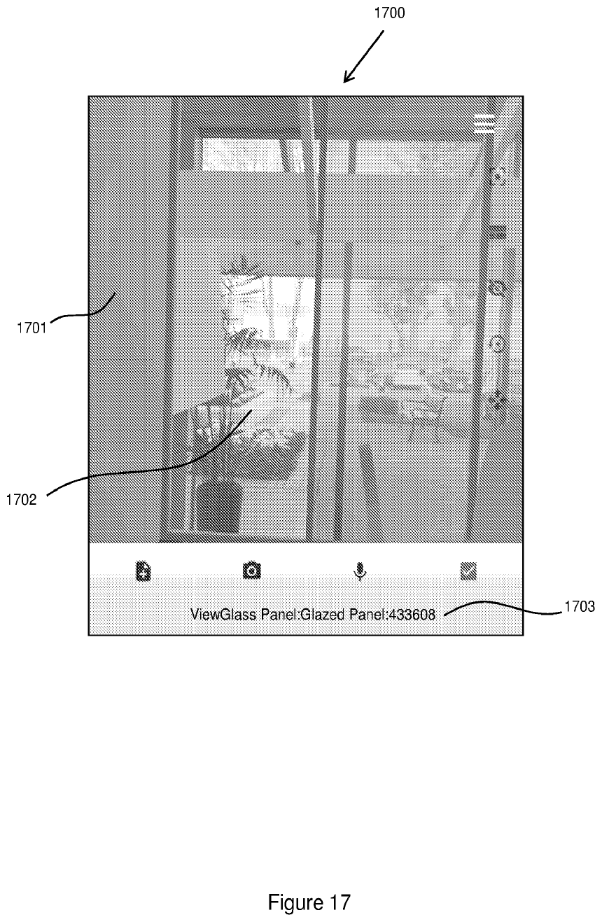

FIG. 17 shows an example of a user interface screen 1700 in which a virtual augmented reality representation merges live video images from a mobile device with stored data in the digital twin based on BIM information. The image on interface screen 1700 may depict structures such as a wall 1701 and target devices such as an IGU 1702. The VR system generating the image may recognize that the current view includes one or more target devices (e.g., IGU 1702) and may provide corresponding prompts, dropdown menu(s), or selection button(s) to assist a user in selecting the requested target device. For example, a display identifier 1703 may be activated to provide a designation of a potential target device based at least in part on generic data already available in the digital twin. By tapping identifier 1703, the user can proceed to scan the corresponding ID tag (e.g., label), which can then automatically be associated with a matching representation of the device in the digital twin. The automated (or semi-automated) collection of identification codes can reduce the time/effort required to populate the ID codes, associated devices, and any linked information (e.g., as disclosed herein) into the digital twin. The time required for such (e.g., semi-) automated procedure can be between an average of about 4 minutes per device (e.g., IGU) to an average of about 15 seconds per device. As a comparison, a fully manual process may require at least about 80%, 90%, 93%, 94%, or 95% more time for registering the device into a digital twin (e.g., including associated information relating to the device, e.g., as disclosed herein). Such (e.g., semi-) automated process may reduce manpower, cost, time, errors, and/or trouble for the installation, maintenance, and/or service teams. Reduction in manpower comprises reduction in number of personnel required and/or reduction in the level of qualification of the personnel required to perform the task(s). Reduction of errors may increase the accuracy of device functionality and control in the facility. For example, presently a verification of window ID and location that is done manually takes about a full 8-hour workday for 100 IGUs.

In some embodiments, a target device present in a real facility may have a corresponding virtual graphic representation in the digital twin. The digital twin may include corresponding data records for the target device with unique identifying information (e.g., ID code or serial number, MAC address, and/or location) and generic information (type of device, manufacturer, and any other device characteristics, feature and/or attribute, e.g., as disclosed herein). By linking the identification code, location of target device, and the digital twin, functions such as building management, maintenance, servicing, and/or repair can be greatly improved (e.g., in efficiency). Overtime, the data records may compile service history and/or (e.g., current) device status, which can be updated into the at least one database comprising the target device (e.g., which can be accessible through the digital twin). Service performed may be updated (e.g., in real-time or after service) into the database (e.g., comprising the status information relating to the device (e.g., that may be accessible through the digital twin). The status of the device may be automatically coupled to the digital twin and/or BIM file. The at least one database may be automatically coupled to the digital twin and/or BIM file. The at least one database may be configured to update the BIM file. Further, the BIM file may be updated automatically, at a designated time (e.g., non-real time), and/or in real-time. The designated time may be a time in which the activity in the facility is low (e.g., at night, weekend, activity break, and/or holiday). In some embodiments, identification data (e.g., as commissioned to the digital twin) is compared with a previous version digital twin (e.g., prior to updating), e.g., in order to find any changes and/or discrepancies. The updated digital twin may be used for analysis, maintenance, site management (e.g., control), planning, and/or to revise an underlying BIM (Revit file). The planning may comprise interior design and/or architectural planning.

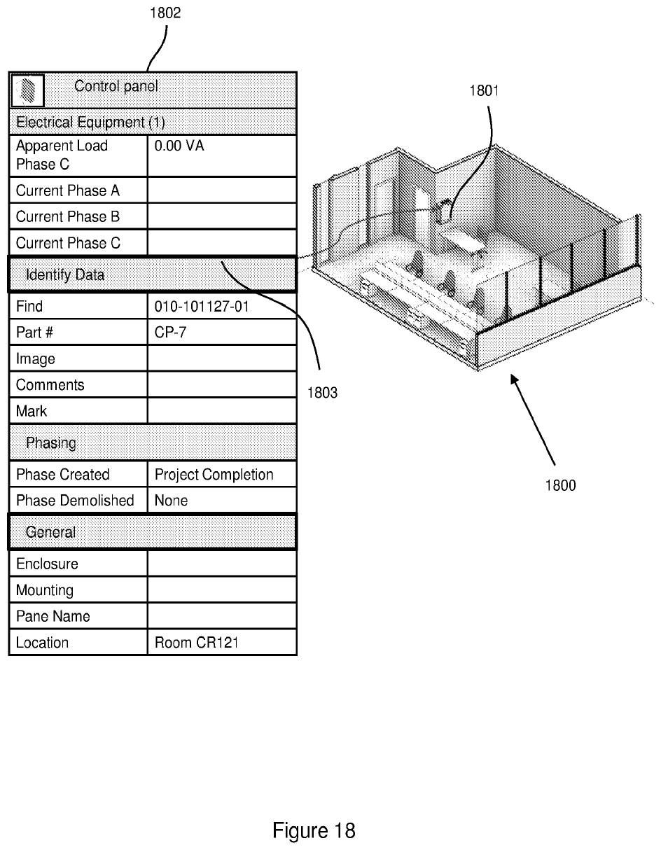

FIG. 18 shows an example of a virtual room 1800 (e.g., presented to a user as part of the digital twin) which contains, or is modified to contain, a virtual control panel device 1801. During commissioning, target device 1801 can be selected and its ID tag captured (e.g., scanned or otherwise sensed) to obtain data about the real target device, which data is linked to the ID code of the target device 1801. The data may be stored in a data record 1802 linked to virtual target device 1801. Data record 1802 may include several data fields useful for device function, control, network coupling, management, maintenance, servicing, and/or repair. In the example shown in in FIG. 18, the data fields include an identification code 1803 which has been captured by an identification capture device operated by the traveler as explained above. The data may include location information (e.g., room CR121), timing of record generation and/or device installation (e.g., Phasing), identity data (e.g., including ID code, part number, associated image, any special mark, and ability to include comments). The data may include categorizing the equipment (e.g., as fixture, or non-fixture, e.g., as furniture, glass, sensor, wall, or electrical equipment)

In some circumstances, a target device may be installed in a facility without having been configured in the BIM data and/or the digital twin. Whenever a target device is not already defined in the existing BIM and/or digital twin, then a user (e.g., the traveler) may add it, e.g., at the time of commissioning of a new system or any time thereafter. The user may delete or modify already represented virtual target devices when needed (e.g., when the device is removed or relocated). For a target device to be added, the mobile device may be used to navigate to and select a location (e.g., geographic location information where the target device resides). The location may be derived from the ID tag (e.g., if it includes a geo-location technology, e.g., UWB technology). The location may be derived from the ID tag of the traveler. The location may be derived from manually inserting location information (e.g., by the traveler). In some embodiments, the user adds the unrepresented target device by selecting a device type from an inventory list which is available in the app. For example, the target device may be of a 3^{rd} party, and the code of the device may be a universal ID code. With the location information and the device type having been determined, the user may use the identification capture device to capture (e.g., scan) the identification code of the real target device into the database(s) and/or digital twin. The digital twin may then be updated with the target device information and a virtual representation of the target device may be created in the virtual model at the identified location. In some embodiments, at least some of the updated information in the digital twin is fed back to the BIM file for similar updating. The digital twin may incorporate or be otherwise linked to the BIM. The database(s) comprising the ID code and any associated device information are stored, may be linked to the BIM.

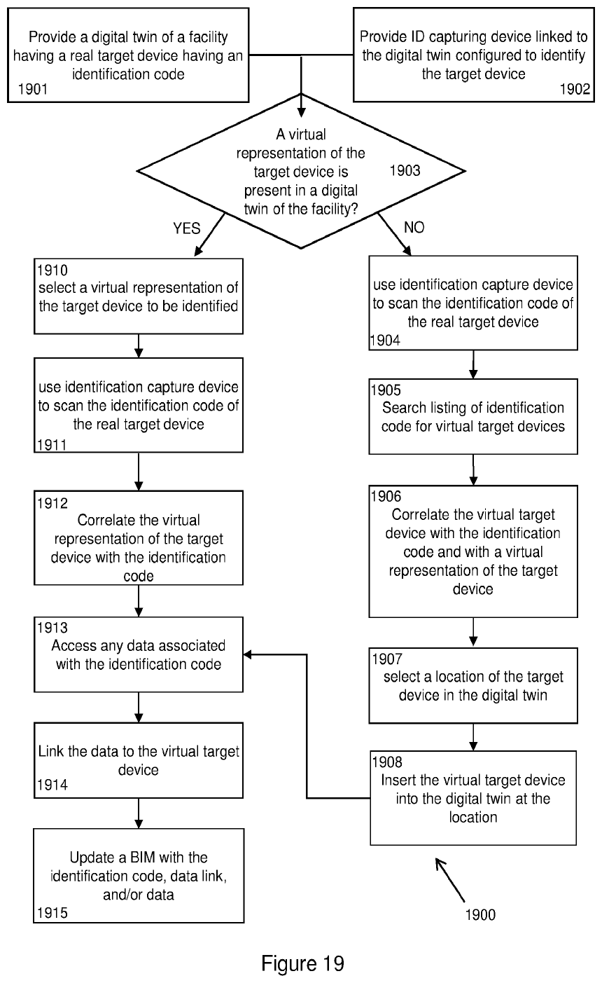

The digital twin may or may not be populated with virtual representation and/or selection of target devices. The app may allow the user to choose the target device from select target devices. The app may search for target devices based at least in part on the captured ID code. FIG. 19 shows a flowchart which provides (i) an example method for registering one or more target devices. The process may begin with an operation 1901 which provides a digital twin of a facility, wherein the facility has a real target device with an identification code (e.g., affixed to the target device on a label or other ID tag), and (ii) in 1902, an identification capture device linked to the digital twin (e.g., a sensor integrated into a mobile device and/or a peripheral capturing device). In some embodiments, the digital twin can zoom and adjust in real time to emulate the location of the traveler in the digital twin, and a mobile device can project the (e.g., immediate) surroundings of a traveler as emulated by the digital twin. Location information of the mobile device and/or of the target device can be tracked (e.g., using geo-location technology). For example, the location information can be provided using a UWB ID tag of the traveler, or the location information can be driven by the mobile device through geolocation (e.g., GPS). Using the location information, a virtual representation of target devices (and/or locations thereof) is presented as part of a virtual augmented reality display of the digital twin. In operation 1903, a determination is made whether the target device of interest is present in the digital twin (e.g., target device type, and/or a specific target device having a manufacturer serial number). If not, then the identification capture device is used to capture (e.g., scan) the identification code of the real target device of interest in operation 1904. In operation 1905, a listing of identification codes and/or device types for virtual target devices is searched (e.g., a device identification code may have already been entered in data records for the virtual twin before knowing the individual installation location, or generic data for known types of devices may be accessed as part of the setup of a target device). In operation 1906, the virtual target device is correlated with the identification code and with a virtual representation of the corresponding type of target device. In operation 1907, the location of the target device is selected in the digital twin (e.g., virtual reality representation), e.g., by the user or automatically via geo-location technology. The virtual target device representation is inserted into the digital twin at the identified location in operation 1908. The digital twin may be linked to database(s) having ID codes linked to various devices. The app on the mobile device may direct searching the database(s) (e.g., the internet) for an association between the ID code and information relating to the target device. Once the ID code of the target device is identified as linked to a target device (e.g., target device type, and/or a specific target device having a manufacturer serial number), the digital twin and/or app selection options may be populated with information relating to the target device and/or a virtual representation of the target device, in the digital twin in a location of the digital twin respective to the real location of the target device in the real enclosure.

When the virtual representation for the target device of interest is present in the digital twin at operation 1903, then the user selects the corresponding virtual representation and/or device ID depicted in the digital twin on the user interface in operation 1910 in order to signify which real target device will be captured (e.g., scanned) for its identification code. In operation 1911, the identification capture device is used to capture the identification code on/in the real target device. In operation 1912, the virtual representation of the target device is correlated with the identification code (e.g., the identification code is transmitted to database(s) containing the digital twin and a corresponding data record (e.g., associated information such as its characteristics and/or status information) is populated with the identification code, thereby linking the two together).

A label or other ID tag providing the identification code may contain additional data relating to the target device (e.g., device characteristics and/or status information). After linking the identification code and/or location to a virtual target device representation in operations 1908 and/or 1912, any additional data is accessed in operation 1913. When additional data is found, then it is linked with the virtual target device in operation 1914. The BIM may be updated with the identification code and any other data or links in operation 1915.

In certain embodiments, a software tool (that may be referred to as a “facility management application”) provides a two-dimensional and/or three-dimensional, user-recognizable, graphical user interface for interacting with devices such as optically switchable (e.g., tintable) windows in a facility (e.g., comprising a building or group of buildings). In some implementations, the tool includes a user mode that allows a user to control or receive information about devices (e.g., windows) and a configuration mode that allows a user to design, set up, and/or configure how the software operates in the user mode of operation. The facility management application is described using these two modes, however, it should be understood the features described as being in the user mode may be present in the configuration mode and vice versa. Further, separate tools or modules, rather than a single application, may be used to implement the two modes. The graphical user interface of the facility management application may be displayed on variety of electronic devices comprising circuitry (weather mobile or stationary) such as a computer, phone, or tablet. In some embodiments, the graphical user interface is displayed on an administrator console and in some cases, the graphical user interface is displayed on a transparent display located on the surface of an optically switchable window (e.g., on a display construct). Examples of transparent display technologies (e.g., that may be incorporated with optically switchable windows), their operation, and their control can be found in International Patent Application Serial No. PCT/US18/29406, filed Apr. 25, 2018, and titled “TINTABLE WINDOW SYSTEM COMPUTING PLATFORM,” International Patent Application Serial No. PCT/US18/29460, filed Apr. 25, 2018, and titled “TINTABLE WINDOW SYSTEM FOR BUILDING SERVICES,” and International Patent Application Serial No. PCT/US20/53641, filed Sep. 30, 2020, titled “TANDEM VISION WINDOW AND MEDIA DISPLAY,” each of which is herein incorporated by reference in its entirety.

The tool may have a graphical user interface that uses 2D and/or 3D building models that may have already been created for another purpose, reducing (e.g., eliminating) costs of creating a building model solely for the purpose of the software tool. For many modern buildings in which a window network is installed, an accurate and detailed 3D building model already exists. Such models are used by architects and engineers when designing new buildings, and such models may be meticulously updated when a building is retrofitted. By using such a 2D and/or 3D building model, a tool may generate a powerful and intuitive graphical user interface that allows a user to view detailed information about devices (e.g., tintable windows) operatively coupled to a network, and may allow the user to control and/or selection of the devices (e.g., switching, and/or tinting of such windows).

In some embodiments, a 2D and/or 3D building model uses mathematical representations that reflect the geometry of a building. The model may be implemented as a file that contains parameters that, when interpreted by appropriate software, can provide details about the building's features and its geometric properties (e.g., dimensions, surfaces, and volumes defined by one or more surfaces). Features of a building (e.g., any structural component or any component placed within a building such as furniture) can be represented by one or more surfaces. For example, a window may be represented by a single surface representing one or more windowpanes. In a more detailed or accurate model, a window may be represented as a plurality of surfaces which define all or most exterior surfaces of the window including the window frame. In some embodiments, a feature is an accurate computer-aided design model for a part or particular feature that was used for the design or manufacture of that feature. Details of a feature in a building model may include details such as an exact location of its one or more defining surfaces, dimensions of the defining surface(s), the manufacturing information of the feature/component, history information of the feature/component, etc. as explained below.

A viewer module may read the building model file (e.g., BIM such as a Revit file) to generate a 2D and/or three-dimensional visualization (digital twin) of the building which may be depicted on a screen of an electronic device. The multi-dimensional visualization may be rendered from a plurality of surfaces of the various building features, each of which is defined by one or more polygon shapes. The surfaces may correspond to the features or physical aspects that make up a building. For example, a beam or a framing structure may each be represented by one or more surfaces within the building model. The resolution of the surfaces may be very high; sometimes the dimensions reflected in a model may be within a few centimeters of the actual building structure. In some embodiments, surfaces, when rendered, are colored and/or textured to reflect the visual appearance of a building more accurately. Within the building model, surfaces may be identified with an identifier such as a node ID, although such IDs need not be displayed with the viewer. In some cases, wireframe models or shell models that are described elsewhere herein may be compatible with the software tool or application. The rendering may be at least every about 5 minutes (min), 10 min, 20 min, 30 min, or 60 min. The rendering frequency of the digital twin of the facility may be between any of the aforementioned values (e.g., from 5 min to 60 min, from 5 min to 20 min, or from 20 min to 60 min).

Building models may be generated during the design phase of a building and may be provided by the building owner or a vendor of the owner who is responsible for design and construction of the building. 2D and/or 3D building models may be generated using computer-aided design (CAD) software such as Autodesk Revit or another similar software design package. In some cases, a building model is created (e.g., only) after the construction of the building, in which case it can take advantage of a locating detecting system such as Light Detection and Ranging (LiDAR). For example, a building model may be generated using a LiDAR camera, such as the Matterport 3D camera. In some embodiments, a 3D model of the building space(s) is generated using an omnidirectional beacon that sends, e.g., RF waves, and then receives input from energy reflected back, or transmitted back from one or more devices that receive the RF waves (reflected or directly), to one or more receivers. One such system that has this capability is the Ossia™ wireless powering system as described in U.S. patent application Ser. No. 14/945,741, filed Nov. 19, 2015, and published as US20160299210A1, titled “TECHNIQUES FOR IMAGING WIRELESS POWER DELIVERY ENVIRONMENTS AND TRACKING OBJECTS THEREIN,” which is herein incorporated by reference in its entirety. In certain embodiments, the devices (e.g., EC windows) are configured to receive and/or transmit wireless power. When used in conjunction with such wireless power capabilities, the EC system can auto-commission as described herein, where the building or space map is generated by the EC window system/window network using its wireless power transmission subsystem.

In some embodiments, the multi-dimensional models may contain various building information that may be relevant to an engineer, architect, or a facility manager. A building model file may contain metadata corresponding to building features and how those features interact with one another. As an illustrative example, consider a pipe used to deliver natural gas within a building. Metadata within the file may include information linked to a representation of the pipe (which may be displayed using one or more surfaces) that includes information such as the model, manufacturer, date of installation, installing contractor, material, dimensions, and fitting type of the pipe. As another example, all or a portion of an I-beam in a building may be represented as a surface, and such surface may contain information about the location of the I-beam, its structural materials, its vendor, etc.

In yet another example, surfaces or features of a building model may be indexed within a model file using data tags or keywords. These data tags may be included in the name associated with the surface/feature, or in the corresponding metadata. A surface or feature may have data tags that link the surface/feature to various characteristics and/or categories. Categories may be based on, e.g., feature type, feature model, size, location, or any other relevant parameter. The facility management application may then, in some cases, identify features corresponding to a certain data tag. The facility management application may be used to search features within the building model. For example, a user may identify all the overhanging features on the west facing, 3^{rd} floor of a building if a user enters the following search: [feature type: window overhang], [floor: third], [direction: west]. In some embodiments, these data tags are automatically added to the feature/surface during a building design by the software used to generate the building model. In some cases, such as when a feature is added to a building model from a library of features, the feature is imported into the building model already having appropriate data tags. When a building is changed by addition, replacement, etc., the building model may be updated to reflect the changes. For example, if a building is retrofitted, features may be added or removed from the building model. In some embodiments, the representation of surfaces in a building model remains unchanged, but the metadata information about affected surfaces is updated. For example, metadata for a structural component may be updated to indicate the date which the component was last inspected for safety.

In some embodiments, the building model is generated with a device network in mind. For example, components of a network (e.g., devices (e.g., IGUs), network controllers, and local controllers) may be added to a building model when the model is first created, or at a later time (e.g., during or after commissioning). When such components are added to the model, each of them may be defined as one or more features and/or one or surfaces. In some embodiments, components of the network are added from a library of network components in which the components are represented by their dimensions, appearance, etc. all in the form of corresponding metadata that can be included in the building model.

In some embodiments, the building model is provided in the form of a complex file that includes information that may or may not be essential to generating a graphical user interface for devices such as optically switchable windows. For example, the building model may include information such as an editing history of the building model, and/or metadata information relating to components that do not interface with a network. At least one of the non-essential information may be removed before the model is used to generate or render features of a graphical user interface. In some cases, files may have an “.RVT” file type or another proprietary file type that is generated using a computer-aided design software packages such as Autodesk Revit. In some embodiments, a building model undergoes a post-production process that makes the model suitable for use by the facility management application. In some embodiments, the building model is exported and saved in a simplified format in which the nonessential information is removed from the file. In some embodiments, the building model is saved in an open source format that may be easily accessed via a plurality of electronic device types and/or across various operating systems. For instance, in some cases, a building model is saved in a format that may be accessed by a viewer module that is compatible with or integrated within a web browser.

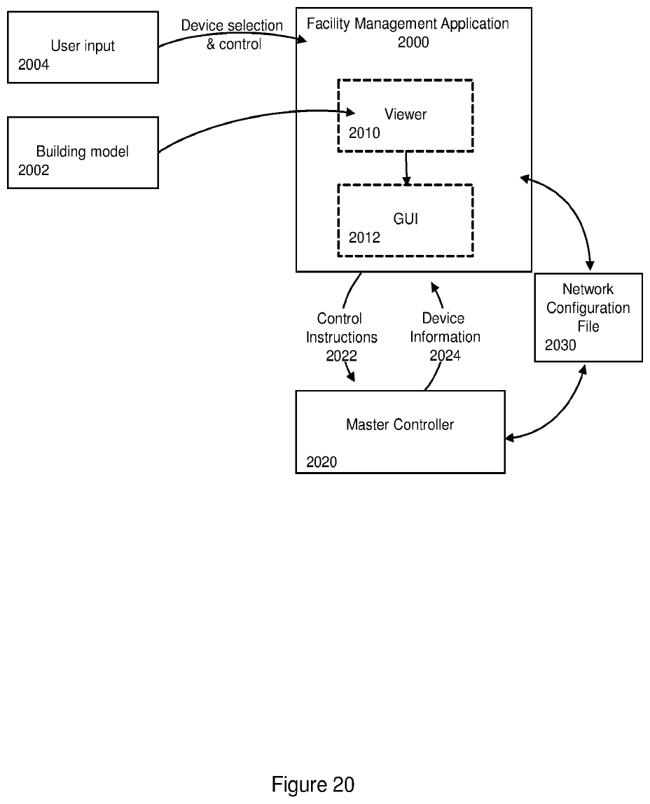

FIG. 20 provides an example of a block diagram showing the structure of the facility management application 2000 (an example of the tool mentioned herein). The application is configured to receive a building model 2002, or at least information from the model, and interpret the building model with a viewer module 2010. The application is configured to receive device (e.g., window) information 2024 from a source of information about the network (e.g., a master controller 2020 or another component on the window network). Such information may include network IDs (e.g., CAN IDs) and/or other information uniquely identifying individual devices on the network. The application is configured to receive a network configuration file 2030 that contains information linking network entities (e.g., devices such as emitters and/or optically switchable windows) to node IDs on a building model. The application may be configured to receive smart objects for devices (e.g., sensors and/or optically switchable windows) handled by the application (or at least receive sufficient information to produce smart objects for such devices). The application may be configured to receive these various pieces of information by one or more application programming interfaces or other appropriate software interfaces.

In some embodiments, the viewer module interprets the building model (or information from such model) in a manner allowing devices to be displayed as smart objects (e.g., virtual representation of target devices) that are in agreement with received device information on a graphical user interface (e.g., on a computer, a phone, a tablet, a transparent display associated with an optically switchable window, or another electronic device comprising circuitry).

The depicted facility management application is configured to receive user input 2004 which may be used to update the network configuration file 2030 and/or provide control instructions 2022 for controlling optically switchable windows on the window network. In certain embodiments, the application is configured to receive user input for any purpose described herein via a touch screen, a voice command interface, and/or other features a device operating the application can have for receiving user commands. Examples of voice-command interfaces that may be used in conjunction with a network of optically switchable windows are described in International Patent Application Serial No. PCT/US17/29476, filed Apr. 25, 2017, titled “CONTROLLING OPTICALLY-SWITCHABLE DEVICES,” and in U.S. Provisional Patent Application Ser. No. 63/080,899, filed on Sep. 21, 2020, titled “INTERACTION BETWEEN AN ENCLOSURE AND ONE OR MORE OCCUPANTS,” each of which is herein incorporated in its entirety. The various features of the software tool will now be described in greater detail.

In addition to being accessed via one or more controllers on a network, network configuration file 2030 may be accessed by the digital twin and/or by a facility management application. A network configuration file may contain various network information that is used by control logic to send information on the widow network and/or operate the devices. When accessed by the facility management application, the network configuration file may link or map features and/or surfaces of a building model to aspects of the network. For example, node IDs from the building model may be linked to specific device (e.g., IGUs), zones, zone groups, device coordinates, device IDs, and network IDs (e.g., CAN IDs or BACnet IDs). In some cases, the network configuration file has a database structure that is updated during a commissioning process or while utilizing a mapping function of the application. In some cases, a network configuration file 2030 used by the facility management application is the same file, or a copy of the same file, that is accessed by a master controller. In some cases, a network configuration file used by the facility management application may store different information than a network configuration file that provides information to a master controller. For example, in some cases, a network configuration file that is used by the application (e.g., only) pairs a node ID on from the building model with a window ID. In such cases, network configuration file that is accessed by a master controller contain additional information such as mappings between a device ID and a network ID, such as a CAN ID, or a BACnet ID, that is used to send communications to a network controller and/or to a local controller.

In some embodiments, the building model and/or the network configuration file is stored on a device that is used to run the facility management application. In some embodiments, there are multiple instances of the building model and/or the network configuration file on many devices, each of which is configured to run the facility management application. In some cases, the building model and/or the network configuration file are stored at a location external to the device running the facility management software; e.g., in the cloud, on a remote server, or at a controller within the network.

Included in or accessed by the facility management application is a viewer module 2010. The viewer module is a software module that reads the 3D building model (or portions thereof) and provides a visual rendering of the model on a device running or accessing the facility management application (e.g., a phone, tablet, or laptop). The rendering may be at least every about 5 minutes (min), 10 min, 20 min, 30 min, or 60 min. The rendering frequency of the 3D building model of the facility may be between any of the aforementioned values (e.g., from 5 min to 60 min, from 5 min to 20 min, or from 20 min to 60 min).

In some embodiments, the facility management application has a mapping function that allows users who have permissions to configure a graphical user interface. The mapping function associates the node IDs of surfaces and/or features in a building model to devices, zones, zone groups, and other network components. In some cases, the mapping function may pair a node ID with a corresponding smart object. The mapping function may access information related to the network from the network configuration file. The mapping function may save relationships made or identified via user input to the network configuration file.

In some embodiments, the viewer module (e.g., of the digital twin such as the app mentioned herein) and/or associated user interface is configured to display a smart object in place of a surface and/or feature within the graphical user interface. In some embodiments, a feature may be transformed into a smart object by automatically or manually associating the feature with an ID, data, or a script. The viewer module and/or user interface may be configured to overlay a smart object on top of the corresponding surface or feature that is displayed in the graphical user interface—for example; a smart object may provide a highlighted border around a surface indicating that the surface corresponds to a selectable smart object. In some embodiments, smart objects modify the appearance of a multi-dimensional model to indicate information provided by the network (e.g., device characteristics and/or status such as a tint state of an IGU, or environmental characteristics relating to the enclosure such as indoor/outdoor temperatures).

The facility management application optionally includes a controlling function through which a user may control one or more devices (e.g., optically switchable windows). For example, the application may send instructions to a master controller (or other network entity having control functionality) to set a tint state for a particular IGU or zone of IGUs. In some embodiments, the controlling function acts as the control logic (see, e.g., 504 in FIG. 5). In some embodiments, the controlling function relays control instructions to control logic located elsewhere on the network, e.g., at a master controller. In some embodiments, the application is used to define or carry out scheduling routines or rules based at least in part on user permissions. In some embodiments, the application is used to control other functions provided by the network. For example, if IGUs on the window network are configured with window antennas, the facility management application may be used to configure permissions of a wireless network implemented using the window antennas.

The facility management application may receive user input 2004 from a variety of electronic devices such as phones, tablets, and computers. In some cases, a graphical user interface is displayed on a transparent display located on the surface of an optically switchable window, and user input is received by user interaction with the transparent display. For example, a transparent display may be located on S1-S4 of an IGU and may partially or fully extend across the viable portion of the lite. In some embodiments, a window includes an on-glass transparent window controller that controls a displayed GUI and/or operates the electrochromic window. In some embodiments, a transparent display for a GUI interface is used for other functions such as displaying the date, time, or weather. In some embodiments, the application is configured to receive user input audibly from voice-controlled speaker devices such as a device using Apple's Siri platform, Amazon's Alexa platform, or the Google Assistant platform. In some embodiments, the facility management application is a web-based application that is accessed via electronic devices having internet connectivity wherein the user has appropriate permissions. For example, a user may be granted access to the application (e.g., only) if the user has credentials to log into the web-based application and/or if the device is determined to be within a close distance of the network. In some embodiments, the facility management application includes a copy of the building model file and/or the network configuration file. For example, the building model file, and network configuration file, and the facility management application may be packaged into a program that can be saved or installed on an electronic device to improve the operating performance of the application and, in some cases, allow for the use of the application even if internet connectivity is lost. In some embodiments, when the executable application is saved on the device, associated components or files are accessed from a remote location. For example, the building model and/or the network configuration file may be stored remotely and retrieved in whole or part to execute functions of the application (e.g., only) when necessary. In some cases, e.g., where there are multiple instances of a program on various devices, changes to the program made by a while operating the application in a configuration mode are pushed to copies of the program running located on other devices using, e.g., the cloud.

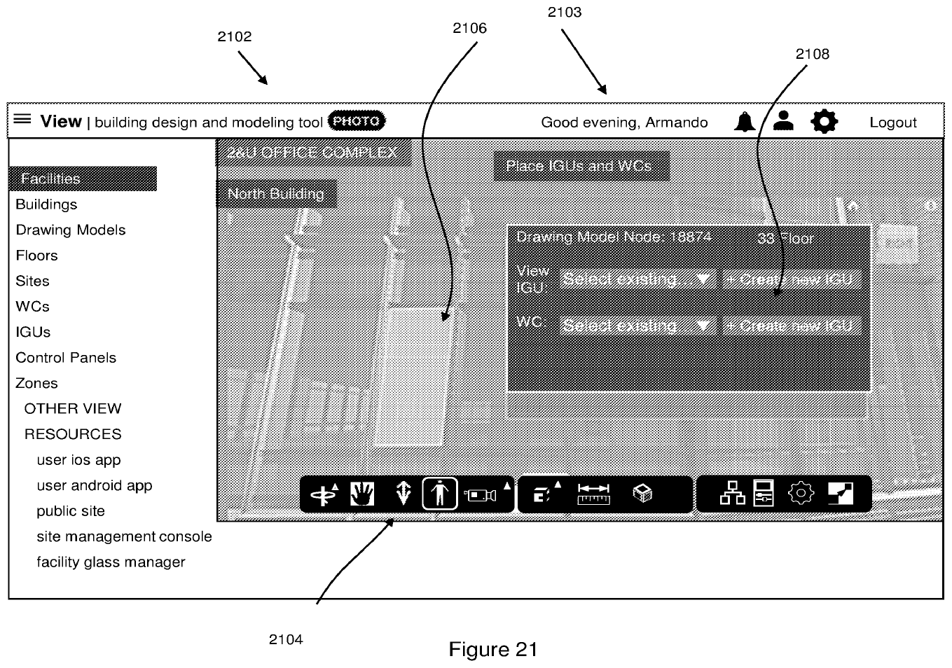

When operating the facility management application in a configuration mode, a user having permissions (e.g., a facilities manager) may set up and configure how the application functions for later use in a user mode. FIG. 21 provides an illustrative example of a graphical user interface that may be displayed when the facility management application is operated in the configuration mode. A user (e.g., facilities manager) may open up the (e.g., facility management) application in a window 2102 such as a web browser where the building model is displayed. A greeting adjusted to the time of date with the name of the user is presented in 2103. The application may also reside on a mobile device. The user (e.g., manager) may locate features or surfaces the building model that correspond to a component on the network, such as surface 2106 which corresponds to an electrochromic IGU. When a surface or feature is selected, the user (e.g., manager) may then be presented with a pop-up window 2108 or another interface from which the user (e.g., manager) may identify or map the selected surfaces and/or features to components on the network. For example, in some cases, a user (e.g., manager) can select what device a surface and/or feature corresponds to from a list of network components that are provided by the application (e.g., the application may receive a list of network components from the network configuration file). In some cases, a user (e.g., manager) may identify the surfaces and/or features corresponding to components of the network, after which, logic provided in the application may be used to automatically link the network ID of components on the network to the corresponding identified surfaces and/or features. For example, using methods previously discussed with relation to automatic commissioning using geo-location, logic may be used to map a node ID within a building model to a network IDs of a corresponding IGU or other component by comparing determined positions of network components to the positions of the identified surfaces and/or features within the building model. In some cases, a process automatically identifies surfaces and/or features in the building model that correspond to windows or other components of the network. In some cases, commissioning logic may be operated from the facility management application such that the network may be commissioned using the configuration mode. While this embodiments provide examples as to devices that comprises a window, any other device (e.g., as disclosed herein) can be substituted.

After surfaces and/or features in the building model have been manually or automatically paired via a node ID to a component on the network (e.g., via a network ID), smart objects may be selected or generated. Ultimately, these may be made available for display and selection in the user mode of operation. The smart objects may be linked to the node IDs of the building model and may be displayed in various formats as described elsewhere herein. For example, a smart object may be displayed instead of a surface in the building model, or a smart object may be configured to be activated (e.g., to present a list of controllable features) when one or more surfaces are selected in the building model. In some embodiments, a smart object is generated by the application such that the size, dimensions, and placement of the smart object within the building model correspond with surface(s) and/or features of the building model that have been paired with a component of the network. In some embodiments, the application receives information from metadata in the building model or a network configuration file that is used to create a smart object. The features available on a smart object that is generated may depend on an ID (e.g., a window ID or a network ID) of the component the smart object is associated with. For example, if a smart object is paired to a device such as an optically switchable window, the smart object may have features that display the current tint state and or allow a user to adjust the tint state. If the electrochromic window has associated sensors (e.g., an interior light sensor, exterior light sensor, interior temperature sensor, exterior temperature, or occupancy sensor), then the smart object may be configured to display the sensed information and/or options to control the tint state of the optically switchable window to help regulate the sensed information. In some embodiments, smart objects are selected from a library of smart objects (e.g., a library stored within the application or downloaded from a remote server) where the library of smart objects includes various components which may be installed on the network. In some embodiments, smart objects are displayed on the building model within the configuration mode where they may be selected for further editing. The smart objects may be associated with any device disclosed herein. The smart objects may be linked to the digital twin.

Referring again to FIG. 21, a user (e.g., facility manager) may organize how the network is configured. For example, using a dialog box such as 2108, the user (e.g., facility manager) may configure a particular device such as IGU as belonging to a specific zone or zone group of devices (e.g., IGUs). As an example, after selecting a surface and/or feature in the building model, the application may display a list of zones to which the device may be added to, or present the user with an option of creating a new zone. In some embodiments, the configuration mode of operation is used to create customized views that may be displayed in the user mode. For example, using navigation controls 2104 that are available within the configuration mode, a user may select a vantage point or perspective that will be displayed in the user mode.

Using the configuration mode, a user (e.g., building manager) may define operation (e.g., tint) schedules for the devices (e.g., optically switchable windows) and/or rules for regulating the environment (e.g., lighting and/or temperature) within the building. A user (e.g., manager) may set permissions for other users. For example, a tenant of a large building may be given control (e.g., only) over the device (e.g., optically switchable windows) in his or her rented space. In some embodiments, a first user grants other users and/or devices access to the configuration mode of the application so that they may establish their own rules and/or create their own customized views. In some cases, rules or other changes that users may make are limited so that they do not violate rules established by the user (e.g., a facility manager or a user of an administrative account). The user may be a facility manager, a maintenance personnel, a customer, and/or a customer success team member.

In some cases, when used by a field service engineer (FSE), the application may present a list of components where a malfunction has been detected and/or where maintenance is needed. In some cases, these features are highlighted and/or in some way marked within the displayed building model, e.g., making it easier for an FSE to know where attention is needed. An FSE might have to ask a facility manager where a malfunctioning device is located or possibly look at interconnect and architectural drawings. This can be a cumbersome process at large sites such as a multistory building, airports, and hospitals where a malfunctioning window may not have even been noticed by site personnel or in cases where the malfunctioning device was self-detected through the network. To facilitate an FSE, the application may provide directions to a particular component in question. For example, the application may display a route overlaid on a plan view of a building indicating the route that the FSE should take. In some cases, such as when the application is operated on a tablet or mobile device that is automatically located within the building, the application may provide turn-by-turn directions—similar to turn-by-turn directions used in a (e.g., GPS) navigations systems. While discussed in terms of directing an FSE to a device requiring service (e.g., malfunctioning device), the application may provide maps and/or routes that can be used by any user of the application. In some cases, antennas (e.g., windows having antennas) or any other geo-location sensor and receiver network (e.g., as disclosed herein) can be used to locate the device. Methods of location detection and routing users using a network are further described in International Patent Application Serial No. PCT/US17/31106, filed on May 4, 2017, titled “WINDOW ANTENNAS,” which is hereby incorporated by reference in its entirety.

In some embodiments, a plurality of devices may be operatively (e.g., communicatively) coupled to the control system. The plurality of devices may be disposed in a facility (e.g., including a building and/or room). The control system may comprise the hierarchy of controllers. The devices may comprise an emitter, a sensor, or a window (e.g., IGU). The device may be any device as disclosed herein. At least two of the plurality of devices may be of the same type. For example, two or more IGUs may be coupled to the control system. At least two of the plurality of devices may be of different types. For example, a sensor and an emitter may be coupled to the control system. At times, the plurality of devices may comprise at least 20, 50, 100, 250, 500, 1000, 2500, 5000, 7500, 10000, 50000, 100000, or 500000 devices. The plurality of devices may be of any number between the aforementioned numbers (e.g., from 20 devices to 500000 devices, from 20 devices to 50 devices, from 50 devices to 500 devices, from 500 devices to 2500 devices, from 1000 devices to 5000 devices, from 5000 devices to 10000 devices, from 10000 devices to 100000 devices, or from 100000 devices to 500000 devices). For example, the number of windows in a floor may be at least 5, 10, 15, 20, 25, 30, 40, or 50. The number of windows in a floor can be any number between the aforementioned numbers (e.g., from 5 to 50, from 5 to 25, or from 25 to 50). At times, the devices may be in a multi-story building. At least a portion of the floors of the multi-story building may have devices controlled by the control system (e.g., at least a portion of the floors of the multi-story building may be controlled by the control system). For example, the multi-story building may have at least 2, 8, 10, 25, 50, 80, 100, 120, 140, or 160 floors that are controlled by the control system. The number of floors (e.g., devices therein) controlled by the control system may be any number between the aforementioned numbers (e.g., from 2 to 50, from 25 to 100, or from 80 to 160). The floor may be of an area of at least about 150 m², 250 m², 500 m², 1000 m², 1500 m², or 2000 square meters (m²). The floor may have an area between any of the aforementioned floor area values (e.g., from about 150 m² to about 2000 m², from about 150 m² to about 500 m² from about 250 m² to about 1000 m², or from about 1000 m² to about 2000 m²). The building may comprise an area of at least about 1000 square feet (sqft), 2000 sqft, 5000 sqft, 10000 sqft, 100000 sqft, 150000 sqft, 200000 sqft, or 500000 sqft. The building may comprise an area between any of the above mentioned areas (e.g., from about 1000 sqft to about 5000 sqft, from about 5000 sqft to about 500000 sqft, or from about 1000 sqft to about 500000 sqft). The building may comprise an area of at least about 100 m², 200 m², 500 m², 1000 m², 5000 m², 10000 m², 25000 m², or 50000 m². The building may comprise an area between any of the above mentioned areas (e.g., from about 100 m² to about 1000 m², from about 500 m² to about 25000 m², from about 100 m² to about 50000 m²). The facility may comprise a commercial or a residential building. The commercial building may include tenant(s) and/or owner(s). The residential facility may comprise a multi or a single family building. The residential facility may comprise an apartment complex. The residential facility may comprise a single family home. The residential facility may comprise multifamily homes (e.g., apartments). The residential facility may comprise townhouses. The facility may comprise residential and commercial portions. The facility may comprise at least about 1, 2, 5, 10, 50, 100, 150, 200, 250, 300, 350, 400, 420, 450, 500, or 550 windows (e.g., tintable windows). The windows may be divided into zones (e.g., based at least in part on the location, façade, floor, ownership, utilization of the enclosure (e.g., room) in which they are disposed, any other assignment metric, random assignment, or any combination thereof. Allocation of windows to the zone may be static or dynamic (e.g., based on a heuristic). There may be at least about 2, 5, 10, 12, 15, 30, 40, or 46 windows per zone.

By having access to visualize components on a network, an FSE may be made aware of information that is helpful for inspection and/or servicing. For example, after inspecting a component as displayed in the building model (e.g., by looking at a zooming to that portion of the model), a FSE may be made aware that a ladder is needed to access a device (e.g., controller) located on a ceiling, or that specific tooling will be needed to access a device that is concealed behind drywall. The application may display technical details of the component such as the model number, the date of installation, the firmware installed, various connected devices, and other technical details such as usage patterns, and/or historical data (e.g., status related information such as leakage current overtime for a particular IGU) that may help an FSE diagnose a problem. By having the ability to take a detailed look at the building model, an FSE may arrive at the site prepared to do the servicing—potentially eliminating extra trips that might otherwise be needed to collect needed materials or tools.

In some embodiments, an FSE can, using the facility management application, sort through installed components using various filters. For example, when a feature is added to a model, it may have data tags and/or metadata that include information such as the date of installation, the date of manufacture, the part model number, the size of an IGU, the firmware on a controller, other device characteristic and/or status information. This information may be helpful in doing preventative maintenance, e.g., when an FSE is at a site to take care of another service request. For example, if it is determined that some controllers manufactured during a certain time frame are prone to premature failure because of a manufacturing defect, an FSE may be able to identify the controllers in question using sorting criteria provided within the application. An FSE may then replace the questionable components before they fail.

In some embodiments, the facility management application has a design module executable within the configuration mode that allows the application to be used for designing the layout of a network in a building. A designer may design a network without needing to visit the physical building for inspection. For example, by inspecting a building model via the design module (e.g., via the digital twin), a designer may take virtual measurements and use tools within the design module to understand light penetration into a building at various times of the year. In the conventional design process, a design engineer might consider architectural drawings to understand the layout of a building. With an understanding of the structure of the building, the designer can may create 2D and/or 3D installation schematics that may be used by an installer as instructions for physical installation. The design process may be tedious, and errors can be introduced as a result of drawing inaccuracies, the architectural drawings being misread, and/or forgetfulness of a designer to consider design rules (e.g., human errors). By using the design module, the timeline for designing a network and completing the installation of devices may be expedited for reasons discussed herein. The expedited timeline may be expedited by at least 50%, 70%, or 90% relative to the time it would take without utilization of the digital twin and/or design module disclosed herein.

In certain embodiments, within the design module, a designer has access to a library of objects or features that may be inserted into a building model. These objects or features are representative of various network components—including windows, window controllers, network controllers, master controllers, sensors, wiring, circuitry for power and communication, and any other device operatively coupled to a network (e.g., as disclosed herein). The library of objects may include structures and/or components that a network may interface with, including structural components that may be needed during installation (e.g., mounting devices for controllers, wiring, etc.). In some embodiments, components of a network that are added to a building model are imported with smart objects which are later used as part of a graphical user interface for controlling the network of optically switchable windows as discussed elsewhere herein. The digital twin and/or design module may comprise devices and/or objects (e.g., fixtures and/or non-fixtures) not coupled to the network. The devices and/or objects (e.g., fixtures and/or non-fixtures) not coupled to the network may have an identification code.

In some embodiments, within the design module, components from a library may be easily selected and imported into a building model. In some cases, the design module may assist in the design process by automatically selecting and/or suggesting an appropriate component for a particular use, e.g., allowing for virtual measurements, enforcing design rules, and/or providing warnings when a design rule is broken.

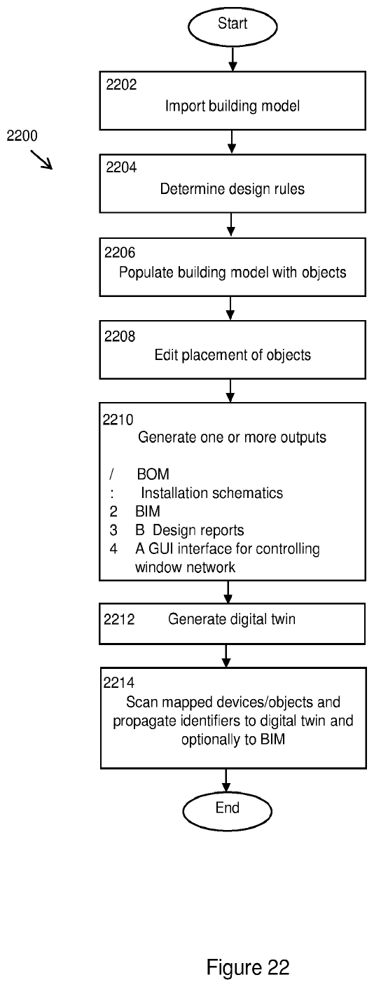

FIG. 22 depicts an example of a method 2200 that a designer may use to design a network. In operation 2202 a building model is loaded or imported into the design module of the facility management application. In some cases, the design module may be an extension or plug-in to the facility management application that is installed or in some cases may operate separately from the rest of the facility management application. In some cases, aspects of the design module, including the library of network objects, may be used as a plug-in for a CAD software applications such as Autodesk Revit. In operation 2204, the design rules that will be enforced by the design module are determined. In some cases, design rules are associated with objects from a library of components accessed by the design module and are not editable. Some design rules, such as rules for triggering warnings, may be edited or adjusted by the designer. In some cases, the designer may impose a set of rules for particular tie points or objects to improve uniformity of the finalized design or determine how the design module will auto-populate a building model with objects of network components. In operation 2206, the building model is populated with objects representing network components. These objects interface with each other at tie points that limit the placement of objects within a building according to the design rules. In some cases, populating the building model with objects may be automated by logic within the design module that determines where appropriate window object should be placed, and then places additional objects as needed to create a network of objects joined by tie points corresponding to a functional network. In some cases, populating the building model may be partially automated, where, e.g., the user may select where devices (e.g., optically switchable windows) should be placed, and the design module determines the placement of other components. In some cases, populating the building model may be a (e.g., largely) manual process. In operation 2208 adjustments may be made to the placement of objects within the building model by the designer. For example, if a designer is unsatisfied with how a building model has been automatically populated with objects, a designer may adjust the location of objects and/or their associated tie points. Having determined the placement of objects within a building model, the design module may be used to automatically generate various outputs in operation 2210. In some cases, the design module may automatically generate a bill of materials (BOM) or installation schematics. In some cases, the design module may create, or update a building information model (BIM) that may be later used by the building owner to make upkeep, retrofit, and other building related decisions. In some cases, the design module may be used to automatically generate a report that may determine various costs and benefits of installing a network. In some cases, a design module may be used to generate a graphical user interface for controlling the network that has been designed.

The controller may monitor and/or direct (e.g., physical) alteration of the operating conditions of the apparatuses, software, and/or methods described herein. Control may comprise regulate, manipulate, restrict, direct, monitor, adjust, modulate, vary, alter, restrain, check, guide, or manage. Controlled (e.g., by a controller) may include attenuated, modulated, varied, managed, curbed, disciplined, regulated, restrained, supervised, manipulated, and/or guided. The control may comprise controlling a control variable (e.g., temperature, power, voltage, and/or profile). The control can comprise real time or off-line control. A calculation utilized by the controller can be done in real time, and/or off-line. The controller may be a manual or a non-manual controller. The controller may be an automatic controller. The controller may operate upon request. The controller may be a programmable controller. The controller may be programed. The controller may comprise a processing unit (e.g., CPU or GPU). The controller may receive an input (e.g., from at least one sensor). The controller may deliver an output. The controller may comprise multiple (e.g., sub-) controllers. The controller may be a part of a control system. The control system may comprise a master controller, floor controller, local controller (e.g., enclosure controller, or window controller). The controller may receive one or more inputs. The controller may generate one or more outputs. The controller may be a single input single output controller (SISO) or a multiple input multiple output controller (MIMO). The controller may interpret the input signal received. The controller may acquire data from the one or more sensors. Acquire may comprise receive or extract. The data may comprise measurement, estimation, determination, generation, or any combination thereof. The controller may comprise feedback control. The controller may comprise feed-forward control. The control may comprise on-off control, proportional control, proportional-integral (PI) control, or proportional-integral-derivative (PID) control. The control may comprise open loop control, or closed loop control. The controller may comprise closed loop control. The controller may comprise open loop control. The controller may comprise a user interface. The user interface may comprise (or operatively coupled to) a keyboard, keypad, mouse, touch screen, microphone, speech recognition package, camera, imaging system, or any combination thereof. The outputs may include a display (e.g., screen), speaker, or printer. The methods, systems and/or the apparatus described herein may comprise a control system. The control system can be in communication with any of the apparatuses (e.g., sensors) described herein. The sensors may be of the same type or of different types, e.g., as described herein. For example, the control system may be in communication with the first sensor and/or with the second sensor. The control system may control the one or more sensors. The control system may control one or more components of a building management system (e.g., lightening, security, and/or air conditioning system). The controller may regulate at least one (e.g., environmental) characteristic of the enclosure. The control system may regulate the enclosure environment using any component of the building management system. For example, the control system may regulate the energy supplied by a heating element and/or by a cooling element. For example, the control system may regulate velocity of an air flowing through a vent to and/or from the enclosure. The control system may comprise a processor. The processor may be a processing unit. The controller may comprise a processing unit. The processing unit may be central. The processing unit may comprise a central processing unit (abbreviated herein as “CPU”). The processing unit may be a graphic processing unit (abbreviated herein as “GPU”). The controller(s) or control mechanisms (e.g., comprising a computer system) may be programmed to implement one or more methods of the disclosure. The processor may be programmed to implement methods of the disclosure. The controller may control at least one component of the forming systems and/or apparatuses disclosed herein.

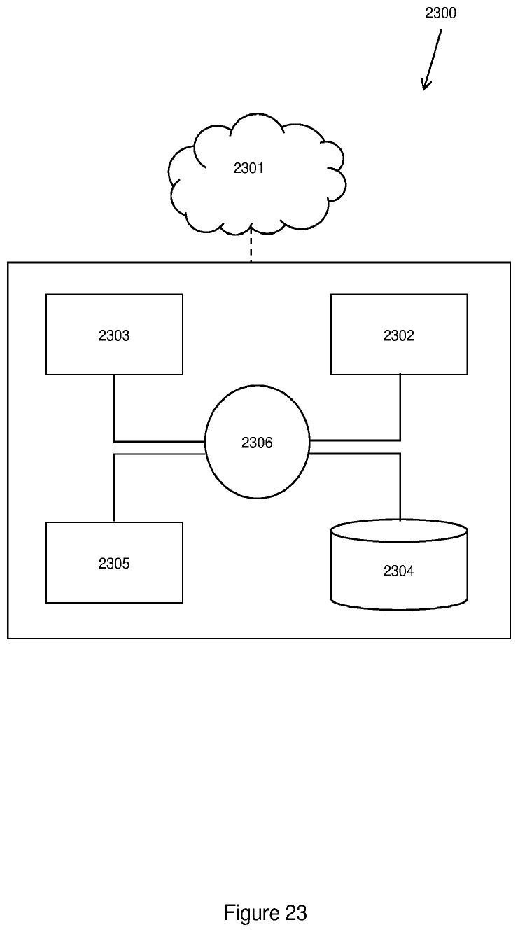

FIG. 23 shows a schematic example of a computer system 2300 that is programmed or otherwise configured to one or more operations of any of the methods provided herein. The computer system can control (e.g., direct, monitor, and/or regulate) various features of the methods, apparatuses, and systems of the present disclosure, such as, for example, control heating, cooling, lightening, and/or venting of an enclosure, or any combination thereof. The computer system can be part of, or be in communication with, any sensor or sensor ensemble disclosed herein. The computer may be coupled to one or more mechanisms disclosed herein, and/or any parts thereof. For example, the computer may be coupled to one or more sensors, valves, switches, lights, windows (e.g., IGUs), motors, pumps, optical components, or any combination thereof.

The computer system can include a processing unit (e.g., 2306) (also “processor,” “computer” and “computer processor” used herein). The computer system may include memory or memory location (e.g., 2302) (e.g., random-access memory, read-only memory, flash memory), electronic storage unit (e.g., 2304) (e.g., hard disk), communication interface (e.g., 2303) (e.g., network adapter) for communicating with one or more other systems, and peripheral devices (e.g., 2305), such as cache, other memory, data storage and/or electronic display adapters. In the example shown in FIG. 23, the memory 2302, storage unit 2304, interface 2303, and peripheral devices 2305 are in communication with the processing unit 2306 through a communication bus (solid lines), such as a motherboard. The storage unit can be a data storage unit (or data repository) for storing data. The computer system can be operatively coupled to a computer network (“network”) (e.g., 2301) with the aid of the communication interface. The network can be the Internet, an internet and/or extranet, or an intranet and/or extranet that is in communication with the Internet. In some cases, the network is a telecommunication and/or data network. The network can include one or more computer servers, which can enable distributed computing, such as cloud computing. The network, in some cases with the aid of the computer system, can implement a peer-to-peer network, which may enable devices coupled to the computer system to behave as a client or a server.

The processing unit can execute a sequence of machine-readable instructions, which can be embodied in a program or software. The instructions may be stored in a memory location, such as the memory 2302. The instructions can be directed to the processing unit, which can subsequently program or otherwise configure the processing unit to implement methods of the present disclosure. Examples of operations performed by the processing unit can include fetch, decode, execute, and write back. The processing unit may interpret and/or execute instructions. The processor may include a microprocessor, a data processor, a central processing unit (CPU), a graphical processing unit (GPU), a system-on-chip (SOC), a co-processor, a network processor, an application specific integrated circuit (ASIC), an application specific instruction-set processor (ASIPs), a controller, a programmable logic device (PLD), a chipset, a field programmable gate array (FPGA), or any combination thereof. The processing unit can be part of a circuit, such as an integrated circuit. One or more other components of the system 2300 can be included in the circuit.

The storage unit can store files, such as drivers, libraries and saved programs. The storage unit can store user data (e.g., user preferences and user programs). In some cases, the computer system can include one or more additional data storage units that are external to the computer system, such as located on a remote server that is in communication with the computer system through an intranet or the Internet.

The computer system can communicate with one or more remote computer systems through a network. For instance, the computer system can communicate with a remote computer system of a user (e.g., operator). Examples of remote computer systems include personal computers (e.g., portable PC), slate or tablet PC's (e.g., Apple® iPad, Samsung@Galaxy Tab), telephones, Smart phones (e.g., Apple® iPhone, Android-enabled device, Blackberry®), or personal digital assistants. A user (e.g., client) can access the computer system via the network.

Methods as described herein can be implemented by way of machine (e.g., computer processor) executable code stored on an electronic storage location of the computer system, such as, for example, on the memory 2302 or electronic storage unit 2304. The machine executable or machine-readable code can be provided in the form of software. During use, the processor 2306 can execute the code. In some cases, the code can be retrieved from the storage unit and stored on the memory for ready access by the processor. In some situations, the electronic storage unit can be precluded, and machine-executable instructions are stored on memory.

The code can be pre-compiled and configured for use with a machine have a processer adapted to execute the code or can be compiled during runtime. The code can be supplied in a programming language that can be selected to enable the code to execute in a pre-compiled or as-compiled fashion.

In some embodiments, the processor comprises a code. The code can be program instructions. The program instructions may cause the at least one processor (e.g., computer) to direct a feed forward and/or feedback control loop. In some embodiments, the program instructions cause the at least one processor to direct a closed loop and/or open loop control scheme. The control may be based at least in part on one or more sensor readings (e.g., sensor data). One controller may direct a plurality of operations. At least two operations may be directed by different controllers. In some embodiments, a different controller may direct at least two of operations (a), (b) and (c). In some embodiments, different controllers may direct at least two of operations (a), (b) and (c). In some embodiments, a non-transitory computer-readable medium cause each a different computer to direct at least two of operations (a), (b) and (c). In some embodiments, different non-transitory computer-readable mediums cause each a different computer to direct at least two of operations (a), (b) and (c). The controller and/or computer readable media may direct any of the apparatuses or components thereof disclosed herein. The controller and/or computer readable media may direct any operations of the methods disclosed herein.

In some embodiments, the at least one sensor is operatively coupled to a control system (e.g., computer control system). The sensor may comprise light sensor, acoustic sensor, vibration sensor, chemical sensor, electrical sensor, magnetic sensor, fluidity sensor, movement sensor, speed sensor, position sensor, pressure sensor, force sensor, density sensor, distance sensor, or proximity sensor. The sensor may include temperature sensor, weight sensor, material (e.g., powder) level sensor, metrology sensor, gas sensor, or humidity sensor. The metrology sensor may comprise measurement sensor (e.g., height, length, width, angle, and/or volume). The metrology sensor may comprise a magnetic, acceleration, orientation, or optical sensor. The sensor may transmit and/or receive sound (e.g., echo), magnetic, electronic, or electromagnetic signal. The electromagnetic signal may comprise a visible, infrared, ultraviolet, ultrasound, radio wave, or microwave signal. The gas sensor may sense any of the gas delineated herein. The distance sensor can be a type of metrology sensor. The distance sensor may comprise an optical sensor, or capacitance sensor. The temperature sensor can comprise Bolometer, Bimetallic strip, calorimeter, Exhaust gas temperature gauge, Flame detection, Gardon gauge, Golay cell, Heat flux sensor, Infrared thermometer, Microbolometer, Microwave radiometer, Net radiometer, Quartz thermometer, Resistance temperature detector, Resistance thermometer, Silicon band gap temperature sensor, Special sensor microwave/imager, Temperature gauge, Thermistor, Thermocouple, Thermometer (e.g., resistance thermometer), or Pyrometer. The temperature sensor may comprise an optical sensor. The temperature sensor may comprise image processing. The temperature sensor may comprise a camera (e.g., IR camera, CCD camera). The pressure sensor may comprise Barograph, Barometer, Boost gauge, Bourdon gauge, Hot filament ionization gauge, Ionization gauge, McLeod gauge, Oscillating U-tube, Permanent Downhole Gauge, Piezometer, Pirani gauge, Pressure sensor, Pressure gauge, Tactile sensor, or Time pressure gauge. The position sensor may comprise Auxanometer, Capacitive displacement sensor, Capacitive sensing, Free fall sensor, Gravimeter, Gyroscopic sensor, Impact sensor, Inclinometer, Integrated circuit piezoelectric sensor, Laser rangefinder, Laser surface velocimeter, LIDAR, Linear encoder, Linear variable differential transformer (LVDT), Liquid capacitive inclinometers, Odometer, Photoelectric sensor, Piezoelectric accelerometer, Rate sensor, Rotary encoder, Rotary variable differential transformer, Selsyn, Shock detector, Shock data logger, Tilt sensor, Tachometer, Ultrasonic thickness gauge, Variable reluctance sensor, or Velocity receiver. The optical sensor may comprise a Charge-coupled device, Colorimeter, Contact image sensor, Electro-optical sensor, Infra-red sensor, Kinetic inductance detector, light emitting diode (e.g., light sensor), Light-addressable potentiometric sensor, Nichols radiometer, Fiber optic sensor, Optical position sensor, Photo detector, Photodiode, Photomultiplier tubes, Phototransistor, Photoelectric sensor, Photoionization detector, Photomultiplier, Photo resistor, Photo switch, Phototube, Scintillometer, Shack-Hartmann, Single-photon avalanche diode, Superconducting nanowire single-photon detector, Transition edge sensor, Visible light photon counter, or Wave front sensor. The one or more sensors may be connected to a control system (e.g., to a processor, to a computer).

In some embodiment a software application may comprise a facility visualizer. The software application may offer a user the ability to observe, manipulate (e.g., revise or adjust), and/or create various features relating to the facility. The feature may relate to the architectural structure of the facility (e.g., fixtures), to assets (e.g., non-fixtures and/or devices) of the facilities, to a network of the facility, and/or to a control system of the facility. For example, the facility visualizer (e.g., building visualizer) may facilitate utilization, alteration, and/or creation of a topological electrical relationships in a digital twin of the facility, and display the digital twin in a user interface (UI) of the facility visualizer software application (e.g., app). The app may reside on a cloud or locally (e.g., in the facility or outside of the facility).

In some embodiments, the app may offer a search feature. In some embodiments, the app may facilitate a rendering feature. The rendering may be at least every about 5 minutes (min), 10 min, 20 min, 30 min, or 60 min. The rendering frequency of the simulation of the facility, may be between any of the aforementioned values (e.g., from 5 min to 60 min, from 5 min to 20 min, or from 20 min to 60 min). The rendering feature may simulate outside influences affecting the facility (e.g., sunlight irradiating on the facility). The rendering feature may simulate inside influences affecting the facility (e.g., affecting an environment of the facility). The rendering feature may use input from one or more sensors of the facility (e.g., historic values and/or real time values). The rendering feature may use input of third parties (e.g., weather forecast) The rendering feature may use historical input (e.g., of this or other facilities, e.g., in a similar setting such as similar geographical and/or environmental setting). The rendering feature may consider one or more jurisdictional rules, regulations, and/or restrictions. The rendering feature may consider one or more industrial recommendation, guidelines, and/or standards. For example, the rendering feature may render a sensor attribute in an enclosure of the facility, e.g., as a function of time. The attribute may include temperature, gas (e.g., air) flow, gas distribution and/or levels, noise levels, pressure levels, and the like (e.g., depending on the sensed measurements). The simulation may include generating a map of the attribute throughout the enclosure of the facility. For example, the simulation may visualize a temperature map in the facility (e.g., using temperature sensors of the facility). For example, the simulation may visualize a ventilation map in the facility (e.g., using data of vent placement and HVAC operation). For example, the simulation may visualize a noise map in the facility (e.g., using noise sensors of the facility). The rendering may be time dependent rendering. For example, a user may view an evolution of the rendered attribute as a function of time (e.g., by selecting various times and/or dates, or by selecting a range of times and/or dates). Such rendering may be presented as a movie, that may be optionally recorded, e.g., per user's request. The rendered movie may have a frame every at least about 5 minutes (min), 10 min, 20 min, 30 min, or 60 min. The rendering frames of the digital twin of the facility may be between any of the aforementioned values (e.g., from 5 min to 60 min, from 5 min to 20 min, or from 20 min to 60 min).

In some embodiments, the software application may include a search feature. The search feature may facilitate searching through an inventory of the facility that is depicted in the digital twin (e.g., architectural elements, and/or assets (e.g., such as non-fixtures and/or devices).

In some embodiments, the software application may present a virtual visualization of the facility in its surroundings in the real-world. In some embodiments, the digital twin simulation may consider the facility in its surroundings in the real-world. For example, the software application and/or simulation of the digital twin may consider an Isovist of shadow and light affecting the facility exterior. For example, the software application may present an image (on a UI) of the facility in a municipal surrounding (e.g., urban surrounding), and/or in a topographical surrounding. For example, the software application may present an image (on a UI) of the facility in conjunction with any civil and/or structural engineering features (e.g., roads, bridges, and/or water fountains). These features may be consider during rendering of the facility, e.g., considering their influence on the facility's exterior and/or interior (e.g., internal environment).

In some embodiments, the software application may provide a report. The report may be related to any aspect of the digital twin (e.g., architectural elements, network, control, and/or assets (e.g., fixtures, non-fixtures and/or devices). The reporting may be done in real time. The report may be generated following a change in the digital twin of the facility. The report may provide a summary of facility assets (e.g., including any available information including various identifications and/or status of the assets). The report may provide a commissioning status of the facility (e.g., including assets therein). The digital twin may incorporate assets (e.g., devices) that have been commissioned in the facility and/or assets to be commissioned in the facility in the future. A user may be able to select various features to include in the report, e.g., using the app. For example, the user may select reporting a commissioned status of the devices of the facility. In some embodiments, system hierarchy is included in the digital twin. The system hierarchy may include a hierarchy of controllers, of devices, and/or of zones. The zones may be grouped into groups (e.g., each having a distinguishable name and/or notation). The zones may be clustered (e.g., with each cluster having a distinguishable name and/or notation). The zones, their grouping and/or clustering may form a hierarchy of zones. The user may select a report delineating a selected hierarchy (e.g., from available options).

In some embodiments, the software application simulates impingement onto the facility and/or penetration of radiation into the facility. The app may utilize standard penetration depth, e.g., based at least in part on space type and/or building vertical, e.g., for occupancy location and/or device control (e.g., tinting control of the tintable windows).

In some embodiments, the software application may be utilized to evaluate an optimal location of device(s) such as sensor(s), emitter(s), transceiver(s), antenna(s), and/or tintable windows, e.g., using its simulation capabilities and other utilization of the digital twin of the facility. For example, the app. may facilitate location of a weather sensor (e.g., sky sensor). The sky sensor may be disposed externally to the facility (e.g., on a wall or on a roof of the facility. The app may aid in determining a favorable (e.g., optimal) location for localizing the weather sensor.

In some embodiments, the software application may be utilized to simulate and/or evaluate sensor data (e.g., of sensors of the facility), e.g., in real time (e.g., as they measure data). The app may store sensor thresholds and/or lockouts. The app may allow the user to view the sensor data, e.g., as simulated with relation to the digital twin. For example, the app may visualize a mapping of the sensor data in at least a portion of the facility, e.g., in real time and/or as a function of time. The time functionality may be facilitated using a time and/or date based slider, or time and/or date range. For example, the time functionality may facility rendering evolution of various aspects of the facility (e.g., sensed attributes and/or sun radiation), through a cycle of one day (one 24 hour cycle). The time functionality may facilitate rendering based on a yearly season (e.g., winter, summer, fall, or spring).

In some embodiments, the app utilizes a software module including APIs and/or services that help access and/or use the facility's design and engineering data (e.g., via the cloud). In some embodiments, the app may utilize a software module configured to allow access to design and engineering data in the cloud (e.g., Autodesk Forge platform). The app may facilitate extraction of an underlying code of a third party cloud design and/or engineering software (e.g., Autodesk Forge). For example, the app may facilitate extraction of an open standard file format and/or data interchange format (e.g., that uses human-readable text to store and transmit data objects consisting of attribute-value pairs and arrays (and/or other serializable values)). The app may facilitate extraction of a language-independent data format. For example, the app may facilitate extraction of JavaScript, or JavaScript related formats. For example, the app may facilitate extraction of JavaScript Object Notation (JSON) such as HBJSON. The app may facilitate extraction of the file format from such cloud application (e.g., from the Forge Model). The extracted file may be utilized for a control module (e.g., Intelligence) configured to control the facility (e.g., control devices of the facility). For example, the extracted file (e.g., HBJSON file) may be utilized to pollinate the control system (e.g., by pollinating the Intelligence module, e.g., in the cloud), and/or into the (e.g., local) database of the facility. The database of the facility can be in the cloud or not in the cloud. The database may be in the facility or external to the facility.

In some embodiments, the software application facilitates saving the input, changes, and/or creations concerning the digital twin. The saved changes to the digital twin may be utilized for commissioning, for control of the facility, and/or for maintenance of the facility. The facility includes any portion of the facility, e.g., as indicated in the digital twin (and at times, also those not indicated in the digital twin).

In some embodiments, the software application may facilitate obtaining user input for generating an understanding (e.g., intelligence that can be utilized by the control system) from the digital twin. In some embodiments, the software application may comprise a web-interface for generating an understanding (e.g., intelligence that can be utilized by the control system) from the digital twin. The user may connect to the software application via the web interface. For example, a customer success manager (e.g., CSM) may interact with the application in input information comprising (i) zones and optionally zone names, (i) zone groups and optionally zone group names, (ii) zone clusters and optionally zone cluster names, (iii) standard penetration depth (e.g., based at least in part on space type and building vertical, such as for occupancy location), (iv) location for weather file grab, and/or (v) sensor thresholds and/or sensor lockouts.

In some embodiments, the software application presents one or more simulations depicted in an architectural model of a facility (e.g., using the digital twin). The simulation may comprise one or more thresholds. The one or more thresholds may be of an attribute, such as a sensed attribute (e.g., a temperature). For example, the simulation may present a sensed temperature at a location of the facility in a certain time, as depicted in a virtual image of the facility (e.g., of the digital twin of the facility). The simulation may be based at least in part on one or more parameters. The simulation may be based at least in part on one or more models (e.g., on a model used by the control system such as an Intelligence model). The one or more models may comprise one or more learning modules (e.g., using artificial intelligence). Examples of models, facility (e.g., building), control system, devices (e.g., tintable window) and network, can be found in U.S. patent application Ser. No. 17/250,586, filed Feb. 5, 2021, titled “CONTROL METHODS AND SYSTEMS USING EXTERNAL 3D MODELING AND NEURAL NETWORKS,” International Patent Application Serial No., which is a National Stage Entry of International Patent Application Serial No. PCT/US19/46524, filed Aug. 14, 2019, titled “CONTROL METHODS AND SYSTEMS USING EXTERNAL 3D MODELING AND NEURAL NETWORKS,” International Patent Application Serial No. PCT/US21/17603, filed Feb. 11, 2021, titled “PREDICTIVE MODELING FOR TINTABLE WINDOWS,” and U.S. Provisional Patent Applicational Ser. No. 63/106,058, filed Oct. 27, 2020, titled “TINTABLE WINDOW FAILURE PREDICTION,” each of which is incorporated herein by reference in its entirety. The software application may utilize a proprietary script. The proprietary scrip may extract data from an architectural model. The extracted data may comprise zone dimension(s) (e.g., fundamental length scales (FLS) such as width, length, and/or height), occupancy region dimension(s) (e.g., FLS), device (e.g., smart window) property(ies), critical viewing angles, or windowsill height, floor height. The smart window property(ies) may comprise window dimension(s) (e.g., FLS), or window material property(ies). The smart window may incorporate a tintable device (e.g., an electrochromic device). The window material properties may comprise tintable entities of the smart window, layer structure (e.g., of the tintable device), layer characteristics (e.g., of the tintable device), or electrical characteristics associated with the smart window. The data used for the simulation may be visualized in the digital twin (e.g., in the architectural design of the facility) and/or presented as a report (e.g., in a table), e.g., per user's preferences and/or as a default feature. The user may manipulate the digital twin presented in the UI of the app for preferred viewing by the user. For example, the user may rotate, resize, and move the virtual image of the facility presented in the UI, relative to the viewing area offered by the UI.

In some embodiment, the software application and/or digital twin simulation are utilized to find an optimal placement of one or more sensors. The simulation may be subject to analysis of total annual sun-hours that can help with reducing (i) contextual shade on sky-sensor and/or (ii) heat-gain from sun on façade (e.g., when one or more sensors (e.g., of a device ensemble) is mounted on an exterior window framing). The analysis may be coded in one or more scripts. The software application and/or digital twin simulation may be utilized to find an optimal location of a sensor that is external, or internal, to the facility. The optimal sensor location analysis may be performed as part of the software application, or as a separate module. For example, the one or more sensors may include a sensor external to the facility. The external sensor may be utilized to measure external influences on the facility. The external influences may include radiation (e.g., sun radiation), rain, snow, fog, clouds, hail, wind, or shadow. The external sensor may be a part of a sensor system. The sensor system may be an external sensor system (e.g., a sky sensor system). Examples for an external sensor system (e.g., sky sensor), facility (e.g., building), control system, devices (e.g., tintable window) and network, can be found in can be found in U.S. patent application Ser. No. 16/871,976, filed May 11, 2020, titled “MULTI-SENSOR HAVING A LIGHT DIFFUSING ELEMENT AROUND A PERIPHERY OF A RING OF PHOTOSENSORS,” U.S. patent application Ser. No. 16/696,887, filed Nov. 26, 2019, titled “MULTI-SENSOR DEVICE AND SYSTEM WITH A LIGHT DIFFUSING ELEMENT AROUND A PERIPHERY OF A RING OF PHOTOSENSORS AND AN INFRARED SENSOR,” and International Patent Application Serial No. PCT/US16/55709, filed Oct. 6, 2016, titled “MULTI-SENSOR,” each of which is incorporated herein by reference in its entirety. For example, the software application and/or digital twin simulation may be used to find an optimal position of the sky sensor on a roof or on an external wall of the facility, e.g., such that the sky sensor is minimally shadowed by external obstructions (e.g., a nearby structure or vegetation (e.g., building, other engineered structure, and/or tree). For example, the one or more sensors may include a sensor internal to the facility. The software may use mapping of an attribute (e.g., a sensed and/or simulated attribute) to select an optimal sensor location in the facility. The attribute may comprise a sensed property. The attribute may comprise temperature, sounds, humidity, gas level, gas velocity, gas pressure, particulate matter, volatile organic compounds, or light. The gas may comprise air, carbon dioxide, oxygen, carbon monoxide, hydrogen sulfide, one or more nitrogen oxide pollutants (NOx), radon, or humidity (water in its gaseous state).

In some embodiments, the software application may facilitate interaction of a user interacts with the device directly in the digital twin of the facility. The app may allow mapping of various sensor data into the digital twin of the facility. The sensor data may comprise forecasted sensor data, real time measurements of the facilities' sensors, or historical measurements. The sensor measurements may be presented as a function of time. The time may be divided into frequencies that are at least the measurement frequency of the sensor(s). A user may select time lapse that is larger than the measurement frequency of the sensor(s) (e.g., from a dropdown menu, as a sliding bar, and/or from a side list).

In some embodiments, the facility simulation and/or digital twin considers customer data. In some embodiments, the facility simulation and/or digital twin incorporates customer data. The customer data may be customer feedback. The customer data may comprise customer sentiments. The customer data may be input (i) directly to the digital twin (e.g., using the app), and/or (ii) by a customer care representative. The customer care representative may be a representative of (a) the company creating and/or maintaining the app, (b) the company commissioning and/or maintaining the network of the facility, (c) the company commissioning and/or maintaining the assets (e.g., devices) of the facility, or (d) any combination thereof. In some embodiments, the customer input may be visualized by the app. For example, the customer input may be visualized as part of a virtual representation of the facility presented in the UI. For example, the customer input may be visualized as data (e.g., as written data such as in a table). The customer input may comprise overriding a proposed target decision made by the control system (e.g., using the control system module(s)). For example, the customer input may comprise window tint value that overrides a proposed target tint value by the control system (e.g., using the control system module(s)). The customer overrides may be analyzed and/or acted upon. The analysis may be utilized by the control system (e.g., by Intelligence). The input may be an info-graphic that is tied to specific asset(s). The asset(s) may be presented, or tied to, the digital twin of the facility. The info-graphic may comprise, for example, customer overrides, customer service (e.g., salesforce) ticket(s) #, tintable window failure, and the like. The app and/or digital twin may facilitate visualization of issues, e.g., by tying comment(s) to a model object (e.g., a facility asset). The comment may be by any user of the app and/or customer. The user may comprise a commissioning service member, maintenance service member, customer service member, or customer.

In some embodiments, the software application comprises a facility visualizer. The facility visualizer may comprise a digital twin visualizer. The application may show customer sentiments, and/or status of various facility components to a user such as to the customer. The app may facilitate setting one or more zones (e.g., and their hierarchy) in an intuitive and/or visible manner. The app may allow the user to alter zones, and/or occupancy regions in an intuitive manner (e.g., while visualizing the changes in a digital twin of the facility, and their effect of various aspects related to the facility such as environmental aspects). The app can automatically generate zone(s) (including their hierarchy), and/or occupancy regions, e.g., based at least in part on penetration depth of sun angles. The automatic generation may be a default of the app. The app may facilitate viewing any bounding furniture, furniture, occupancy regions, occupancy, zones, sun rays (or any other attribute) in the digital twin (e.g., in a visual manner). Alteration in the attribute may be simulated and/or represented as a function of time, and rendered into a time dependent virtual representation in the UI of the app. The user may select the time frequency of rendering, or the time frequency may be provided as a default time lapse. The user may save the time varied rendering as a movie.

In some embodiments, the software application may facilitate adjustment of control modules (e.g., software package) that control the facility (e.g., one or more devices in the facility). For example, the app may facility adjustment of control system (e.g., using Intelligence) parameters on the digital twin, e.g., in a local or in a web application. The changes to the control module(s) may be committed to the field (e.g., used by the control system of the facility). These changes may be manually and/or automatically summarized, e.g., in report(s). The report(s) may be periodic reports such as a weekly report. The report(s) may be non-periodic (e.g., on demand, and/or when an alternation has been made in the control module). The report(s) may be generated by the app, e.g., on selection by a user. The app may have a default preference to automatically generate the report. A user may be able to alter the default preference of the app. The report may be sent to select team members and/or customers. A user may list the team member(s) and/or customers. In some embodiments, the app may allow viewing the digital twin and/or simulation(s) prior to commissioning (e.g., onboarding) various aspects of the facility. The app may allow proofing various aspects of the facility at least in part by viewing and/or inspecting the digital twin through the app, e.g., using the various simulation capabilities it offers. Examples of control modules can be found in International Patent Application Serial Nos. PCT/US14/16974, filed Feb. 18, 2014, titled “CONTROL METHOD FOR TINTABLE WINDOWS,” PCT/US15/29675, filed May 7, 2015, titled “CONTROL METHOD FOR TINTABLE WINDOWS,” PCT/US17/66198, filed Dec. 13, 2017, titled “CONTROL METHOD FOR TINTABLE WINDOWS,” PCT/US21/17603, and PCT/US19/46524, in U.S. patent application Ser. No. 17/250,586, and in U.S. Provisional Patent Application Ser. No. 63/106,058, each of which is incorporated herein by reference in its entirety.

In some instances, a Customer Success Manager (CSM) does not have a tool (e.g., an automatic tool) incorporating various devices in the facility they are addressing. Building Information Management Models (e.g., BIM such as Autodesk Revit file) may be static and incorporate architectural elements of a facility, but not devices installed in the facility, let alone updated status of such devices. At time the architectural model offers two dimensional (2D) representation of the facility, rather than three dimensional (3D) representation.

In some embodiments, a digital twin of the facility integrates an (e.g., 3D) architectural image of the facility with devices installed therein, which corresponds to real location of the devices installed in the facility. In some embodiments, such digital twin may facilitate management of the facility at various levels, e.g., through usage of an app (e.g., as disclosed herein). The status of the devices may be updated to reflect real time, or substantially real time, status of the devices. The digital twin may aid in deployment and/or maintenance of the facility (e.g., including deployment and/or maintenance of devices of the facility). The digital twin may serve as a tool for customers and/or customer managers (e.g., CSM), e.g., when interacting with customers or potential customers. Customers may be owners or tenants of the facility (or any portion thereof). The digital twin may be a supplemented initial BIM file (e.g., fortified with device information), or utilize and/or incorporate the BIM file.

In some embodiments, the facility (e.g., including a building) is controlled by a control system (e.g., as disclosed herein). the control system controls the various devices disposed in the facility. For example, tintable windows are controlled by the control system. The control system may utilized a control module that calculates and predicts a preferred tint value for tinting the tintable windows. The control module (e.g., that may be referred to herein as “Intelligence”) may consider the time of year, season, (e.g., winter or summer), geographical location of the facility (e.g., and/or tintable window), topology in the vicinity of the facility, obstructions in the vicinity of the facility, structural features of the facility, weather, and sun location, to control the devices (e.g., the tintable windows) of the facility. The weather may be derived from sensors of the facility, from sensors without relation to the facility, and/or from a third party (e.g., weather forecasting service). In some embodiments, at least a portion of the weather data may be located in the facility, or outside of the facility (e.g., at a different location and/or in the cloud).

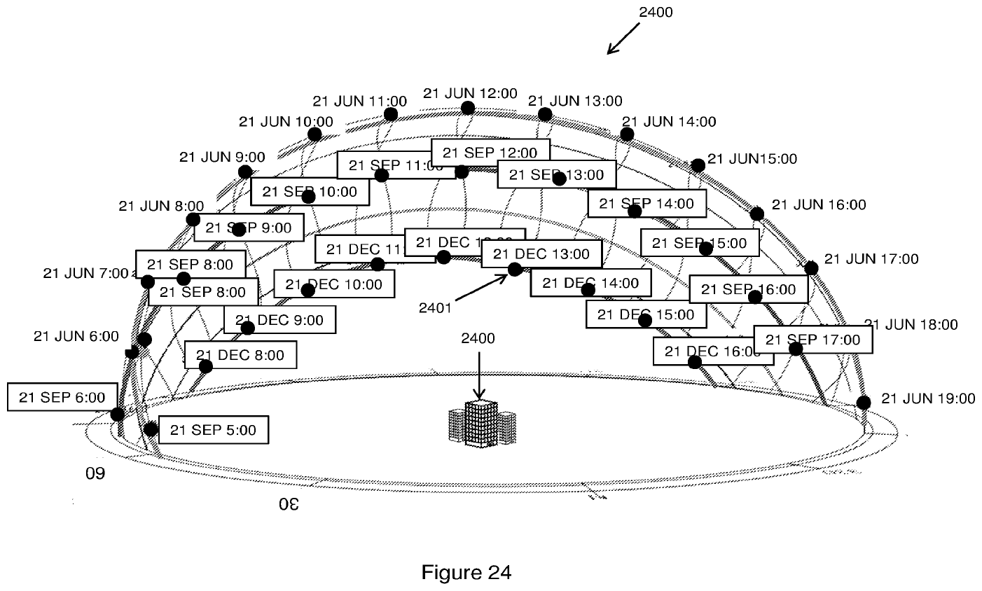

FIG. 24 shows an example of sun locations as a function of time and date, relative to a facility 2400. For example, 2403 shows sun locations during the summer (e.g., summer solstice in the year 2020), and 2401 shows sun locations in the winter (e.g., winter solstice in the year 2020). 2402 shows degrees of rotation in a unit circle and the associated Cardinal directions (e.g., Cardinal points) North, South, West, and East. Such graphics may show extreme positions of the sun, that may assist in evaluating various aspects of the facility with respect to sun radiation.

In some embodiments, the control software module considers geographical location of the facility (e.g., and/or tintable window), topology in the vicinity of the facility, obstructions in the vicinity of the facility, structural features of the facility. The topology in the vicinity of the facility may include considering a topological map of the facility's vicinity, such as comprising a mountain, valley, hill, embankment, elevation, depression, or slope. The embankment, elevation, depression, or slope may be away from the window, or towards the window (which control software module may consider). The obstructions in the vicinity of the facility (e.g., that potentially affect light (e.g., sun radiation) from reaching the facility) may comprise adjacent man-made structures, or vegetation (e.g., trees and/or large bushes). The manmade structures may comprise a building, a statue, a monument, a fountain, a civil engineering structure, or a structural engineering structure. The civil engineered structure may comprise a bridge, a pipeline, a pillar, a tunnel, a traffic light, a dam, power station (or component thereof), power accessory, railway, or a road. The control module may consider a municipal map to which the facility belongs. The control module may consider any reflective surfaces comprising metallic surfaces (e.g., metal clads and/or metal statues), or water bodies (e.g., ocean, seal, lake, pool, fountain, river and/or stream). The control module (e.g., software module used by the control system) may consider reflective, dispersive and/or absorptive surfaces (i) of the facility and/or (ii) objects adjacent to the facility. The objects may comprise vegetations, natural inanimate objects, and man-made objects. The structural features of the facility may comprise external structural features (e.g., that may affect radiation from entering the facility). The external structural features may comprise a fin, a column, an overhang, a curved external wall portion, a straight external wall portion, a protrusion, or an embossing.

In some embodiments, the software application may facilitate annotating the digital twin of the facility by a user. The annotation may be visible in the UI, e.g., (i) in the virtual representation of the facility (e.g., in the digital twin) and/or (ii) as a separate block from the virtual representation of the facility. The user may be able to select whether the annotation is presented as options (i), (ii), or both (i) and (ii) above. Certain annotation(s) may be considered by the control system (e.g., through the control system software package such as Intelligence). Certain annotations may be solicited from the user by the app.

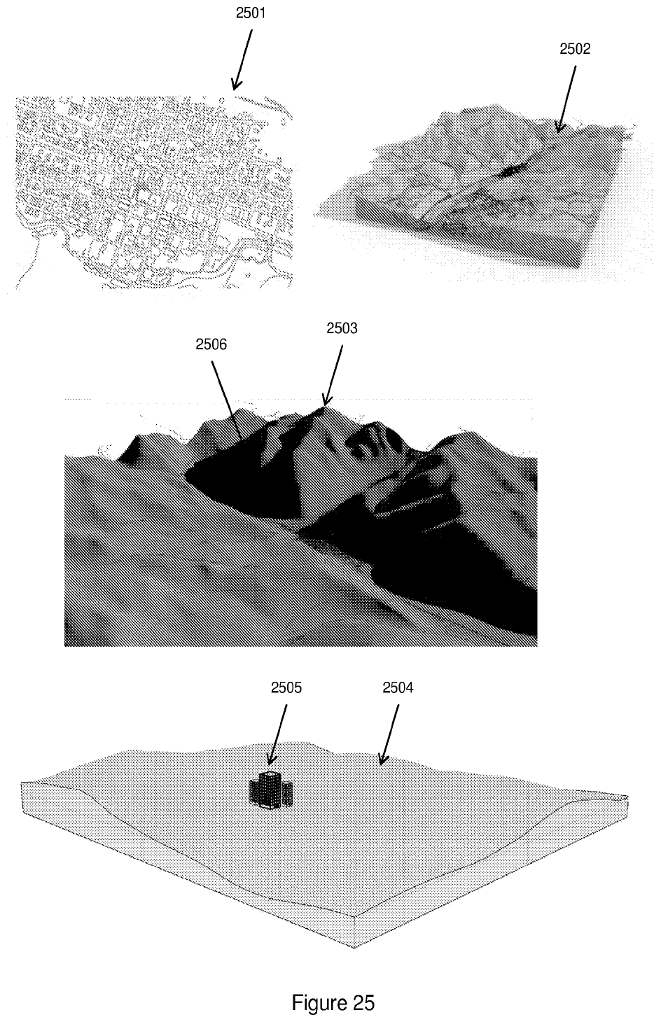

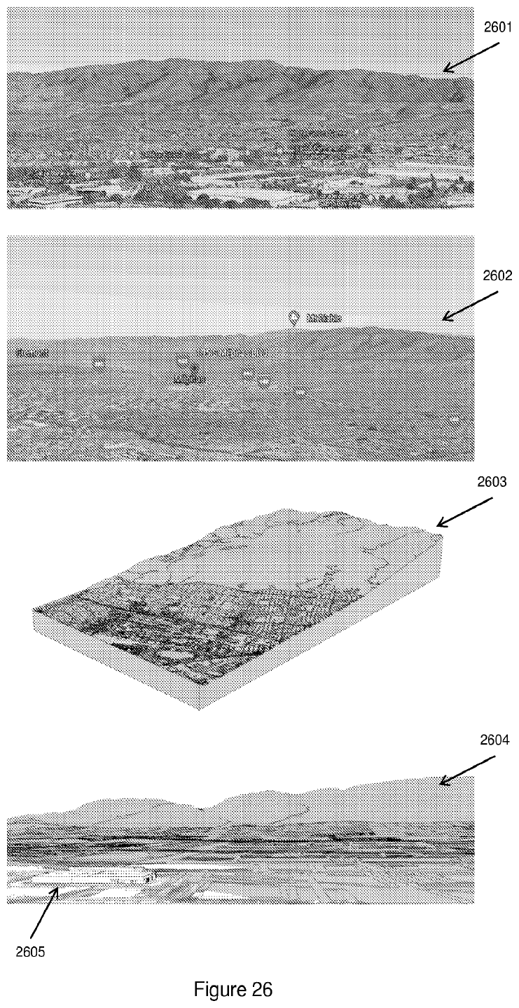

FIG. 25 shows an example of a municipal map 2501; a topographical map 2503 showing various shaded mountains and valleys that may affect a facility disposed at 2506 in a valley adjacent to the shaded mountains; a topological map 2502 in which roads are depicted, and a digitized topological map 2504 of a facility's vicinity, in which the facility 2505 is deposed. FIG. 26 shows an example of an annotated aerial view 2601 of a facility's vicinity, an annotated aerial view 2602 indicated roads in the vicinity of the facility, a municipal planning 2603 superimposed on a topographical map, which facility belongs to the municipality; and a digitized topological mapping 2604 of a vicinity of the facility 2605, the facility 2605, and municipal planning in its vicinity. Any and all of the map types depicted in FIGS. 25-26 may be considered (e.g., taken into account) by the control system (e.g., using the predictive module such as Intelligence) to control the facility (e.g., tint various tintable windows of the facility).

In some embodiments, a user may provide input to a software application, that may influence the control system. For example, the user may provide input that will override decisions of the control system, or guide the control system in its decision making process. The software application may permit or restrict the user for using it, or making certain changes. Various users may have various permission levels. The permission levels may be guided by a hierarchy.

In some embodiment, a user provides input to the software application and/or to the control system (e.g., using the control system software module). The app may be operatively coupled to the control system, on included as part of the control system. The level of access, control and type of user interface the user is presented by the app, may depend on permission granted to the user. The permission may be granted by the app, by the control system, and/or by the network. The permission may depend on occupant-role (e.g., building operations manager vs. employee, full-time employee vs. shared workspace user) and/or type of facility enclosure (e.g., shared conference room vs. solo office). The permissions may have a hierarchical structure. The permission (e.g., permission hierarchy) may be based at least in part on: (i) employment level hierarchy, (ii) voting plurality, may include thresholds and voting rights, (iii) system user hierarchy (e.g., a system administrator may have a higher hierarchy that users), (iv) geographic location of employees (e.g., at time of request—a remote employee may not be allowed to dictate environments of non-remote occupants), (v) geographic location of the facility, (vi) ownership of the facility (or portion thereof), (vii) security level (e.g., network security level assigned to different users), and/or (viii) energy, health, safety and/or jurisdictional considerations. The app and/or control system module may comprise logic. The logic may determine whether to inhibit or allow a direct override based on the user permission scheme. The logic of the app may determine which user interfaces a user is presented with, e.g., based at least in part on the permission scheme. Data from input provided by the user may be collected and/or utilized in this or in another forecast, even when the when the user does not have permission to make an actionable decision.

In some embodiments, the various devices (e.g., IGUs) are grouped into zones of targets (e.g., of EC windows). At least one zone (e.g., each of which zones) can include a subset of devices. For example, at least one (e.g., each) zone of devices may be controlled by one or more respective floor controllers and one or more respective local controllers (e.g., window controllers) controlled by these floor controllers. In some examples, at least one (e.g., each) zone can be controlled by a single floor controller and two or more local controllers controlled by the single floor controller. For example, a zone can represent a logical grouping of the devices. Each zone may correspond to a set of devices (e.g., of the same type) in a specific location or area of the facility that are driven together based at least in part on their location. For example, a facility (e.g., building) may have four faces or sides (a North face, a South face, an East Face, and a West Face) and ten floors. In such a didactic example, each zone may correspond to the set of smart windows (e.g., tintable windows) on a particular floor and on a particular one of the four faces. At least one (e.g., each) zone may correspond to a set of devices that share one or more physical characteristics (for example, device parameters such as size or age). In some embodiments, a zone of devices is grouped based at least in part on one or more non-physical characteristics such as, for example, a security designation or a business hierarchy (for example, IGUs bounding managers' offices can be grouped in one or more zones while IGUs bounding non-managers' offices can be grouped in one or more different zones).

In some embodiments, at least one (e.g., each) floor controller is able to address all of the devices in at least one (e.g., each) of one or more respective zones. For example, the master controller can issue a primary tint command to the floor controller that controls a target zone. The primary tint command can include an (e.g., abstract) identification of the target zone (hereinafter also referred to as a “zone ID”). For example, the zone ID can be a first protocol ID such as that just described in the example above. In such cases, the floor controller receives the primary tint command including the tint value and the zone ID and maps the zone ID to the second protocol IDs associated with the local controllers within the zone. In some embodiments, the zone ID is a higher level abstraction than the first protocol IDs. In such cases, the floor controller can first map the zone ID to one or more first protocol IDs, and subsequently map the first protocol IDs to the second protocol IDs.

In some embodiments, the master controller is coupled to one or more outward-facing networks via one or more wired and/or wireless links. For example, the master controller can communicate acquired status information or sensor data to remote computers, mobile devices, servers, databases in or accessible by the outward-facing network. In some embodiments, various applications, including third party applications or cloud-based applications, executing within such remote devices are able to access data from or provide data to the MC. In some embodiments, authorized users or applications communicate requests to modify the tint states of various tintable windows to the master controller via the network. For example, the master controller can first determine whether to grant the request (for example, based at least in part on power considerations or based at least in part on whether the user has the appropriate authorization) prior to issuing a tint command. The master controller may then calculate, determine, select, or otherwise generate a tint value and transmit the tint value in a primary tint command to cause the tint state transitions in the associated tintable windows.

In some embodiments, a user submits such a request from a computing device, such as a desktop computer, laptop computer, tablet computer or mobile device (for example, a smartphone). The user's computing device may execute a client-side application that is capable of communicating with the master controller (e.g., through the app), and in some examples, with a master controller application executing within the master controller. In some embodiments, the client-side application may communicate with a separate application, in the same or a different physical device or system as the master controller, which then communicates with the master controller application to affect the desired tint state modifications. For example, the master controller application or other separate application can be used to authenticate the user to authorize requests submitted by the user. The user may select a target to be manipulated (e.g., the IGUs to be tinted), and directly or indirectly inform the master controller of the selections, e.g., by entering an enclosure ID (e.g., room number) via the client-side application. There may be a hierarchy of overriding permissions to use the app and/or alter the digital twin. The hierarchy may depended on the type of user. For example, a factory employee user may not be allowed to alter device network IDs. For example, an employee may be allowed to alter the tint state of a window adjacent to their workstation, but not of other tintable windows of the facility. For example, a visitor may be prevented from having the visitor's mobile circuitry connected to the network, app, or make any changes to the digital twin. The coupling to the network may be automatic and seamless (e.g., after the initial preference have been set). Seamless coupling may be without requiring input from the user. The permission hierarchy may be based at least in part on (i) selected privileges, (ii) employment hierarchy and/or status, (iii) designated location within the facility, (iv) permission to enter various layers of the facility network, and/or (v) any combination thereof.

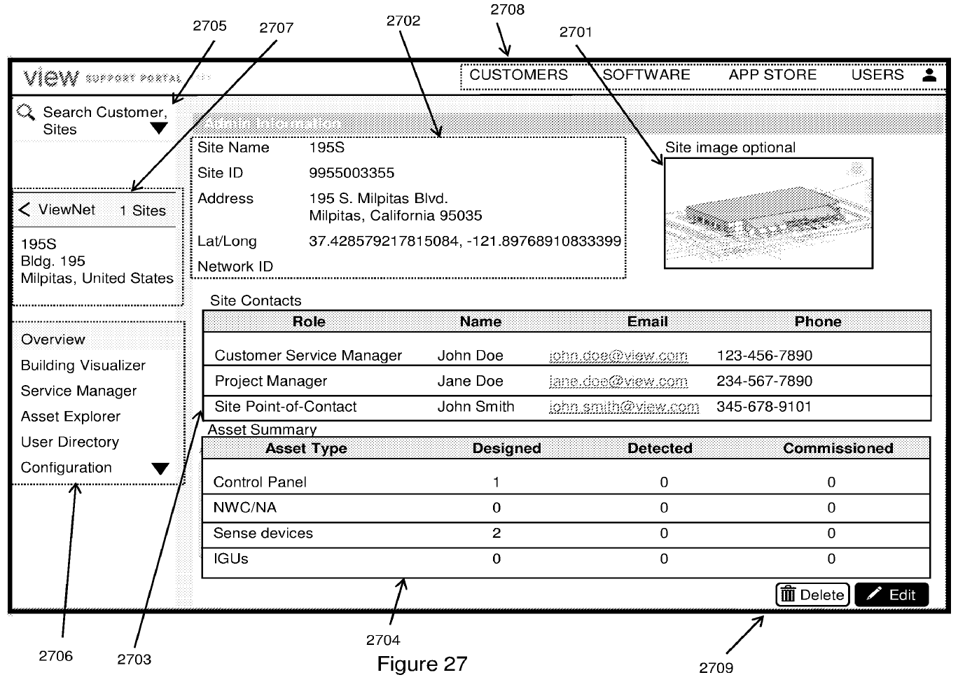

FIG. 27 shows an example of a user interface screen of a software application (app) that includes a customer support portal. The user interface (UI) may allow to search other customer sites in block 2705, e.g., as a free search and/or from a dropdown menu indicated by a downward arrow. The UI may include options in block 2708 to select customers, software, app store, users, and indicate current user. When an icon of the current user is clicked, a dropdown menu may appear allowing the user to log out of the app. The UI may include an identification of a local network (e.g., ViewNet) such as by its local address. The UI may include in block 2706 an overview of modules offered by the app, such as a Building Visualizer, a Service Manager, an Asset Explorer (e.g., device explorer), a User Dictionary, and Configuration screen. Additional overview, and/or detailed selection of the modules, may be available in a dropdown menu activated by pressing on a downward arrow in block 2706. The user interface screen includes a visual model of the facility 2701 (e.g., site image) which may be optional. In block 2702, the user interface indicates the site name, identification, address, and geographic coordinates. In block 2703, contacts of the facility (e.g., site) may be available, such as customer service manager, project manager, and site point of contact. In block 2704, a summary of the assets (e.g., devices) may be indicated such as any control panels, Network Window Controllers and/or Network Adaptors (abbreviated as NWC/NA), sensors, emitters, or device ensembles (e.g., sense devices), and windows (e.g., tintable windows and/or IGUs). The app may allow the user to delete the entry of the facility by pressing the 2709 Delete field, or edit the entry of the facility by pressing the 2709 Edit field. Any of the field in blocks 2707, 2706, 2703, 2704, 2701 may be interactive and, when selected by the user, may offer additional information and/or direct the app to other user interfaces displayed to the user upon their selection.

In some embodiments, the facility may be divided into one or more zones. The zones may be defined at least in part by a customer, or by the facility manager. The zones may be at least in part automatically defined. For example, the zone of devices (e.g., comprising tintable windows, sensors, or emitters) may associate with (i) a façade of a building they are facing, (ii) a floor they are disposed in, (iii) a building in the facility they are disposed in, (iv) a functionality of the enclosure they are disposed in (e.g., a conference room, a gym, an office, or a cafeteria), (iv) prescribed and/or in fact occupation (e.g., organizational function) to the enclosure they are disposed in, (v) prescribed and/or in fact activity in the enclosure they are disposed in, (vi) tenant, owner, and/or manager of the enclosure of the facility (e.g., for a facility having various tenants, owners, and/or managers), and/or (vii) their geographic location. The zones may be alterable (e.g., using the software app), e.g., visually. The status of the zone (e.g., in conjunction to the status of the devices therein), may be displayed by the app (e.g., updated in real-time, or substantially in real time). One or more zones may be grouped. For example, all zones in a certain floor may be groped. There may be a zone hierarchy using any of the zone associations (i) to (vii).

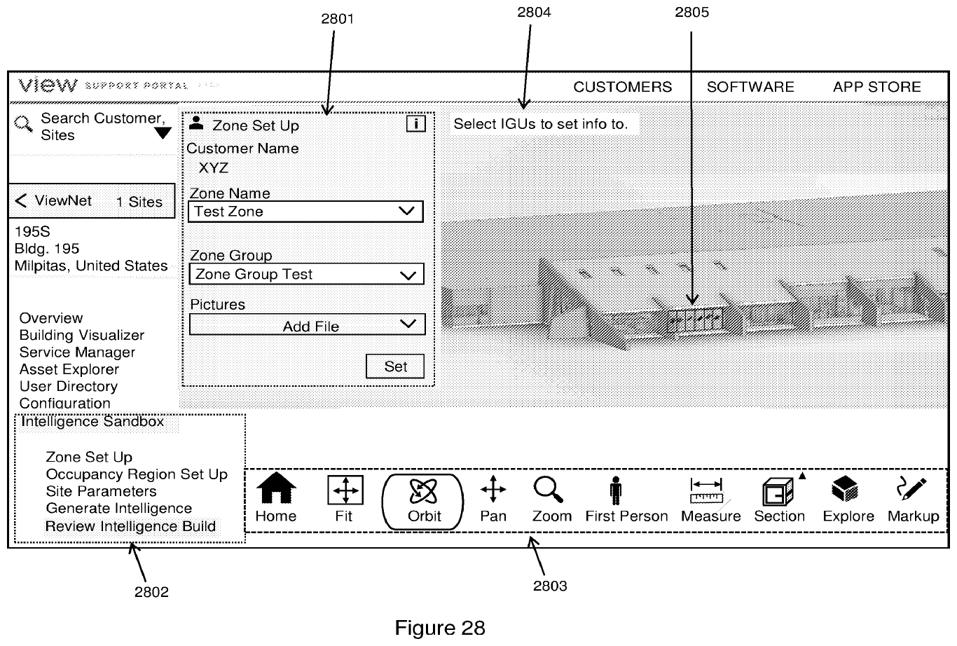

FIG. 28 shows an example of a user interface screen of a software application (app) that includes a customer support portal. In addition to sections similar to those described in the example of FIG. 27 (e.g., 2708, 2707, 2805, and 2706), the UI screen shown in the example of FIG. 28 depicts options titled “intelligence Sandbox” in block 2802 that include setting up and/or revising zone(s), occupancy region(s), site parameters, generate Intelligence, and review Intelligence building. In some embodiments, “Intelligence” refers to a control module that controls the building (e.g., various devices disposed in the building). The word “Intelligence” may be replaced with any other name of a similar control module. FIG. 28 shows an example in which the Zone Set Up option in block 2802 is selected. An option for a user to select one or more zones in block 2801, as indicated by “Zone Set Up” writing. The customer's name is indicated as XYZ in this fictious example. The zone may have a name (here, “Test Zone”), that may be selected from a dropdown menu visible on selection of the respective down arrow to the right of “Test Zone” writing. The zone group (when available) is indicated (here as “Zone Group Test”) that may be selected from a dropdown menu visible on selection of the respective down arrow to the right of “Zone Group Test” writing. The user is provided an option to add any pictures to the file in Pictures field, which uploaded picture files (e.g., file names) may be viewed in a drop down menu activated by selecting a downward menu next to the wording “Add File.” Once the selection is set, the user is provided with the option to save the selection by selecting the “Set” field in block 2801. The zone configured is indicated in the figure of the facility in bold 2805 (e.g., windows 2805 included in the zone that is set up in 2801 named Test Zone). The user is provided a toolbox in block 2803 including an option to return to a home screen (by selecting Home), fit to window (by selecting Fit), reorient the facility in 3D space (by selecting Orbit), move up down and/or to the sides (by selecting Pan), zoom the virtual depiction of the facility in or out (by selecting Zoom), measure various distances in the facility (by selecting Measure), selecting a section of the facility (by selecting Section), markup (e.g., annotate) the virtual depiction of the facility (by selecting Markup), and exploring other added feature (by selecting Explore).

In some embodiments, the control system considers occupancy region(s) of the facility. Occupants in the occupancy regions may be affected by sunlight and/or glare, depending on the positioning of the occupancy region relative to window(s) of the facility, and their tint state.

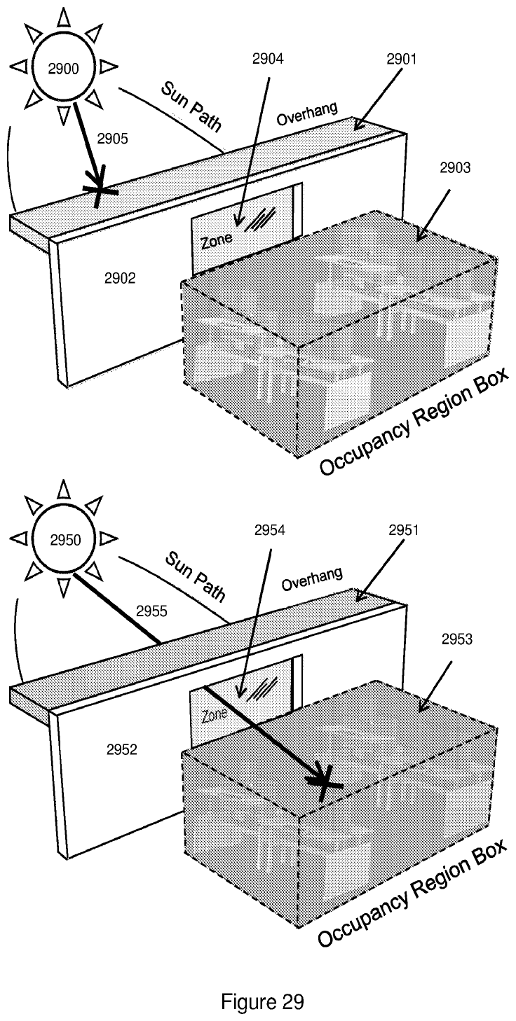

FIG. 29 shows an example of a facility wall 2902 having a windows 2904 that belongs to a zone. Sun 2900 shines a ray 2905 that is prevented to reach the occupancy region 2903 in the facility due to an overhang 2901. A position of the sun 2900 can be predicted from its sun path. FIG. 29 shows an example of a facility wall 2952 having a windows 2954 that belongs to a zone. Sun 2950 shines a ray 2955 that reaches the occupancy region 2953 in the facility through window 2954, which sun ray 2955 is not obstructed from overhang 2951. A position of the sun 2950 can be predicted from its sun path. Occupancy regions 2903 are boxes, each encompassing a designated furniture (e.g., of an office setting), and each does not extend to the full height of their adjacent walls (e.g., 2902 and 2952).

In some embodiments, estimation of the level of irradiation and/or glare of radiation (e.g., sun rays) entering the occupancy region considers one or more angles. The angle may be between a person located at an edge of an occupancy region, and the full extent of a window adjacent to the occupancy region. The angle may be a two dimensional angle considered an average occupant height. The glare region may be a three dimensional structure tipping at the person, and extending to the full opening (e.g., up to the framing) of the window. For example, the glare region may be a three dimensional pyramidal structure tipping at the person, and extending to the full opening of the (e.g., rectangular framed) window. The angle may be between a person located at a designated location of the user in an occupancy region, and the full extent of a window adjacent to the occupancy region. Examples of tintable windows, control system (and modules therein), devices, facility (e.g., building) network, occupancy regions, and methodologies used to determine and/or forecast tint levels for tintable windows, e.g., utilized by a control system, can be found in International Patent Application Serial Nos. PCT/US14/16974, PCT/US15/29675, and PCT/US17/66198, each of which is incorporated herein by reference in its entirety. In some embodiments, the control system utilizes at least 2, 3, 4, 5, or 6 separate modules. At least one of the modules contributes to at least about 50%, 60%, 70%, 80%, or 90% of the requested setting value, and the other the control system modules (e.g., software modules) contribute to the rest of the requested setting value (e.g., target tint level of the tintable window).

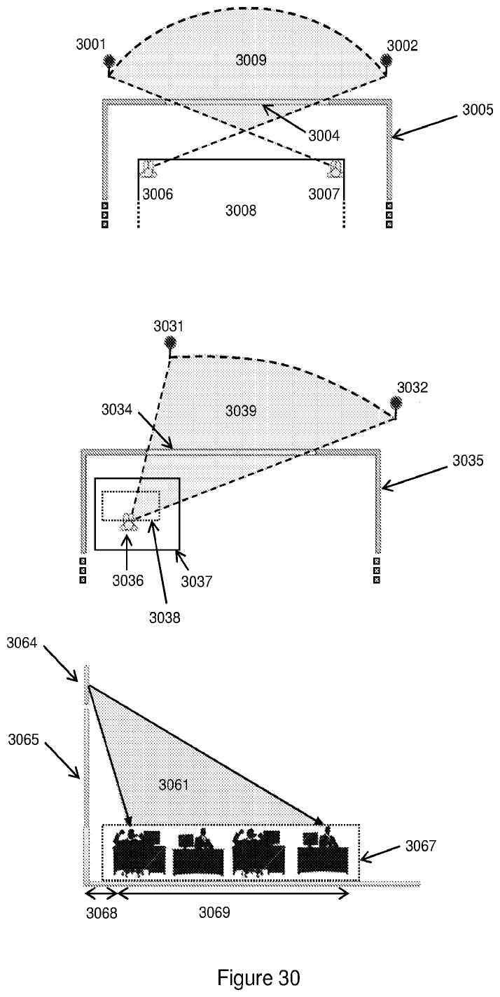

FIG. 30 shows one example of estimating the field of view. A portion of an enclosure 3005 having a window 3004 (that may belong to a zone) includes a portion of an occupancy region 3008. At the edges of occupancy region 3008 two occupants 3006 and 3007 are simulated. The field of view 3009 of the occupancy region is estimated using the critical viewing angles of occupants at the edges of the occupancy region. Each occupant 3006 and 3007 has a critical viewing angle through window 3004. Occupant 3007 has critical viewing angle 3001, and occupant 3006 has critical viewing angle 3002. Field of view 3009 is estimated (e.g., calculated) using the critical angles.

FIG. 30 shows another example of estimating the field of view. A portion of an enclosure 3035 having a window 3034 (that may belong to a zone) includes a portion of an occupancy region 3037. At a designated location of occupancy region 3037 an occupant 3036 is simulated seated next to a desk 3038 disposed at its designated location in enclosure 3035. The field of view 3039 of the occupancy region is estimated using the critical viewing angles of the occupant at two critical angles as the occupant is disposed in the designated position and is viewing an exterior of the window 3034 through its horizontal edges. Occupant 3036 views outside of window 3034 at a first critical viewing angle 3031 that is the leftmost lateral viewing (e.g., gazing) angle, and Occupant 3036 views outside of window 3034 at a first critical viewing angle 3032 that is the rightmost lateral viewing (e.g., gazing) angle. Field of view 3009 is estimated (e.g., calculated) using the critical angles.

FIG. 30 shows an example of radiation entering an enclosure portion. A portion of an enclosure 3065 having a window 3064 (that may belong to a zone) includes a portion of an occupancy region 3067 in which occupants are seated, each seated next to a desk (e.g., in a workplace). Irradiation is shing through window 3064 into the enclosure portion, and irradiate the occupants in occupancy region 3067 impinging on the occupancy region at a length 3069 of an irradiation zone 3061. When glare is detected and/or estimated by the irradiating rays in irradiation zone 3061, window 3064 will be tinted to a darker tint (e.g., tint level 4), as compared to a situation when glare is not detected and/or estimated (e.g., tint level 1). When the external radiation source is from a sun, the region susceptible to glare starts at a distance 3068 from the external wall that the radiation rays do not directly occupy as they shine through window 3064.

In some embodiments, the tintable windows are tinted to various tint level. For example, there may be at least 2, 3, or 4 tint levels. Tint level 1 may be the lighter most tint level (e.g., no tint, or a maximally transparent window). The higher the tint level number, the darker the tinting may be. For example, when the control level tints to four different tint levels, tint level 4 may be the darkest tint. For example, there may be at least 2, 3, 4, 5, 6, 7, 8, 9, or 10 tint levels. For example, there may be an infinite number (e.g., continuum) of tint level between the lightest tint (e.g., no tint) and the darkest tint level. For example, there may be a discretized number of tint levels.

In some embodiments, a user of a software application (app) may alter and/or determine occupancy region(s), e.g., that are utilized in controlling device(s) of the facility (e.g., control tint levels of tintable windows). For example, the user may determine and/or alter one or more volume parameters of an existing occupancy ration. For example, the user may determine and/or alter placement of the occupancy region in the facility. For example, the user may determine and/or alter existence of the occupancy region in the facility (e.g., the user may delete or create an occupancy region). The occupancy region may be altered individually. Occupant regions in a zone may be altered collectively. For example, all occupant region in a zone may be altered to have a certain height. For example, all occupant region in a floor, in a building and/or in a facility may be altered to have a certain height. The occupancy region may be determined using length, width, and height of a boxed region. The occupancy region can be represented as the length, width, and height (or any other representation of a physical volume) of the space that the occupant will be residing in. In some embodiments, the penetration depth of radiation into the building comprises an offset of occupancy region from the window zone. A user may input a length amount of offset away from the window into the building (e.g., in a measurement scale such as feet and inches, or meters and centimeters.

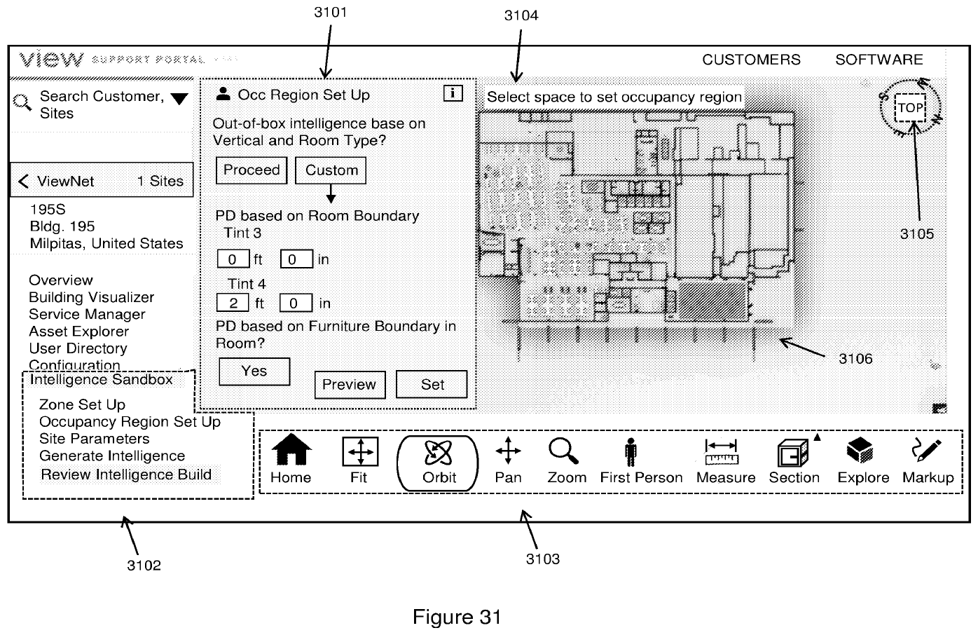

FIG. 31 shows an example of a user interface screen of a software application (app) that includes a customer support portal. In addition to sections similar to those described in the example of FIG. 27 (e.g., 2708, 2707, 3105, and 2706), the UI screen shown in the example of FIG. 31 depicts options titled “intelligence Sandbox” in block 3102 that include setting up and/or revising zone(s), occupancy region(s), site parameters, generate Intelligence, and review Intelligence building. In some embodiments, “Intelligence” refers to a control module that controls the building (e.g., various devices disposed in the building). The word “Intelligence” may be replaced with any other name of a similar control module. FIG. 31 shows an example in which the Occupancy Region Set Up option in block 3102 is selected. The facility is depicted as in 3106, which facility includes occupancy scheme and fixtures of the facility (shown as a horizontal cross section). An option for a user to set up the Occupancy Region in block 3101, as indicated by “Occ Region Set Up” writing. The app provides a default setting of occupancy region. By selecting the option Proceed in block 3101, the user accepts the default setting. The user has the option to customize the occupancy region by selecting the option of Custom in block 3101. The occupancy region may be selected for various tint level of the tintable windows (as indicated in block 3101 as Tint 3 (lighter tint) and Tint 4 (darker tint). The user may indicate the height of the occupancy region in the various tint levels (e.g., in feet and inches). The user may enter penetration depth related values into the respective fields in block 3101, the penetration depth based on room boundary (PD based on Room Boundary). The Penetration Depth may comprise an offset of occupancy region from the window zone. The user is prompted in block 3101 to enter the length amount of offset away from the window in feet (ft) and inches (in). The user may indicate if the furniture boundary takes a role in defining the occupancy region by selecting Yes to the prompted question. The user may previous the occupancy region by selection the option Previous. The user may save the defined occupancy region by selecting the option Set in block 3101. The user may be reminded to select the space to set the occupancy region as indicated by words in region 3104. The user may view the geographic Cardinal directions North, East, South, and West and placement of the facility by an indicator (e.g., front, top bottom, back and sides (e.g., left and right) indicated schematically as a cube) 3105 showing the top, placed on a unit circle depicting the associated Cardinal directions (e.g., Cardinal points) North, South, West, and East. Such graphics may show extreme positions of the sun, that may assist in evaluating various aspects of the facility with respect to sun radiation. The user is provided a toolbox in block 3103 including an option to return to a home screen (by selecting Home), fit to window (by selecting Fit), reorient the facility in 3D space (by selecting Orbit), move up down and/or to the sides (by selecting Pan), zoom the virtual depiction of the facility in or out (by selecting Zoom), measure various distances in the facility (by selecting Measure), selecting a section of the facility (by selecting Section), markup (e.g., annotate) the virtual depiction of the facility (by selecting Markup), and exploring other added feature (by selecting Explore).

In some embodiments, once the user completes adjustment of various parameters using the software application, the parameters are updated in the digital twin of the facility. Such process can be referred to as “pollination.” The app may add any (e.g., critical) missing features to the digital twin (e.g., using default settings). The critical features may be those that if not added, will generate errors, and prevent rendering of the simulation. The simulation and/or app or a portion thereof may run locally in the facility, or in a remote setting (e.g., on the cloud). In some embodiments, the app may utilize an open model platform. The simulation and/or app may be operatively coupled to the control system of the facility. The app and/or simulation may facilitate testing the design of the facility and components therein (e.g., assets such as devices), test such facility design (e.g., at least in part by running simulation on the digital twin) prior to deployment. The app may facilitate viewing various layers of the facility, while omitting other layers. For example, the app may facilitate viewing device ensemble connectivity to the network, without interior walls. For example, the app may facilitate viewing only temperature sensors, without any other sensors. For example, the app may facilitate viewing tintable windows without interior furniture. For example, the app may facilitate viewing the facility including its assets, without simulating light effects. The app may facilitate searching for an asset type (e.g., by name), or for a particular asset (e.g., having an ID). The App may offer the ability to easily search for any asset and/or quickly identify the physical location of it within a reasonable time (e.g., within at most 0.6 minutes (min.), 0.3 min, 0.25 minutes (min), 0.5 min., 1 min, 2 min, or 5 min. The easy search may comprise typing the asset name, nickname, or serial number in a search block. The app may facilitate viewing all assets of that type in the digital twin (e.g., as represented in the UI). The user may intuitively select a particular device in the digital twin, and inspect its status and/or related information (e.g., network ID and/or its manufacture's information). The status may be presented as an annotation in the digital twin, as an optional collapsible (e.g., dropdown) menu, and/or as a sidebar. When the device is altered, and/or gathers data (e.g., in real time), such status may also be presented. For example, when the user selects a sensor, data of the sensor may be shown (e.g., collected in a time window (which the user may select), and/or in real time (e.g., as it is collected). The app may receive real time data and update its database accordingly (e.g., in real time), which data may be used for the simulation(s). The App may be configured to show a Sun motion path (e.g., historic, in real time and/or prospective). The App may be configured to show planned versus actual tint state of one or more tintable windows of a facility (e.g., building), e.g., at different times. The different times include historic, real time and/or prospective times (e.g., and dates). The app may facilitate adding, or incorporating, map within the Digital Twin, e.g., to show the context of user's location. The map may be smaller as compared to the entire facility. The map may include the entire facility or a portion of the facility (e.g., a map of a portion of the facility that is relevant to the user such as a map of the facility in which the asset of interest is disposed). The app may facilitating altering a scope of the map (e.g., using a zooming in/out icon). The app may facilitate enlarging the scope of the facility portion displayed by the map, or reduce the scope of the facility portion displayed by the map. The size of the displayed map may or may not remain the same on the graphic interphase screen. The App may facilitate reducing and/or enlarging the size of the map displayed on its user interface.

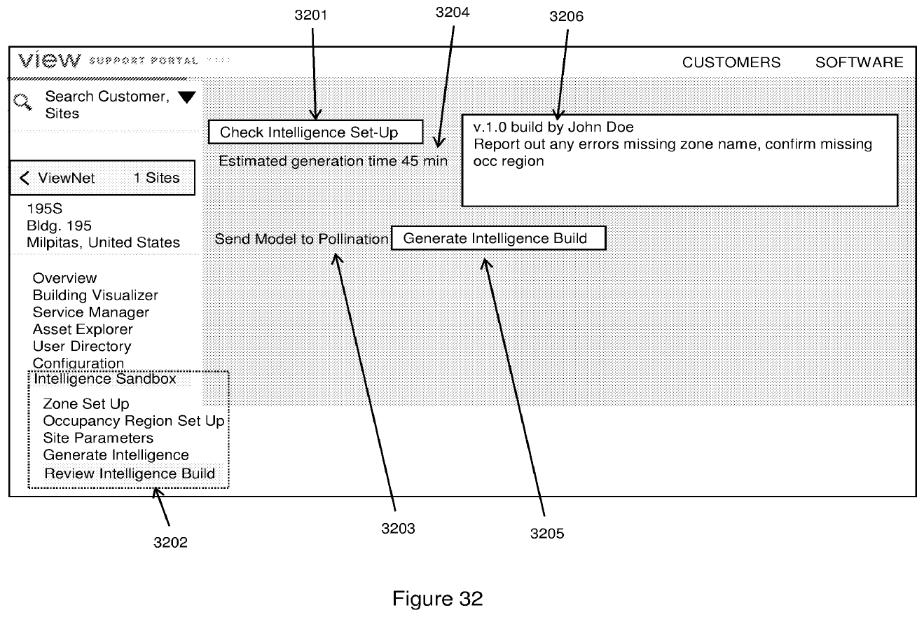

FIG. 32 shows an example of a user interface screen of a software application (app) that includes a customer support portal. In addition to sections similar to those described in the example of FIG. 27 (e.g., 2708, 2707, 3105, and 2706), the UI screen shown in the example of FIG. 32 depicts options titled “intelligence Sandbox” in block 3202 that include setting up and/or revising zone(s), occupancy region(s), site parameters, generate Intelligence, and review Intelligence building. In some embodiments, “Intelligence” refers to a control module that controls the building (e.g., various devices disposed in the building). The word “Intelligence” may be replaced with any other name of a similar control module. FIG. 32 shows an example in which the Generate Intelligence option is selected, as can be viewed also in filed 3205. This option prompts an update of the Intelligence control module and pollinates (e.g., updates) the digital twin of the facility with any user updates. The user is notified of the status of the pollination in field 3201. For example, in FIG. 32, the status depicted in field 3201 is Check Intelligence Set-Up. A time estimate is presented to the user in 3204, which in this example is 45 minutes. A detailed status is depicted in field 3206. The detailed status includes the version of the digital twin (V. 1.0), and its author (John Doe). The detailed status field indicates operations undergoing by the software (Report out any errors missing zone name, confirm missing occupancy region). Other detailed status indicators in detailed status field 3206 are possible, as are different general status options in field 3201.

In some embodiments, the app may facilitate viewing the digital twin in the UI as a pedestrian simulation against the existing space of the facility (e.g., from an average person's point of view).

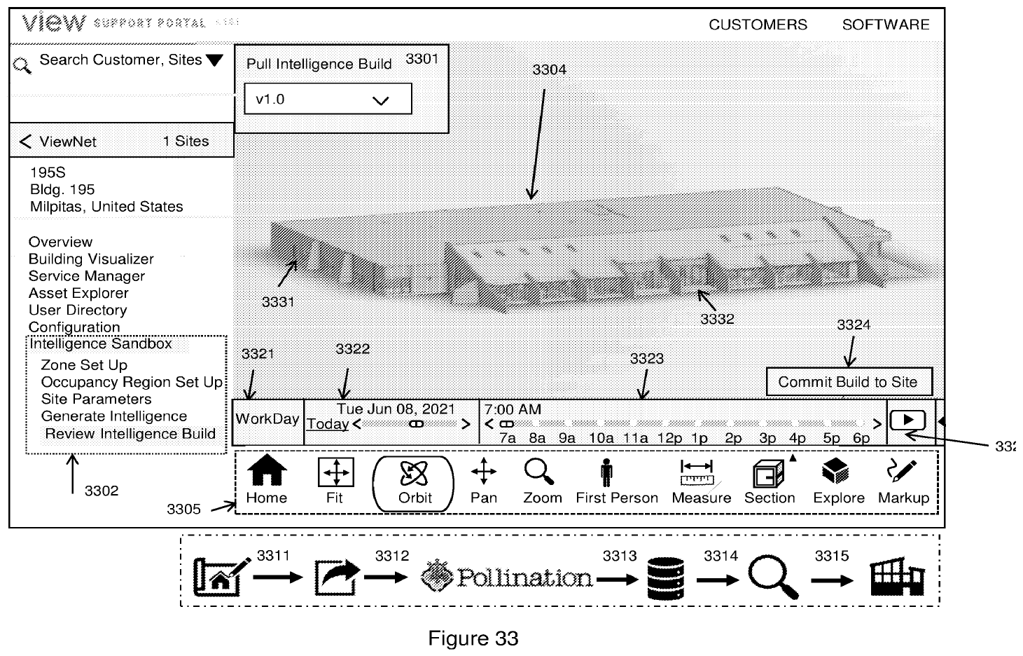

FIG. 33 shows an example of a user interface screen of a software application (app) that includes a customer support portal. In addition to sections similar to those described in the example of FIG. 27 (e.g., 2708, 2707, 3105, and 2706), the UI screen shown in the example of FIG. 33 depicts options titled “intelligence Sandbox” in block 3302 that include setting up and/or revising zone(s), occupancy region(s), site parameters, generate Intelligence, and review Intelligence building. In some embodiments, “Intelligence” refers to a control module that controls the building (e.g., various devices disposed in the building). The word “Intelligence” may be replaced with any other name of a similar control module. FIG. 33 shows an example in which the Review Intelligence Build option is selected. Block 3301 allows the user to pull an intelligence filed from a dropdown menu that can be activated by selecting the down arrow in field 3301. An image of the facility is shown in 3304. The user can manipulate the image using tool box in block 3105 including an option to return to a home screen (by selecting Home), fit to window (by selecting Fit), reorient the facility in 3D space (by selecting Orbit), move up down and/or to the sides (by selecting Pan), view the virtual image of the facility at an average person's gaze (by selecting First Person), zoom the virtual depiction of the facility in or out (by selecting Zoom), measure various distances in the facility (by selecting Measure), selecting a section of the facility (by selecting Section), markup (e.g., annotate) the virtual depiction of the facility (by selecting Markup), and exploring other added feature (by selecting Explore). The example UI show in FIG. 33 allows the user to choose between a workday and a non-workday (e.g., holiday) in block 3321, to choose the date in 3322, and the time in block 3323. The user can change the date, and time using a sliding scale, or side arrows. The user can change the date using arrow 3325. The user may toggle between workday and non-workday option by selecting block 3321, which will cause alteration of the date in block 3322. Block 3322 includes an indicator when the data is today (e.g., Today). The timescale provided in block 3323 can be discretized 9 e.g., every our), or continuous. The date and time selection are served as rendering criterial for the virtual depiction of facility 3304, as it is simulated with respect to sun irradiation, and any shadows casted on various facility portions. In the example shown in FIG. 33, Tuesday Jun. 8, 2021, is a workday, at 7 AM, shadow is casted in façade 3331 while sun is shining on façade 3332. The user may be able to alter the time and data and observe changing in shadow and light with respect to the facility. The user may manipulate the facility using toolbox 3305 and observe (for a given time and date) the shadows casted on the facility, and portion of the facility irradiated by light and/or subject to glare. The user may observe effect of occupancy zone selection and zone selection during this simulation. Once the user is satisfied with all selections as observed in the simulation, the user may select the Commit Build to Site field 3324, which will finalized the choices of the control module (e.g., Intelligence). The user is provided a toolbox in block 3305 including an option to return to a home screen (by selecting Home), fit to window (by selecting Fit), reorient the facility in 3D space (by selecting Orbit), move up down and/or to the sides (by selecting Pan), view the virtual image of the facility at an average person's gaze (by selecting First Person), zoom the virtual depiction of the facility in or out (by selecting Zoom), measure various distances in the facility (by selecting Measure), selecting a section of the facility (by selecting Section), markup (e.g., annotate) the virtual depiction of the facility (by selecting Markup), and exploring other added feature (by selecting Explore).

FIG. 33 shows an example of preparing and/or revising a digital twin of a facility in block 3310 starting from entering and/or adjusting details that are entered through the app for update in 3311, which update is simulated and verified, and then sent for pollinating the digital twin in 3312, then sent for storage in 3313, which stored digital twin may be sent for inspection in optional operation 3314. Once the inspection is satisfactory, the digital twin is deployed for (i) utilization by the control system (e.g., using Intelligence module), (ii) device and/or facility commissioning, and/or (iii) maintenance of the facility and/or device(s) of the facility.

In some embodiments, the software application (app) includes a management module. The management module may facilitate management of various devices of the facility. For example, the app facilitates selection of a certain device of the facility, viewing its status and related information. The management software application module may offer capabilities similar to the once discussed above, e.g., relating to FIGS. 18 and 21.

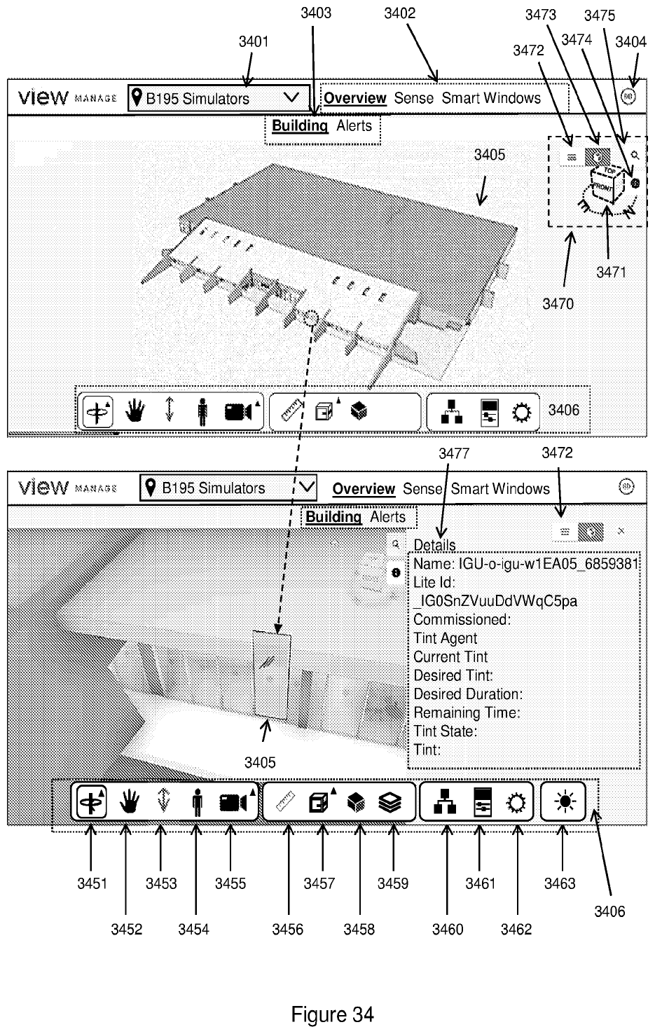

FIG. 34 shows an example of a UI of an app having a management module. The UI shows in field 3401 an indication of the chosen facility simulated. A user may choose other facility using a downward arrow in field 3401. The downward arrow may open a dropdown menu listing the other simulated facilities the user may choose from. Field 3402 indicates various options of options the user can view in the UI (e.g., Overview, Sense (e.g., sensor devices), or Smart Windows (e.g., tintable windows). The Overview option is selected in the example shown in FIG. 34. The chosen facility simulation in 3401 is visually depicted in a virtual representation of the facility 3405. Block 3470 offers the user options to enlarge the facility view by choosing magnifying glass 3475, understand the orientation of the facility in relation to the Cardinal directions North, West South, and East in 3471 that includes a unit circle and the associated Cardinal directions (e.g., Cardinal points) and also the relative facades of the building (e.g., front, top bottom, back and sides indicated schematically as a cube), the user may choose a three dimensional view by selecting 3473. The user may toggle between selection of detailed information regarding the selected item (e.g., the facility 3405) in icon 3472. Help can be provided by clicking icon 3474. User identification (e.g., initials) are presented by logging in, in icon 3404. The user may log out by clicking icon 3404, which may present a menu allowing the user to select the logout option. Facility simulation 3405 (e.g., virtual depiction of the facility) may be manipulated using tools in block 3406. Some portions of the simulated facility are interactive. For example, devices of the facility may be interactive. For example, the user may select a device (e.g., smart window 3490a) in the facility simulation 3405, which may prompt zooming on that device 3490b. The user may view details of the chosen device by selecting icon 3472, that will present menu 3476. An indication of Details is presented in 3477. The details may include the network identification of the device (e.g., Name of the device), the factory identification of the device (e.g., lite ID), and any other technical information and/or status of the device, such as the ones listed in field 3476 (e.g., whether the device has been commissioned or not). Some indicators may optionally be indicated by alphanumerical characters (e.g., the Lite ID), and some by picture icons (e.g., the commissioning indicator). The user may manipulate the facility using toolbox 3406 and observe (for a given time and date) the shadows casted on the facility, and portion of the facility irradiated by light and/or subject to glare. The user is provided a toolbox in block 3406 including an option to rotate the virtual facility along a vertical axis by selecting icon 3451, fit to screen by selecting icon 3452, move the virtual facility image vertically by selecting icon 3453, view the virtual image of the facility at an average person's gaze by selecting icon 3454, record a rendered movie of the virtual facility by selecting icon 3455, measure various distances in the facility by selecting icon 3456, section plane 3457, explode model objects 3458, floor levels, 3459, model browser 3460, object properties 3461, alter settings by selecting icon 3462, render sun object and shadows 3463.

In some embodiments, the software application may present a virtual visualization of the facility interior in the real-world. In some embodiments, the digital twin simulation may consider the interior of the real-world interior of the facility (e.g., as planned and/or as sensed by sensor(s)). For example, the software application and/or simulation of the digital twin may consider an Isovist of shadow and light affecting the facility interior. For example, the software application may present an image (on a UI) of the facility, its fixtures and/or at least a portion of non-fixtures. For example, the software application may present an image (on a UI) of the facility in one or more: walls, openings (e.g., windows, vestibules, corridors, foyers, piers, and/or doors), ceilings, floors, furniture, and/or light fixtures. These features may be consider during rendering of the facility, e.g., considering their influence on the facility's interior (e.g., internal environment such as light and shadow distribution).

In some embodiments, an Isovist is the volume of space visible from a given point in space, together with a specification of the location of that point. An Isovist can be three-dimensional, or represented as a two dimensional map (e.g., horizontal cross section of an 3D Isovist). A boundary-shape of an Isovist may or may not vary with location. The Isovist can be a volume of space illuminated by a point source of light.

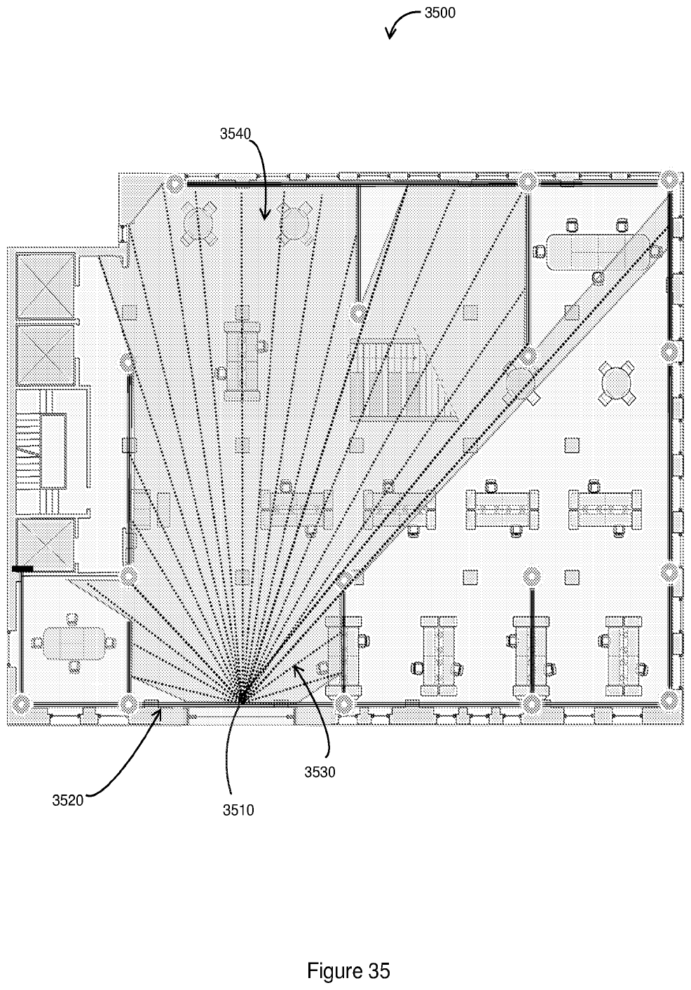

FIG. 35 shows an example of an Isovist on a two-dimensional floorplan 3500 of a facility. A window opening 3510 is disposed at a wall 3520 of the facility. A set of locations on floorplan 3500 are impinged by rays 3530 are depicted in an Isovist 3540, which can be used to evaluate light penetrating from window 3510.

While preferred embodiments of the present invention have been shown, and described herein, it will be obvious to those skilled in the art that such embodiments are provided by way of example only. It is not intended that the invention be limited by the specific examples provided within the specification. While the invention has been described with reference to the afore-mentioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations, or relative proportions set forth herein which depend upon a variety of conditions and variables. It should be understood that various alternatives to the embodiments of the invention described herein might be employed in practicing the invention. It is therefore contemplated that the invention shall also cover any such alternatives, modifications, variations, or equivalents. It is intended that the following claims define the scope of the invention and that methods and structures within the scope of these claims and their equivalents be covered thereby.

1. A method comprising:
(A) identifying a location information of a real target device at least in part by (i) using a mobile device to select a virtual target device in a virtual representation of an enclosure in which the real target device is disposed, which virtual target device is a virtual representation of the real target device, which real target device is included in the one or more real target devices disposed in the enclosure, and/or (ii) using geographic information locating the real target device;
(B) using an identification capture device to capture an identification code of the real target device, which identification code is attached to the real target device; and
(C) registering the real target device at least in part by linking (I) the identification code, (II) the location information, and (III) the virtual representation of the enclosure.

2. (canceled)

3. The method of claim 1, wherein:
the virtual representation of the enclosure is displayed on the mobile device, and
the virtual representation includes virtual representations of at least some of the one or more real target devices.

4. The method of claim 3, further comprising navigating within the virtual representation of the enclosure according to movement of the mobile device in the enclosure.

5. The method of claim 4, wherein:
the mobile device is transported by a traveler within the enclosure, and
a zoomed view in the virtual representation is presented on a display of the mobile device in real time to depict a virtual representation of the real target device based at least in part on a present location of the traveler.

6. (canceled)

7. The method of claim 5, wherein the traveler is a robot having image recognition capabilities.

8. The method of claim 3, further comprising updating the virtual representation of the enclosure according to the registering of the target device.

9. The method of claim 8, wherein the virtual representation of the enclosure is derived from and/or comprises an architectural model of the enclosure.

10. The method of claim 9, further comprising updating the architectural model according to registration of the real target device.

11. The method of claim 9, further comprising determining a status of the real target device at least in part by utilizing the virtual representation of the enclosure, the virtual representation of the real target device, and associated information obtained through utilizing the capture device.

12. The method of claim 11, further comprising (a) initiating servicing of the real target device when the status determined indicates a servicing need, and (b) updating the status determined upon completion of the servicing.

13. The method of claim 1, wherein the geographic information is an absolute information.

14. The method of claim 13, wherein the absolute information is derived at least in part from a Global Positioning System (GPS) receiver or from a ultrawide band (UWB) receiver.

15. The method of claim 1, wherein the geographic information is a relative location in the virtual representation of the enclosure.

16. (canceled)

17. The method claim 1, further comprising using the identification code to populate (a) the virtual representation of the enclosure and/or (b) at least one associated database of the virtual representation of the enclosure, with: a virtual representation of the real target device and/or associated information of the real target device.

18. The method of claim 1, further comprising transmitting the captured identification code to at least one database for storing and/or operatively coupled to the virtual representation of the enclosure.

19-20. (canceled)

21. An apparatus for registering one or more real target devices, the apparatus comprising at least one controller having circuitry, which at least one controller is configured to:
(A) operatively couple to an identification capture device and to a virtual representation of an enclosure in which the one or more real target devices are disposed;
(B) receive, or direct receipt of, location information of a real target device at least in part by (i) selection of a virtual target device in a virtual representation of an enclosure in which the real target device is disposed, which virtual target device is a virtual representation of the real target device, which real target device is included in the one or more real target devices, and/or (ii) geographic information locating the real target device;
(C) receive, or direct receipt of, identification information of the real target device from the identification capture device configured to capture an identification code of the real target device, which identification code is attached to the real target device; and
(D) register, or direct registration of, the real target device at least in part by linking, or direct linkage of, (I) the identification code, (II) the location information, and (III) the virtual representation of the enclosure.

22-23. (canceled)

24. The apparatus of claim 21, wherein the at least one controller is further configured to update, or direct update of, the virtual representation of the enclosure according to the registering of the real target device.

25. The apparatus of claim 21, wherein:
the identification capture device is mobile, and
the at least one controller is configured to direct the identification capture device to capture the identification code optically and/or electronically, which controller is operatively coupled to the identification capture device.

26-29. (canceled)

30. The method of claim 1, further comprising:
generating a digital twin of a real facility at least in part by using a virtual architectural model of a real facility;
populating at least one device of the real facility in the digital twin at a virtual location that corresponds to its real location in the real facility, which at least one device is controllable; and
simulating, or directing simulation of, effect of at least one environmental attribute on the real facility.

31. The method of claim 30, wherein the environmental attribute comprises lighting, radiation, temperature, gas velocity, gas flow, gas content, gas concentration, gas pressure, sound, volatile organic compounds, or particulate matter.

32-50. (canceled)
